(19) United States
(12) Patent Application Publication
(10) Pub. No.: US 2009/0274891 A1
(43) Pub. Date: Nov. 5, 2009

(54) ANTIREFLECTION FILM, POLARIZING PLATE, AND IMAGE DISPLAY DEVICE INCLUDING THE SAME

(75) Inventors: Osamu SAWANOBORI, Minami-Ashigara-shi (JP); Hiroyuki Yoneyama, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/504,759

(22) Filed: Jul. 17, 2009

Related U.S. Application Data
(62) Division of application No. 11/526,822, filed on Sep. 26, 2006.

(30) Foreign Application Priority Data
Sep. 26, 2005 (JP) 2005-278461

(51) Int. Cl. B32B 5/18; B32B 5/16; B32B 9/00

(52) U.S. Cl. 428/314.4; 428/323; 428/317.9; 428/331

(57) ABSTRACT

An antireflection film including a transparent support and at least one layer having a refractive index of from 1.28 to 1.48, wherein the layer having a refractive index of from 1.28 to 1.48 positioned farthest from the transparent support in the at least one layer having a refractive index of from 1.28 to 1.48 is formed by coating a coating composition including: an ionizing radiation hardenable compound; a particle having a conductive metal oxide-coated layer; and at least one ionizing radiation hardenable fluorine-containing antifouling agent.

### CROSS-REFERENCE TO RELATED APPLICATIONS

This application is a divisional of U.S. application Ser. No. 11/526,822 filed on Sep. 26, 2006, which claims priority to Japanese Application No. 2005-278461 filed on Sep. 26, 2005, the entire contents of which are incorporated herein by reference.

### FIELD OF THE INVENTION

The present invention relates to an antireflection film, a polarizing plate and an image display device.

### BACKGROUND OF THE INVENTION

In general, in image display devices such as a cathode ray tube display device (CRT), a plasma display (PDP), an electroluminescence display (ELD), and a liquid crystal display device (LCD), for the purpose of preventing a lowering of contrast or reflection of an image due to the reflection of external light, an antireflection film is disposed on the outermost surface of a display so as to reduce a reflectance by using a principle of optical interference.

Such an antireflection film can be prepared by forming a low refractive index layer having an appropriate thickness for the outermost surface and if desired, properly forming a high refractive index layer, middle refractive index layer, a hard coat layer, and so on between the outermost surface and a support. For the purpose of realizing a low reflectance, a material having a low refractive index as far as possible is desired for the low refractive index layer. Also, since the antireflection film is used for the outermost surface, it is expected that it has a function as a protective film of a display device. It is required that stains or dusts hardly attach to the antireflection film and that the antireflection film has strong scar resistance. In a thin film having a thickness of about 100 nm, in order to realize high scar resistance, the film must have strength by itself and adhesiveness to a lower layer.

In order to decrease the refractive index of a material, there are measures such as introduction of a fluorine atom and decrease of density (introduction of voids). However, in all of these measures, the film strength or adhesiveness at an interface is lowered so that the scar resistance tends to be lowered. Thus, it was a difficult problem to make low refractive index and high scar resistance compatible with each other.

Also, in particular, a fluorine atom-containing binder is liable to be negatively charged so that it involved a problem that in the case where it is used on a display surface, dusts in the circumstances likely attach thereto. In addition, when a fluorine based antifouling material is used, the fluorine based antifouling agent is aligned on a film surface and exhibits antifouling properties. Thus, there was involved a problem that the surface is further negatively charged so that dusts likely attach onto the surface. Accordingly, an improving technology was required.

As a technology for imparting dustproof properties, it is described to add an anionic or cationic material. However, in the case of using such a material, there were involved problems that the material is separated in a coating liquid; that unevenness is generated at the time of coating; and that the scar resistance of the film is deteriorated.

Also, a method of providing a so-called “antistatic layer” containing a conductive particle is known by JP-A-2005-196122. However, this method involves a problem that a layer must be newly provided so that loads of equipment and time at the time of manufacture are large. Also, the major part of antistatic conductive particles which have hitherto been generally used has a refractive index of particle of from about 1.6 to 2.2, and the refractive index of the antistatic layer containing such a particle inevitably increases. Because of a high refractive index of the antistatic layer, in optical films, non-intended interference unevenness is generated due to a difference in the refractive index from adjacent layers, or the color taste of an opposite color becomes strong.

From the viewpoint of lowering the refractive index of a conductive particle, JP-A-2005-119909 describes that a particle resulting from coating a surface of a silica particle with antimony oxide is used in a low refractive index layer. However, JP-A-2005-119909 does not describe a technology for improving the antifouling properties so that this technology is in a level requiring a further improvement in view of the antifouling properties.

On the other hand, JP-A-2003-222704 describes that by adding a silane coupling agent in a low refractive index layer raw material utilizing a fluorine-containing polymer, the scar resistance is largely improved. However, this method involves a problem that the silane coupling agent having a low boiling point volatilizes during coating and drying steps. Thus, the addition of an excessive amount of the silane coupling agent is necessary taking into consideration the volatilization. Accordingly, there was involved a problem that a stable performance is hardly obtained.

On the other hand, for the purpose of imparting antifouling properties, JP-A-2002-277604 describes that an antifouling layer is overcoated. However, though such a compound for imparting antifouling properties can be coated on a layer containing, as a major binder, a hydrolysis condensate of an organosilane based compound, there were involved problems that it is liable to repel an ionizing radiation hardenable binder which is in general widely used and that unevenness is likely generated.

### SUMMARY OF THE INVENTION

An object of the invention is to provide an antireflection film having excellent adhesiveness, scar resistance, dustproof properties and antifouling properties and having sufficient antireflection performance. In particular, the invention is to provide an antireflection film which when a fluorine-containing polymer or a fluorine-containing antifouling agent is used, has excellent antifouling properties and dustproof properties and has sufficient antireflection performance. In addition, the invention is to provide a polarizing plate and an image display device each using such an antireflection film.

In order to overcome the foregoing problems, the present inventors made extensive and intensive investigations. As a result, it has been found that the foregoing problems can be solved, thereby achieving the foregoing objects by the following configurations, leading to accomplishment of the invention.

That is, the invention has achieved the foregoing objects by the following configurations.

(1) An antireflection film comprising a transparent support and at least one layer having a refractive index of from 1.28 to 1.48, wherein the layer having a refractive index of from 1.28 to 1.48 positioned farthest from the transparent support in the at least one layer having a refractive index of from 1.28 to 1.48 is formed by coating a coating composition containing at least the following components:

(A) an ionizing radiation hardenable compound; and

(B) a fine particle having a conductive metal oxide-coated layer.

(2) The antireflection film as set forth in (1), wherein the fine particle (B) having a conductive metal oxide-coated layer is a porous inorganic fine particle or a fine particle having voids in the inside thereof.
(3) The antireflection film as set forth in (1) or (2), wherein the fine particle (B) having a conductive metal oxide-coated layer is a silica based fine particle having an antimony oxide-coated layer.
(4) The antireflection film as set forth in any one of (1) to (3), wherein the fine particle (B) having a conductive metal oxide-coated layer is a porous silica based fine particle or a silica based fine particle having voids in the inside thereof.
(5) The antireflection film as set forth in any one of (1) to (4), wherein the fine particle (B) having a conductive metal oxide-coated layer contains a silica-coated layer or a silica-coated layer resulting from a surface treatment with a hydrolyzate of an organosilane compound represented by the following formula (3) and/or a partial condensate thereof on a conductive metal oxide-coated layer.

(R³⁰)ₘ₁Si(X³¹)₄₋ₘ₁ Formula (3)

In the formula (3), R³⁰ represents a substituted or unsubstituted alkyl group or a substituted or unsubstituted aryl group; X³¹ represents a hydroxyl group or a hydrolyzable group; and m1 represents an integer of from 1 to 3.

(6) The antireflection film as set forth in any one of (1) to (5), wherein the fine particle (B) having a conductive metal oxide-coated layer has a refractive index in the range of from 1.35 to 1.60 and a volume resistivity value in the range of from 10 to 5,000 Ω/cm.
(7) The antireflection film as set forth in any one of (1) to (6), wherein the fine particle (B) having a conductive metal oxide-coated layer has an average particle size in the range of from 5 to 300 nm and a thickness of the conductive metal oxide-coated layer in the range of from 0.5 to 30 nm.
(8) The antireflection film as set forth in any one of (1) to (7), wherein the compound (A) contains at least two ethylenically unsaturated groups in one molecule thereof.
(9) The antireflection film as set forth in any one of (1) to (8), wherein the compound (A) is a fluorine-containing polymer containing at least one perfluoroolefin polymer-ization unit and at least one (meth)acryloyl group-containing polymerization unit.
(10) The antireflection film as set forth in any one of (1) to (9), wherein the coating composition further contains (C) a compound having a polysiloxane structure represented by the following formula (1).

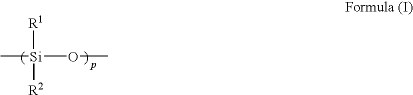

In the formula (1), R¹ and R² may be the same or different and each represents an alkyl group or an aryl group; and p represents an integer of from 10 to 500.

(11) The antireflection film as set forth in any one of (1) to (10), wherein the ionizing radiation hardenable compound (A) is represented by the following formula (1).

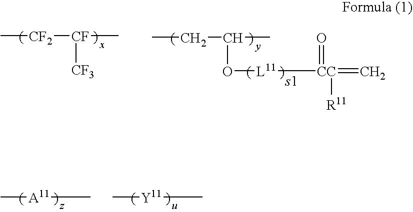

In the formula (1), L¹¹ represents a connecting group having from 1 to 10 carbon atoms; s1 represents 0 or 1; R¹¹ represents a hydrogen atom or a methyl group; A¹¹ represents a repeating unit containing a hydroxyl group in a side chain thereof; Y¹¹ represents a constitutional component containing a polysiloxane structure in a principal chain thereof; x, y and z each represents % by mole of a respective repeating unit based on the whole of repeating units other than Y¹¹ and represents a value which is satisfied with the relations of (30≦x≦60), (30≦y≦70) and (0≦z≦40), provided that the total sum of x, y and z is 100% by mole; and u represents % by weight of the constitutional component Y¹¹ in the copolymer and is satisfied with the relation of (0.01≦u≦20).

(12) The antireflection film as set forth in any one of (1) to (9), wherein the ionizing radiation hardenable compound (A) is represented by the following formula (2).

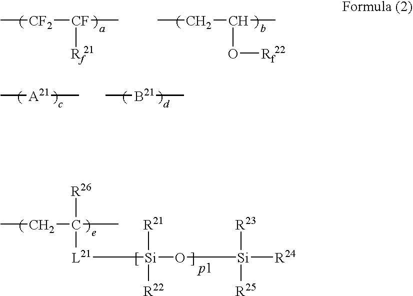

In the formula (2), R_{f}²¹ represents a perfluoroalkyl group having from 1 to 5 carbon atoms; R_{f}²² represents a fluorine-containing alkyl group having a linear, branched or alicyclic structure having from 1 to 30 carbon atoms and may contain an ether bond; A²¹ represents a constitutional unit containing a reactive group capable of participating in a crosslinking reaction; B²¹ represents an arbitrary constitutional component; R²¹ and R²² may be the same or different and each represents an alkyl group or an aryl group; p1 represents an integer of from 10 to 500; R²³ to R²⁵ each independently represents a substituted or unsubstituted monovalent organic group or a hydrogen atom; R²⁶ represents a hydrogen atom or a methyl group; L²¹ represents an arbitrary connecting group having from 1 to 20 carbon atom or a single bond; a to d each represents a molar fraction (%) of a respective constitutional component exclusive of a polysiloxane-containing polymerization unit and represents a value which is satisfied with the relations of (10≦(a+b)≦55), (10≦a≦55), (0≦b≦45), (10≦c≦50) and (0≦d≦40); and e represents a weight fraction (%) of a polysiloxane-containing polymerization unit based on the weight of the whole of other components and is satisfied with the relation of (0.01≦e≦20).

(13) The antireflection film as set forth in any one of (1) to (12), wherein the coating composition further contains (D) at least one ionizing radiation hardenable fluorine-containing antifouling agent.
(14) A polarizing plate having the antireflection film as set forth in any one of (1) to
(13) provided in at least one side thereof.
(15) An image display device having at least one of the antireflection film as set forth in any one of (1) to (13) and the polarizing plate as set forth in (14) arranged therein.

According to the invention, it is possible to provide an antireflection film having excellent scar resistance, dustproof properties and antifouling properties and having sufficient antireflection performance. In addition, it is possible to provide a high-quality polarizing plate and an image display device by using such an antireflection film.

### DETAILED DESCRIPTION OF THE INVENTION

The invention will be hereunder described in more detail. Incidentally, in this specification, in the case where a numerical value exhibits a physical property value, a characteristic value or the like, the terms “from (numerical value 1) to (numerical value 2)” means “(numerical value 1) or more and not more than (numerical value 2)”. Also, in this specification, the term “(meth)acrylate” means “at least one of acrylate and methacrylate”. The same is also applicable to “(meth)acrylic acid” and so on.

### ≦Antireflection Film>

The antireflection film of the invention includes a transparent support having at least one low refractive index layer thereon, with the low refractive index layer positioned farthest from the transparent support in the at least one low refractive index layer being formed by coating a coating composition containing at least the following components:

(A) an ionizing radiation hardenable compound; and

(B) a fine particle having a conductive metal oxide-coated layer.

### [Low Refractive Index Layer]

First of all, the low refractive index layer of the antireflection film of the invention will be hereunder described.

The refractive index of the low refractive index layer in the invention is in the range of from 1.28 to 1.48, and preferably from 1.34 to 1.44. In addition, in view of realizing a low reflectance, it is preferable that the low refractive index layer is satisfied with the following numerical formula (1).

(m₁λ/4)×0.7≦n₁d₁≦(m₁λ/4)×1.3 Numerical Formula (1)

In the formula, m₁ represents a positive odd number; n₁ represents a refractive index of the low refractive index layer; d₁ represents a thickness (nm) of the low refractive index layer; and λ represents a wavelength and is a value in the range of from 500 to 550 nm.

Incidentally, by the terms “the low refractive index layer is satisfied with the numerical formula (1)” as referred to herein, it is meant that m₁ (a positive odd number, and usually 1) is present within the foregoing wavelength range.

In the invention, the refractive index of the constitutional layers of the optical film can be determined by optical simulation of the refractive index and the thickness of each layer from the reflectance of the optical film. Furthermore, the refractive index can be measured by an Abbe's refractometer directly in a hardened state of the components of the constitutional layer.

### [Ionizing Radiation Hardenable Compound] (Constitutional Component (A) of Low Refractive Index Layer of the Invention)

In the invention, in coating a low refractive index layer, an ionizing ration hardenable compound (a compound capable of being hardened upon irradiation with ionizing radiations) is used. As such an ionizing ration hardenable compound, for example, a fluorine-containing polymer or fluorine-containing sol/gel raw material having a low refractive index with respect to the compound itself is preferably used. Usually, the fluorine-containing polymer or fluorine-containing sol/gel raw material is crosslinked by ionizing radiations and if desired, heating. A surface of the formed low refractive index layer preferably has a dynamic friction coefficient of from 0.03 to 0.15 and a contact angle against water of from 90 to 120°. Furthermore, a compound containing at least two ethylenically unsaturated groups in one molecule thereof and capable of being hardened upon irradiation with ionizing radiations can also be used.

The ionizing radiation hardenable compound is preferably used in an amount of from 10 to 100% by weight, more preferably from 30 to 95% by weight, and especially preferably from 40 to 80% by weight based on the solids of the low refractive index layer.

### [Compound Containing at Least Two Ethylenically Unsaturated Groups in One Molecule Thereof]

Examples of the compound containing at least two ethylenically unsaturated groups in one molecule thereof include esters of a polyhydric alcohol and (meth)acrylic acid [for example, ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri-(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, and polyester polyarylates], ethylene oxide modified compounds of the foregoing esters, vinylbenzene and derivatives thereof [for example, 1,4-divinylbenzene, 2-acryloylethyl 4-vinylbenzoate, and 1,4-divinylcyclohexanone], vinylsulfones (for example, divinylsulfone), acrylamides (for example, methylenebisacrylamide), and methacrylamides. Two or more kinds of such a compound may be used together. Though such a compound is able to increase the density of a crosslinking group in a binder and to form a hardened film with high hardness, its refractive index is not low as compared with that of fluorine-containing polymer binders. However, when this compound is used together with, as a fine particle (B) having a conductive metal oxide-coated layer, a silica based fine particle having an antimony oxide-coated layer as described later (hereinafter sometimes referred to as “antimony oxide-coated silica based fine particle”), for example, a porous fine particle or a fine particle having voids in the inside thereof, a sufficiently effective refractive index as the low refractive index layer of the invention can be obtained.

### [Fluorine-Containing Polymer]

Examples of the fluorine-containing polymer or fluorine-containing sol/gel raw material which is used in the low refractive index layer include fluorine-containing copolymers containing, as constitutional components, a fluorine-containing monomer unit and a constitutional unit for imparting crosslinking reactivity in addition to hydrolyzates or dehydration condensates of a perfluoroalkyl group-containing silane compound (for example, heptadecafluoro-1,1,2,2-tetrahydrodecyl)triethoxysilane).

Specific examples of the fluorine-containing monomer unit include fluoroolefins (for example, fluoroethylene, vinylidene fluoride, tetrafluoroethylene, hexafluoropro-pylene, and perfluoro-2,2-dimethyl-1,3-dioxonol), partially or completely fluorinated alkyl ester derivatives of (meth)acrylic acid (for example, VISCOAT 6FM (manufactured by Osaka Organic Chemical Industry Ltd.) and M-2020 (manufactured by Daikin Industries, Ltd.), and completely or partially fluorinated vinyl ethers. Of these, perfluoroolefins are preferable; and hexafluoropropylene is especially preferable from the viewpoints of refractive index, solubility, transparency, easiness of availability, and so on.

As the constitutional unit for imparting crosslinking reactivity, the following units (a), (b) and (c) are mainly enumerated.

That is, examples thereof include (a) a constitutional unit obtainable by polymerization of a monomer which contains a self-crosslinking functional group in the molecule thereof (for example, glycidyl(meth)acrylate and glycidyl vinyl ether) in advance; (b) a constitutional unit obtainable by polymerization of a monomer containing a carboxyl group, a hydroxyl group, an amino group, a sulfo group, etc. [for example, (meth)acrylic acid, methylol (meth)acrylate, hydroxyalkyl(meth)acrylate, allyl acrylate, hydroxyethyl vinyl ether, hydroxybutyl vinyl ether, maleic acid, and crotonic acid]; and (c) a constitutional unit obtainable by reacting a compound containing a group reactive with the foregoing functional group (a) or (b) and another crosslinking functional group in the molecule thereof react with the foregoing constitutional unit (a) or (b) (for example, a constitutional unit capable of being synthesized by a measure such as making acrylic acid chloride act to a hydroxyl group).

In the invention, in the foregoing constitutional unit (c), it is especially preferable that the crosslinking functional group is a photopolymerizable group. Examples of the photopolymerizable group include a (meth)acryloyl group, an alkenyl group, a cinnamoyl group, a cinnamylideneacetyl group, a benzalacetophenone group, a stylylpyridine group, an α-phenylmaleimide group, a phenylazide group, a sulfonylamide group, a carbonylamide group, a diazo group, an o-quinonediazide group, a furylacryloyl group, a coumarin group, a pyrone group, an anthracene group, a benzophenone group, a stilbene group, a dithiocarbamate group, a xanthate group, a 1,2,3-thiadiazole group, a cyclopropene group, and an azadioxabicyclo group. Such a group may be one or two or more kinds thereof. Of these groups, a (meth)acryloyl group and a cinnamoyl group are preferable, with a (meth)acryloyl group being especially preferable.

As a specific example of a method of preparing a photopolymerizable group-containing copolymer, the following methods can be enumerated. However, it should not be construed that the invention is limited thereto.

(1) A method of reacting a crosslinking functional group-containing copolymer containing a hydroxyl group with (meth)acrylic acid chloride to form an ester.

(2) A method of reacting a crosslinking functional group-containing copolymer containing a hydroxyl group with an isocyanate group-containing (meth)acrylic ester to form a urethane.

(3) A method of reacting a crosslinking functional group-containing copolymer containing an epoxy group with (meth)acrylic acid to form an ester.

(4) A method of reacting a crosslinking functional group-containing copolymer containing a carboxyl group with an epoxy group-containing (meth)acrylic ester to form an ester.

Incidentally, the amount of introduction of the photopolymerizable group can be arbitrarily adjusted. In view of stability of surface properties of coating film and lowering in defective face properties and improvement in film strength at the time of copresence of an inorganic fine particle, it is also preferable that a certain amount of a carboxyl group, a hydroxyl group, etc. remains.

Furthermore, besides the foregoing fluorine-containing monomer unit and the foregoing constitutional unit for imparting crosslinking reactivity, from the viewpoints of solubility in a solvent, transparency of a film and so on, a fluorine atom-free monomer can be properly copolymerized, too. The monomer unit which can be used together is not particularly limited, and examples thereof include olefins (for example, ethylene, propylene, isoprene, vinyl chloride, and vinylidene chloride), acrylic esters (for example, methyl acrylate, methyl acrylate, ethyl acrylate, and 2-ethylhexyl acrylate), methacrylic esters (for example, methyl methacrylate, ethyl methacrylate, butyl methacrylate, and ethylene glycol dimethacrylate), styrene derivatives (for example, styrene, divinylbenzene, vinyltoluene, and α-methylstyrene), vinyl ethers (for example, methyl vinyl ether, ethyl vinyl ether, and cyclohexyl vinyl ether), vinyl esters (for example, vinyl acetate, vinyl propionate, and vinyl cinnamate), acrylamides (for example, N-tert-butyl acrylamide and N-cyclohexyl acrylamide), methacrylamides, and acrylonitrile derivatives.

In the invention, an especially useful fluorine-containing polymer is a random copolymer of a perfluoroolefin and a vinyl ether or a vinyl ester. It is especially preferable that the fluorine-containing polymer contains a group which is able to undergo a crosslinking reaction singly (for example, a radical reactive group such as a (meth)acryloyl group and a ring-opening polymerizable group such as an epoxy group and an oxetanyl group). Such a crosslinking reactive group-containing polymerization unit preferably accounts for from 5 to 70% by mole, and especially preferably from 30 to 60% by mole of the whole of polymerization units of the polymer. As a preferred polymer, polymers as described in JP-A-2002-243907, JP-A-2002-372601, JP-A-2003-26732, JP-A-2003-222702, JP-A-2003-294911, JP-A-2003-329804, JP-A-2004-4444, and JP-A-2004-45462 can be enumerated.

Furthermore, for the purpose of imparting antifouling properties to the fluorine-containing polymer which is useful in the invention, it is preferable that a polysiloxane structure is introduced. Though a method of introducing a polysiloxane structure is not limited, for example, a method of introducing a polysiloxane block copolymerization component by using a silicone macro azo initiator as described in JP-A-11-189621, JP-A-11-228631 and JP-A-2000-313709; and a method of introducing a polysiloxane graft copolymerization component by using a silicone macromer as described in JP-A-2-251555 and JP-A-2-308806 are preferable. Such a polysiloxane component is preferably contained in an amount of from 0.5 to 10% by weight, and especially preferably from 1 to 5% by weight in the polymer.

A molecular weight of the polymer which can be preferably used in the invention is 5,000 or more, preferably from 10,000 to 500,000, and most preferably from 15,000 to 200,000 in terms of a weight average molecular weight. By jointly using polymers having a different average molecular weight from each other, the surface properties and scar resistance of a coating film can be improved.

The foregoing fluorine-containing polymer may be properly used together with a hardening agent as described in JP-A-10-25388 and JP-A-10-147739. It is also preferable that the fluorine-containing polymer is used together with a fluorine-containing polyfunctional polymerizable unsaturated group-containing compound as described in JP-A-2000-17028 and JP-A2-2-145952. Examples of the polyfunctional polymerizable unsaturated group-containing compound include the foregoing “compounds containing two or more ethylenically unsaturated groups”. In particular, the case where a compound containing a polymerizable unsaturated compound in the polymer main body is used, its effect due to the joint use against the improvement in scar resistance is large and preferable.

Such a compound is preferably used in an amount of from 1 to 50 parts by weight, more preferably from 2 to 40 parts by weight, and most preferably from 3 to 30 parts by weight based on 100 parts by weight of the polymer main body.

[Compound having a Polysiloxane Partial Structure]

A compound having a polysiloxane partial structure which can be especially preferable in the invention will be hereunder described in detail.

In roughly classifying such a compound, (1) a compound in which a polysiloxane partial structure represented by the following formula (1) is contained in a polymer principal chain and (2) a compound in which a polysiloxane partial structure represented by the following formula (2) is contained in a polymer side chain can be preferably used.

### (Polymer Having a Polysiloxane Partial Structure in a Polymer Principal Chain)

As the polymer having a polysiloxane partial structure in a polymer principal chain, a fluorine-containing polymer having a polysiloxane partial structure in a principal chain thereof and containing a repeating unit made of a fluorine-containing vinyl monomer, a repeating unit containing a (meth)acryloyl group in a side chain thereof and a repeating unit containing a hydroxyl group is preferable. Such a compound can work as both a compound capable of being hardened upon irradiation with ionizing radiations and a compound having a polysiloxane partial structure. This polymer is preferably represented by the following formula (1).

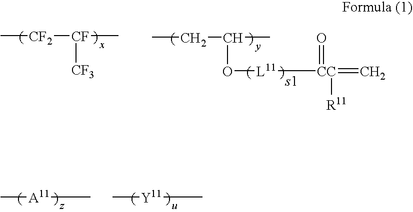

In the foregoing formula (1), L¹¹ represents a connecting group having from 1 to 10 carbon atoms, more preferably a connecting group having from 1 to 6 carbon atoms, and especially preferably a connecting group having from 2 to 4 carbon atoms; may have a linear or branched structure or a cyclic structure and may contain a hetero atom selected from O, N and S. Preferred examples thereof include *—(CH₂)₂—O—**, *—(CH₂)₂—NH—**, *—(CH₂)₄—O—**, *—(CH₂)₆—O—**, *—(CH₂)₂—O—(CH₂)₂—O—**, *—CONH—(CH₂)₃—O—**, *—CH₂CH(OH)CH₂—O—**, and *—CH₂CH₂OCONH(CH₂)₃—O—** (* represents a connecting site of the polymer principal chain side; and ** represents a connecting site of the (meth)acryloyl group side).

s1 represents 0 or 1.

R¹¹ represents a hydrogen atom or a methyl group; and from the viewpoint of hardening reactivity, R¹¹ is more preferably a hydrogen atom.

A¹¹ represents a repeating unit containing a hydroxyl group in a side chain thereof and is not particularly limited so far as it is a constitutional component of a monomer which is copolymerizable with hexafluoropropylene. A¹¹ can be properly selected from a variety of viewpoints such as adhesiveness to a substrate, Tg of a polymer (contributing to the film hardness), solubility in a solvent, transparency, slipperiness, and dustproof or antifouling properties and may be constituted of a single vinyl monomer or plural vinyl monomers according to the purpose.

Preferred examples of the vinyl monomer which constitutes A¹¹ include vinyl ethers such as methyl vinyl ether, ethyl vinyl ether, t-butyl vinyl ether, cyclohexyl vinyl ether, isopropyl vinyl ether, hydroxyethyl vinyl ether, hydroxybutyl vinyl ether, glycidyl vinyl ether, and allyl vinyl ether; vinyl esters such as vinyl acetate, vinyl propionate, and vinyl butyrate; (meth)acrylates such as methyl(meth)acrylate, ethyl(meth)acrylate, hydroxyethyl(meth)acrylate, glycidyl methacrylate, allyl(meth)acrylate, and (meth)acryloyloxypropyl trimethoxysilane; styrene derivatives such as styrene and p-hydroxymethylstyrene; and unsaturated carboxylic acids such as crotonic acid, maleic acid, and itaconic acid, and derivatives thereof. Of these, vinyl ether derivatives and vinyl ester derivatives are more preferable; and vinyl ether derivatives are especially preferable.

Y¹¹ represents a constitutional component containing a polysiloxane partial structure in a principal chain thereof.

Though a method of introducing a polysiloxane partial structure into the principal chain is not particularly limited, examples thereof include a method of using a polymer type initiator such as an azo group-containing polysiloxane amide (for example, commercially available VPS-0501 and VPS-1001 (trade names, manufactured by Wako Pure Chemicals Industries, Ltd.)) as described in JP-A-6-93100; a method in which a reactive group derived from a polymerization initiator or a chain transfer agent (for example, a mercapto group, a carboxyl group, and a hydroxyl group) is introduced into a polymer terminal and then reacted with a polysiloxane containing a reactive group (for example, an epoxy group and isocyanate group) on one terminal or both terminals thereof; and a method of copolymerizing a cyclic siloxane oligomer such as hexa-methylcyclotrisiloxane by anionic ring-opening polymerization. Above all, a method of utilizing an initiator having a polysiloxane partial structure is easy and preferable.

x, y and z each represents % by mole of a respective repeating unit based on the whole of repeating units other than Y¹¹ and represents a value which is satisfied with the relations of (30≦x≦60), (30≦y≦70) and (0≦z≦40), and preferably (35≦x≦55), (30≦y≦60) and (0≦z≦35), provided that the total sum of x, y and z is 100% by mole; and u represents % by weight of the constitutional component Y¹¹ in the copolymer and is satisfied with the relation of (0.01≦u≦20).

Above all, a polymer represented by the following formula (1-2) is especially preferable.

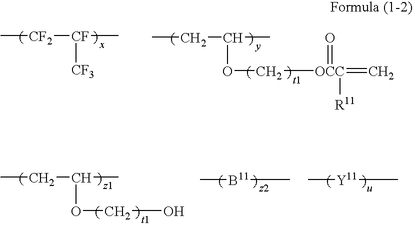

In the foregoing formula (1-2), R¹¹, Y¹¹, x, y and u have the same meanings as in the formula (1), respectively, and preferred ranges thereof are also the same.

B¹¹ represents a repeating unit derived from an arbitrary vinyl monomer and may be constituted of a single component or plural components. Examples thereof include those as described above for A¹¹ in the foregoing formula (1).

z1 and z2 each represents % by mole of a respective repeating unit based on the whole of repeating units other than Y¹¹ and represents a value which is satisfied with the relations of (0≦z1≦40) and (0≦z2≦40), preferably (0≦z1≦30) and (0≦z2≦10), and especially preferably (0≦z1≦10) and (0≦z2≦5), provided that the total sum of x, y, z1 and z2 is 100% by mole. Also, t1 represents a value which is satisfied with the relation of (2≦t1≦10), preferably (2≦t1≦6), and especially preferably (2≦t1≦4). The copolymer represented by the foregoing formula (1-2) is more preferably satisfied with the relations of (40≦x≦60), (40≦y≦60) and (z2=0).

The polysiloxane partial structure which is introduced into the copolymer of the invention is especially preferably a structure represented by the following formula (I-3).

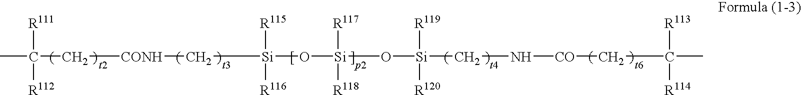

In the foregoing formula (1-3), R¹¹¹, R¹¹², R¹¹³ and R¹¹⁴ each independently represents a hydrogen atom, an alkyl group (preferably an alkyl group having from 1 to 5 carbon atoms, such as a methyl group and an ethyl group), an aryl group (preferably an aryl group having from 6 to 10 carbon atoms, such as a phenyl group and a naphthyl group), an alkoxycarbonyl group (preferably an alkoxycarbonyl group having from 2 to 5 carbon atoms, such as a methoxycarbonyl group and an ethoxycarbonyl group), or a cyano group; preferably an alkyl group or a cyano group; and especially preferably a methyl group or a cyano group.

R¹¹⁵ to R¹²⁰ each independently represents a hydrogen atom, an alkyl group (preferably an alkyl group having from 1 to 5 carbon atoms, such as a methyl group and an ethyl group), a haloalkyl group (preferably a fluorinated alkyl group having from 1 to 5 carbon atoms, such as a trifluoromethyl group and a pentafluoroethyl group), or a phenyl group; preferably a methyl group or a phenyl group; and especially preferably a methyl group.

t2 and t5 each independently represents an integer of from 1 to 10, preferably an integer of from 1 to 6, and especially preferably an integer of from 2 to 4. t3 and t4 each independently represents an integer of from 1 to 10, preferably an integer of from 1 to 6, and especially preferably an integer of from 2 to 4. p2 represents an integer of from 10 to 1,000, preferably an integer of from 20 to 500, and especially preferably an integer of from 50 to 200.

The polysiloxane partial structure represented by the foregoing formula (1-3) is preferably introduced in an amount in the range of from 0.01 to 20% by weight, more preferably in the range of from 0.05 to 10% by weight, and especially preferably in the range of from 0.5 to 5% by weight in the polymer which can be used in the invention.

By the introduction of the foregoing polysiloxane partial structure, not only antifouling properties and dustproof properties are imparted to the film but also slipperiness is imparted to the film surface so that such is advantageous in view of scar resistance.

In the polymer which is useful in the invention, in addition to the repeating unit derived from the foregoing fluorine-containing vinyl monomer and the repeating unit containing a (meth)acryloyl group in a side chain thereof, other vinyl monomer can be properly copolymerized, too from a variety of viewpoints such as adhesiveness to a substrate, Tg of a polymer (contributing to the film hardness), solubility in a solvent, transparency, and dustproof or antifouling properties. Such a vinyl monomer may be used in combination of plural kinds thereof depending upon the purpose. In this case, these vinyl monomers are preferably introduced in a total amount in the range of from 0 to 40% by mole, more preferably in the range of from 0 to 30% by mole, and especially preferably in the range of from 0 to 20% by mole in the copolymer.

The monomer unit which can be used together is not particularly limited, and examples thereof include olefins (for example, ethylene, propylene, isoprene, vinyl chloride, and vinylidene chloride), acrylic esters (for example, methyl acrylate, methyl acrylate, ethyl acrylate, 2-ethylhexyl acrylate, and 2-hydroxyethyl acrylate), methacrylic esters (for example, methyl methacrylate, ethyl methacrylate, butyl methacrylate, and 2-hydroxyethyl methacrylate), styrene derivatives (for example, styrene, p-hydroxymethylstyrene, and p-methoxystyrene), vinyl ethers (for example, methyl vinyl ether, ethyl vinyl ether, cyclohexyl vinyl ether, hydroxyethyl vinyl ether, and hydroxybutyl vinyl ether), vinyl esters (for example, vinyl acetate, vinyl propionate, and vinyl cinnamate), unsaturated carboxylic acids (for example, acrylic acid, methacrylic acid, cronic acid, maleic acid, and itaconic acid), acrylamides (for example, N,N-dimethylacrylamide, N-t-butyl acrylamide, and N-cyclohexyl acrylamide), methacrylamides (for example, N,N-dimethyl methacrylamide), and acrylonitrile.

Preferred examples of the polymer which is useful in the invention will be given below, but it should not be construed that the invention is limited thereto.

TABLE 1

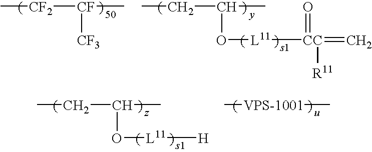

| | x | y | u | s1 | L¹¹ | R¹¹ |
|---|---|---|---|---|---|---|
| P-1 | 50 | 0 | 2 | 1 | *—CH₂CH₂O—** | H |
| P-2 | 50 | 0 | 2 | 1 | *—CH₂CH₂O—** | CH₃ |
| P-3 | 45 | 5 | 2 | 1 | *—CH₂CH₂O—** | H |
| P-4 | 40 | 10 | 2 | 1 | *—CH₂CH₂O—** | H |
| P-5 | 30 | 20 | 2 | 1 | *—CH₂CH₂O—** | H |
| P-6 | 50 | 0 | 2 | 0 | — | H |
| P-7 | 50 | 0 | 2 | 1 | *—C₄H₈O—** | H |
| P-8 | 50 | 0 | 2 | 1 | 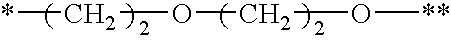 | H |
| P-9 | 50 | 0 | 2 | 1 | 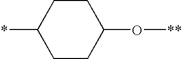 | H |
| P-10 | 50 | 0 | 2 | 1 | *—CH₂CH₂NH—** | H |
| P-11 | 50 | 0 | 3 | 1 | 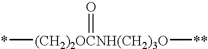 | H |
| P-12 | 50 | 0 | 3 | 1 | 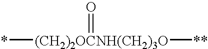 | CH₃ |
| P-13 | 50 | 0 | 3 | 1 | 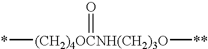 | CH₃ |
| P-14 | 50 | 0 | 3 | 1 | 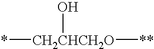 | H |
| P-15 | 50 | 0 | 3 | 1 | 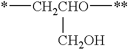 | H |
| P-16 | 50 | 0 | 3 | 1 | 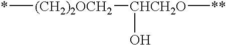 | H |
| P-17 | 50 | 0 | 3 | 1 | 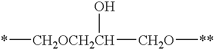 | CH₃ |
| P-18 | 50 | 0 | 3 | 1 | 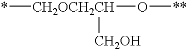 | CH₃ |
| P-19 | 40 | 10 | 2 | 1 | *—CH₂CH₂O—** | CH₃ |

* represents a polymer principal chain side; and ** represents a (meth)acryloyl group side.

In the foregoing table, “50/y/z” represents a molar ratio; u represents % by weight; and VPS-1001 represents a component derived from “VPS1001” (a trade name) which a polysiloxane-containing macro azo initiator as manufactured by Wako Pure Chemicals Industries, Ltd. (hereinafter the same).

TABLE 2

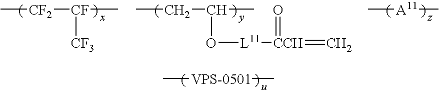

| | x | y | z | u | L¹¹ | A¹¹ |
|---|---|---|---|---|---|---|
| P-20 | 55 | 45 | 0 | 4 | *—CH₂CH₂O—** | — |
| P-21 | 45 | 55 | 0 | 4 | *—CH₂CH₂O—** | — |
| P-22 | 50 | 45 | 5 | 4 | 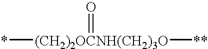 | 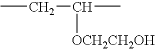 |
| P-23 | 50 | 45 | 5 | 4 | 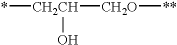 | 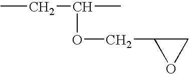 |
| P-24 | 50 | 45 | 5 | 4 | 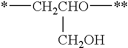 | 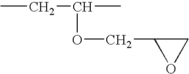 |
| P-25 | 50 | 40 | 10 | 4 | *—CH₂CH₂O—** | 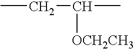 |
| P-26 | 50 | 40 | 10 | 4 | *—CH₂CH₂O—** | 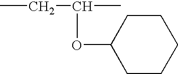 |
| P-27 | 50 | 40 | 10 | 4 | *—CH₂CH₂O—** | 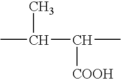 |

* represents a polymer principal chain side; and ** represents a (meth)acryloyl group side.

In the foregoing table, “x/y/z” represents a molar ratio; u represents % by weight; and VPS-1001 represents a component derived from “VPS0501” (a trade name) which a polysiloxane-containing macro azo initiator as manufactured by Wako Pure Chemicals Industries, Ltd.

TABLE 3

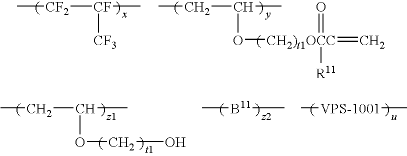

| | x | y | z1 | z2 | u | t1 | R¹¹ | B¹¹ |
|---|---|---|---|---|---|---|---|---|
| P-28 | 50 | 40 | 5 | 5 | 2 | 2 | H | 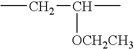 |
| P-29 | 50 | 35 | 5 | 10 | 2 | 2 | H | 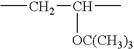 |
| P-30 | 40 | 40 | 10 | 10 | 2 | 4 | CH₃ | 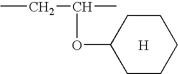 |

TABLE 4

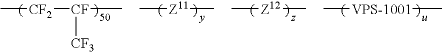

| | y | z | u | Z¹¹ | Z¹² |
|---|---|---|---|---|---|
| P-31 | 45 | 5 | 5 | 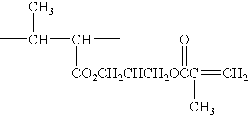 | 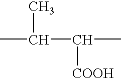 |
| P-32 | 40 | 10 | 10 | 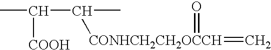 | 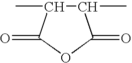 |

In the foregoing table, “x/y/z1/z2” and “50/y/z” each represents a molar ratio; u represents % by weight; and t1 represents the number of a methylene unit.

TABLE 5

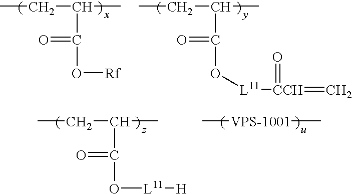

| | x | y | z | u | Rf | L¹¹ |
|---|---|---|---|---|---|---|
| P- | 60 | 40 | 0 | 5 | —CH₂CH₂C₈F₁₇(n) | —CH₂CH₂O— |
| 33 | | | | | | |
| P- | 60 | 30 | 10 | 5 | —CH₂CH₂C₄F₈H(n) | —CH₂CH₂O— |
| 34 | | | | | | |
| P- | 40 | 60 | 0 | 5 | —CH₂CH₂C₆F₁₂H(n) | —CH₂CH₂CH₂CH₂O— |
| 35 | | | | | | |

TABLE 6

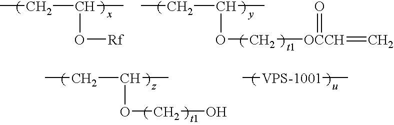

| | x | y | z | u | t1 | Rf |
|---|---|---|---|---|---|---|
| P- | 50 | 50 | 0 | 5 | 2 | —CH₂C₄F₈H(n) |
| 36 | | | | | | |
| P- | 40 | 55 | 5 | 5 | 2 | —CH₂C₄F₈H(n) |
| 37 | | | | | | |
| P- | 30 | 70 | 0 | 5 | 4 | —CH₂C₈F₁₇(n) |
| 38 | | | | | | |
| P- | 60 | 40 | 0 | 5 | 2 | —CH₂CH₂C₈F₁₆H(n) |
| 39 | | | | | | |

In the foregoing table, “x/y/z” represents a molar ratio; u represents % by weight; and t1 represents the number of a methylene unit.

TABLE 7

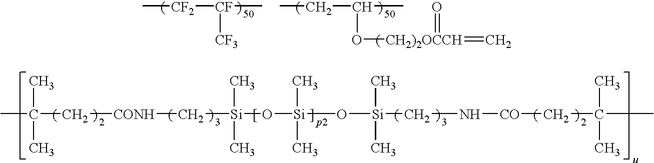

| | u | p2 |
|---|---|---|
| P-40 | 2 | 50 |
| P-41 | 2 | 100 |
| P-42 | 2 | 200 |
| P-43 | 2 | 500 |
| P-44 | 2 | 1000 |
| P-45 | 3 | 100 |
| P-46 | 4 | 100 |
| P-47 | 5 | 100 |
| P-48 | 10 | 100 |
| P-49 | 20 | 100 |

In the foregoing table, the ratio (50/50) of vinyl monomer components represents a molar ratio; u represents % by weight; and p2 represents the number of a dimethylsiloxane partial structure.

### (Polymer Having a Polysiloxane Partial Structure in a Polymer Side Chain)

Next, a polymer having a polysiloxane partial structure in a polymer side chain will be hereunder described in detail.

A form of the polymer which is especially preferable in the invention is a form represented by the following formula (2). Such a compound can work as both a compound capable of being hardened upon irradiation with ionizing radiations and a compound having a polysiloxane partial structure.

Formula (2)

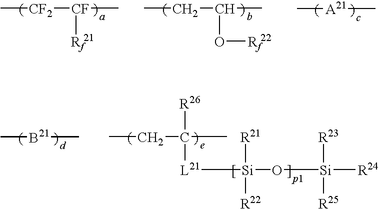

In the formula (2), R_{f}²¹ represents a perfluoroalkyl group having from 1 to 5 carbon atoms; R_{f}²² represents a fluorine-containing alkyl group having a linear, branched or alicyclic structure having from 1 to 30 carbon atoms and may contain an ether bond; A²¹ represents a constitutional unit containing a reactive group capable of participating in a crosslinking reaction; B represents an arbitrary constitutional component; R²¹ and R²² may be the same or different and each represents an alkyl group or an aryl group; p1 represents an integer of from 10 to 500; R²³ to R²⁵ each independently represents a substituted or unsubstituted monovalent organic group or a hydrogen atom; R²⁶ represents a hydrogen atom or a methyl group; and L²¹ represents an arbitrary connecting group having from 1 to 20 carbon atom or a single bond.

a to d each represents a molar fraction (%) of a respective constitutional component exclusive of a polysiloxane-containing polymerization unit and represents a value which is satisfied with the relations of (10≦(a+b)≦55), (10≦a≦55) (more preferably (40≦a≦55)), (0≦b≦45) (more preferably (0≦b≦30)), (10≦c≦50) (more preferably (20≦c≦50)) and (0≦d≦40) (more preferably (0≦d≦30)); and e represents a weight fraction (%) of a polysiloxane-containing polymerization unit based on the weight of the whole of other components and is satisfied with the relation of (0.01≦e≦20) (preferably (0.1≦e≦10), and more preferably (0.5≦e≦5)).

The perfluoroolefin is preferably a perfluoroolefin having from 3 to 7 carbon atoms; perfluoropropylene and perfluorobutylene are preferable from the viewpoint of polymerization reactivity; and perfluoropropylene is especially preferable from the viewpoint of easiness of availability.

The content of the perfluoroolefin in the polymer is from 10 to 55% by mole. For the purpose of realizing a low refractive index of the raw material, it is desired to increase a rate of introduction of the perfluoroolefin. However, in a general solution system radical polymerization reaction, the introduction of approximately 50 to 70% by mole is a limit in view of polymerization reactivity, and more introduction is difficult. In the invention, the content of the perfluoroolefin in the polymer is preferably from 10 to 55% by mole, and especially preferably from 40 to 55% by mole.

### (Fluorine-Containing Vinyl Ether)

In the invention, for the purpose of realizing a low refractive index, the compound represented by the formula (2) may be copolymerized with a fluorine-containing vinyl ether represented by the following formula (M1). Though this copolymerization component may be introduced in a copolymerization range of from 0 to 45% by mole in the polymer, it is preferably introduced in a copolymerization range of from 0 to 30% by mole, and especially preferably from 0 to 20% by mole. In particular, in the case where a film hardness of the low refractive index layer is to be fixed high (for example, corresponding to the case where a large amount of a low refractive index filler is contained in the low refractive index layer and an increase of the film strength is rather preferable than a decrease of the refractive index of the layer by a binder polymer), the rate of introduction of the copolymerization component represented by the fluorine-containing vinyl ether represented by the following formula (M1) is preferably 0% by mole. This is because by eliminating this copolymerization component, a rate of introduction of a polymerization unit containing a reactive group capable of participating in a crosslinking reaction into a side chain thereof as described later can be increased.

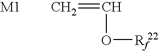

In the formula (M1), R_{f}²² represents a fluorine-containing alkyl group having from 1 to 30 carbon atoms, preferably a fluorine-containing alkyl group having from 1 to 20 carbon atoms, and especially preferably a fluorine-containing alkyl group having from 1 to 15 carbon atoms; may be linear [for example, —CF₂CF₃, —CH₂(CF₂)₄H, —CH₂(CF₂)₈CF₃, and —CH₂CH₂(CF₂)₄H]; may have a branched structure [for example, —CH(CF₃)₂, —CH₂CF(CF₃)₂, —CH(CH₃)CF₂CF₃, and —CH(CH₃)(CF₂)₅CF₂H]; may have an alicyclic structure (preferably a 5-membered ring or a 6-membered ring, for example, a perfluorocyclohexyl group, a perfluorocyclopentyl group, and an alkyl group substituted with such a group); and may contain an ether bond (for example, —CH₂OCH₂CF₂CF₃, —CH₂CH₂OCH₂C₄F₈H, —CH₂CH₂OCH₂CH₂C₈F₁₇, and —CH₂CH₂OCF₂CF₂OCF₂CF₂H).

The foregoing monomer represented by the formula (M1) can be, for example, synthesized by a method of making a fluorine-containing alcohol act to a split-off group-substituted alkyl vinyl ether such as vinyloxyalkyl sulfonates and vinyloxyalkyl chlorides in the presence of a base catalyst as described in Macromolecules, Vol. 32 (21), p. 7122 (1999), JP-A-2-721, and so on; a method of mixing a fluorine-containing alcohol and a vinyl ether such as butyl vinyl ether in the presence of a palladium catalyst, thereby undergoing exchange of the vinyl group as described in WO 92/05135; and a method of reacting a fluorine-containing ketone and dibromoethane in the presence of a potassium fluoride catalyst and then undergoing a dehydrobromination reaction by an alkaline catalyst as described in U.S. Pat. No. 3,420,793.

Preferred examples of the constitutional component represented by the formula (M1) will be given below.

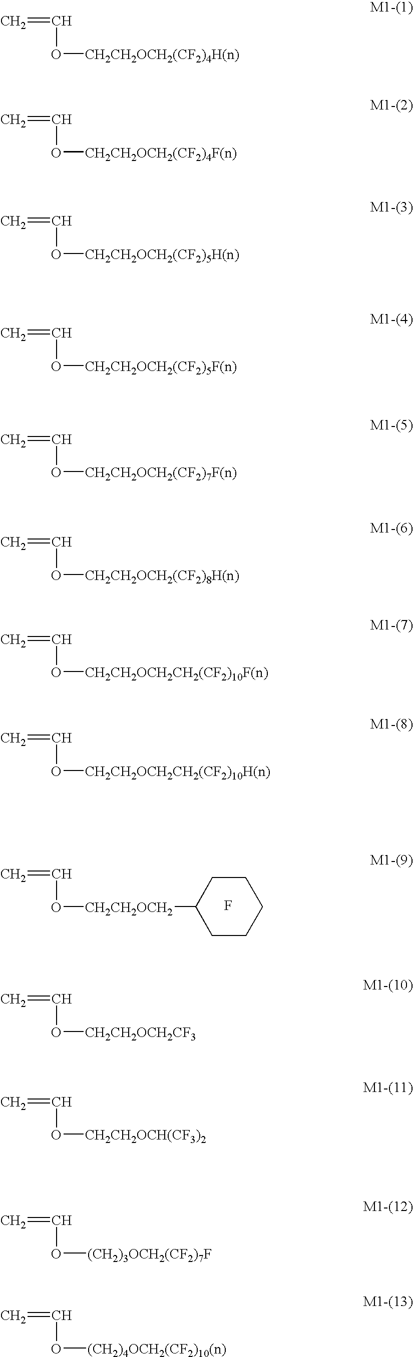

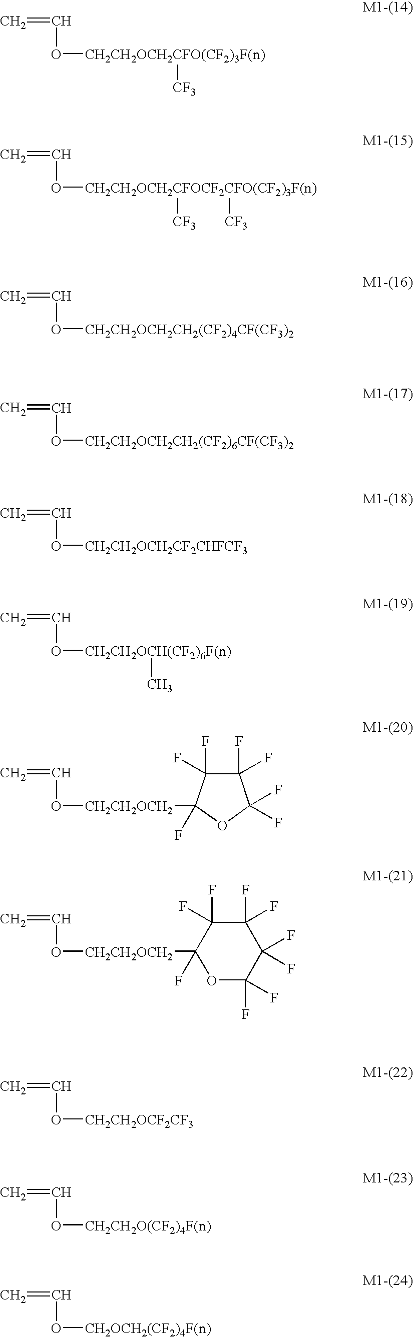

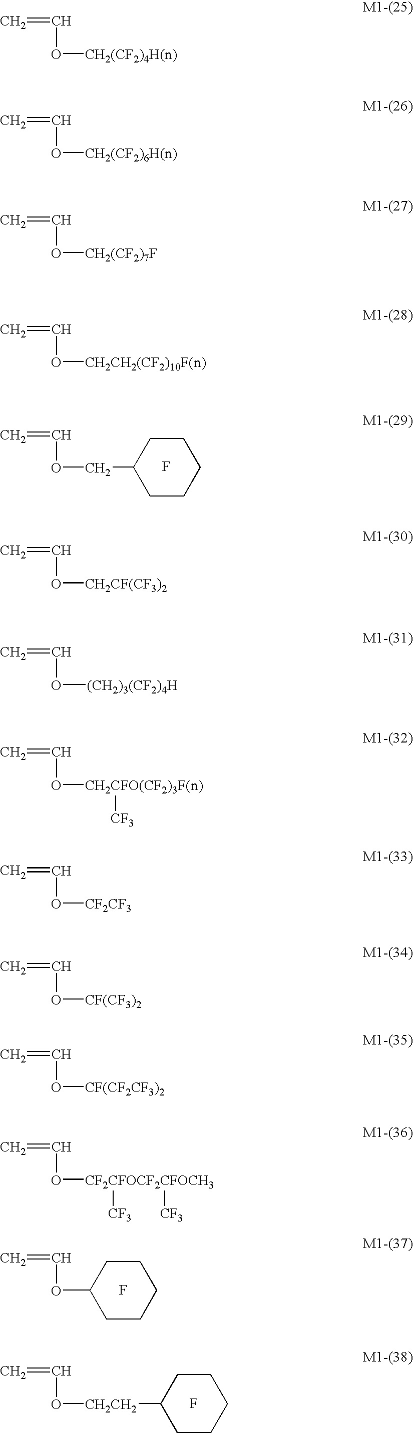

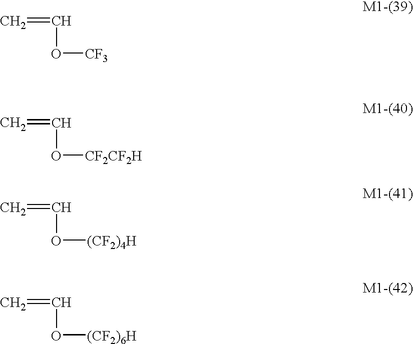

### (Constitutional Unit Having a Reactive Group Capable of Participating in a Crosslinking Reaction)

In the invention, a structure of a constitutional unit containing a reactive group capable of participating in a crosslinking reaction (hereinafter sometimes referred to as “crosslinking reactive group”) which is contained in the fluorine-containing polymer constituting the low refractive index layer, for example, the compound represented by the formula (2) is not particularly limited. However, from the viewpoint of polymerization reactivity with the fluorine-containing olefin, vinyl group-containing compounds are preferable; and vinyl ethers and vinyl esters are more preferable.

Examples of the foregoing crosslinking reactive group include an active hydrogen atom-containing group (for example, a hydroxyl group, an amino group, a carbamoyl group, a mercapto group, a β-ketoester group, a hydrosilyl group, and a silanol group), a cationic polymerizable group (for example, an epoxy group, an oxetanyl group, an oxazolyl group, and a vinyloxy group), an unsaturated double bond-containing group capable of being added or polymerized by an acid anhydride or a radical species (for example, an acryloyl group, a methacryloyl group, and an allyl group), a hydrolyzable silyl group (for example, an alkoxysilyl group and an acyloxysilyl group), and a group capable of being substituted with a nucleating agent (for example, an active halogen atom and a sulfonic acid ester).

Of these, the unsaturated double bond-containing group can be formed by a common method such as a method in which after synthesizing a hydroxyl group-containing polymer, an acid halide (for example, (meth)acrylic acid chloride), an acid anhydride (for example, (meth)acrylic anhydride) or (meth)acrylic acid is made to act; and a method in which after polymerizing a vinyl monomer containing a 3-chloropropoionic acid ester site, dehydrochlorination is carried out. Also, other functional group may be similarly introduced in the monomer stage or may be introduced after synthesizing a polymer containing a reactive group such as a hydroxyl group.

Of the foregoing crosslinking reactive groups, a hydroxyl group, an epoxy group, a (meth)acryloyl group, and a hydrolyzable silyl group are preferable; an epoxy group and a (meth)acryloyl group are more preferable; and a (meth)acryloyl group is the most preferable. The amount of introduction of such a crosslinking reactive group-containing copolymerization component is in the range of from 10 to 50% by mole, preferably in the range of from 20 to 50% by mole, and especially preferably in the range of from 25 to 50% by mole.

Preferred examples of the polymerization unit capable of participating in a crosslinking reaction will be given below, but it should not be construed that the invention is limited thereto.

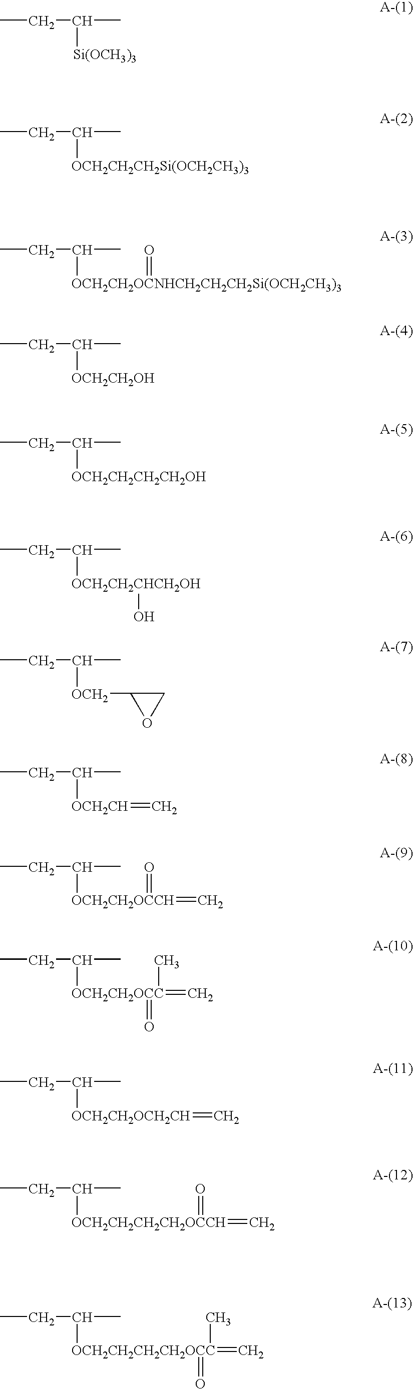

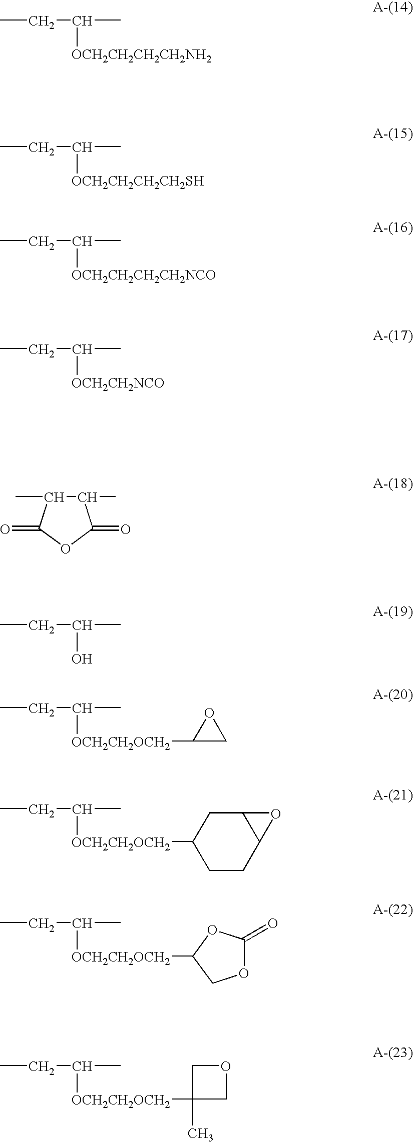

### (Polysiloxane Partial Structure)

A polysiloxane partial structure in the polymer having a polysiloxane partial structure in a side chain thereof which is used in the invention will be hereunder described. In general, the polysiloxane partial structure contains a repeating siloxane site represented by the following formula (2-1).

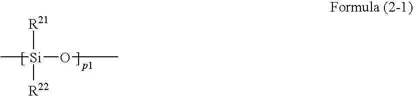

In the formula (2-1), R²¹ and R²² may be the same or different and each represents an alkyl group or an aryl group. The alkyl group is preferably an alkyl group having from 1 to 4 carbon atoms, such as a methyl group, a trifluoromethyl group, and an ethyl group. The aryl group is preferably an aryl group having from 6 to 20 carbon atoms, such as a phenyl group and a naphthyl group. Of these, a methyl group and a phenyl group are preferable; and a methyl group is especially preferable. p1 represents an integer of from 10 to 500, preferably from 10 to 350, and especially preferably from 10 to 250.

The polymer having a polysiloxane structure represented by the formula (2-1) in a side chain thereof can be synthesized by a method in which with respect to a polymer containing a reactive group (for example, an epoxy group, a hydroxyl group, a carboxyl group, and an acid anhydride group), a polysiloxane containing a corresponding reactive group (for example, an amino group, a mercapto group, a carboxyl group, and a hydroxyl group with respect to the epoxy group or acid anhydride group) at one terminal thereof (for example, SILAPLANE Series (manufactured by Chisso Corporation) is introduced by a polymerization reaction as described in, for example, J. Appl. Polym. Sci., Vol. 2000, page 78 (1955) and JP-A-56-28219; and a method of polymerizing a polysiloxane-containing silicon macromer, and the both methods can be preferably employed. In the invention, a method for achieving the introduction by polymerizing a silicon macromer is more preferable.

The polymerization unit containing a repeating siloxane side in a side chain thereof preferably accounts for from 0.01 to 20% by weight, more preferably from 0.1 to 10 % by weight, and especially preferably from 0.5 to 5% in the copolymer.

Preferred examples of the polymerization unit containing a repeating siloxane site in a side chain thereof which is used in the invention will be given below, but it should not be construed that the invention is limited thereto.

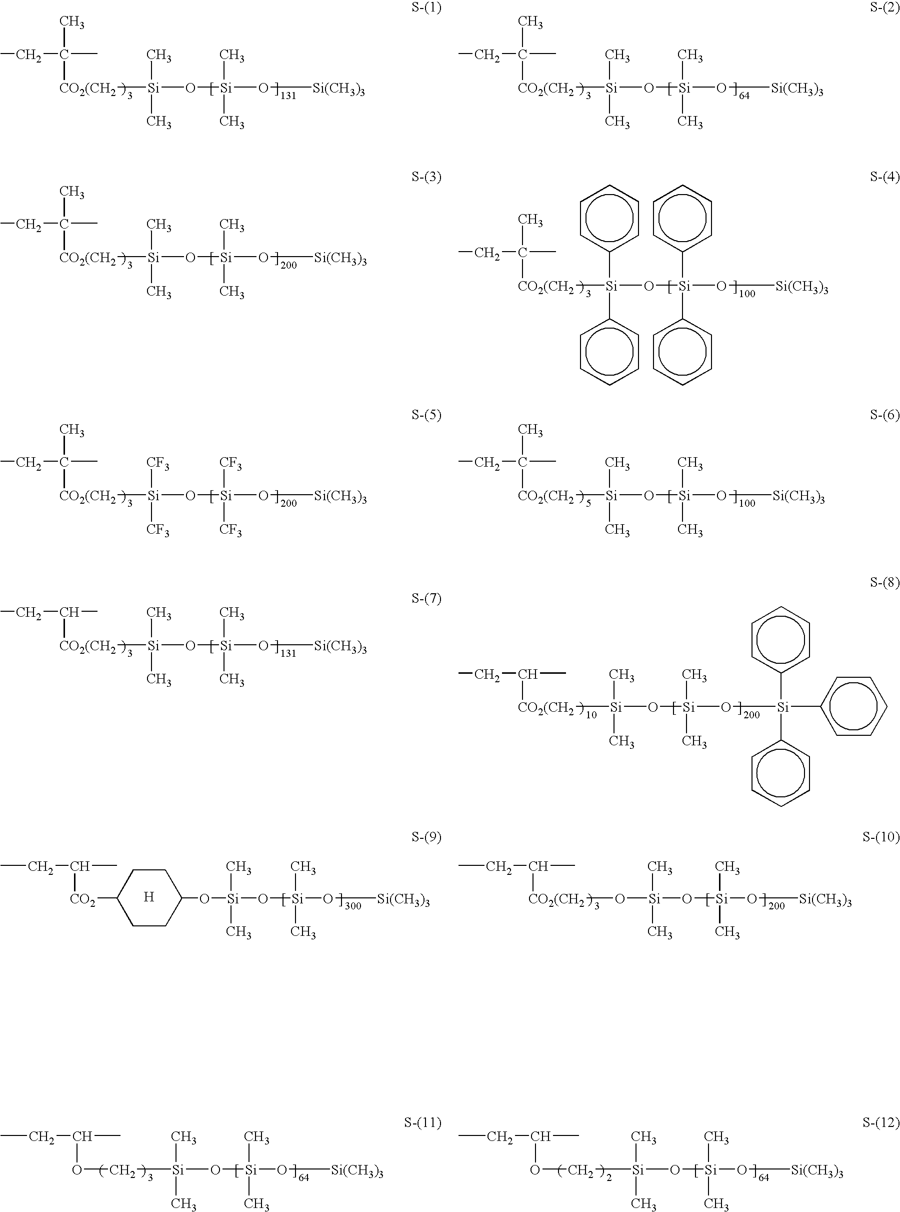

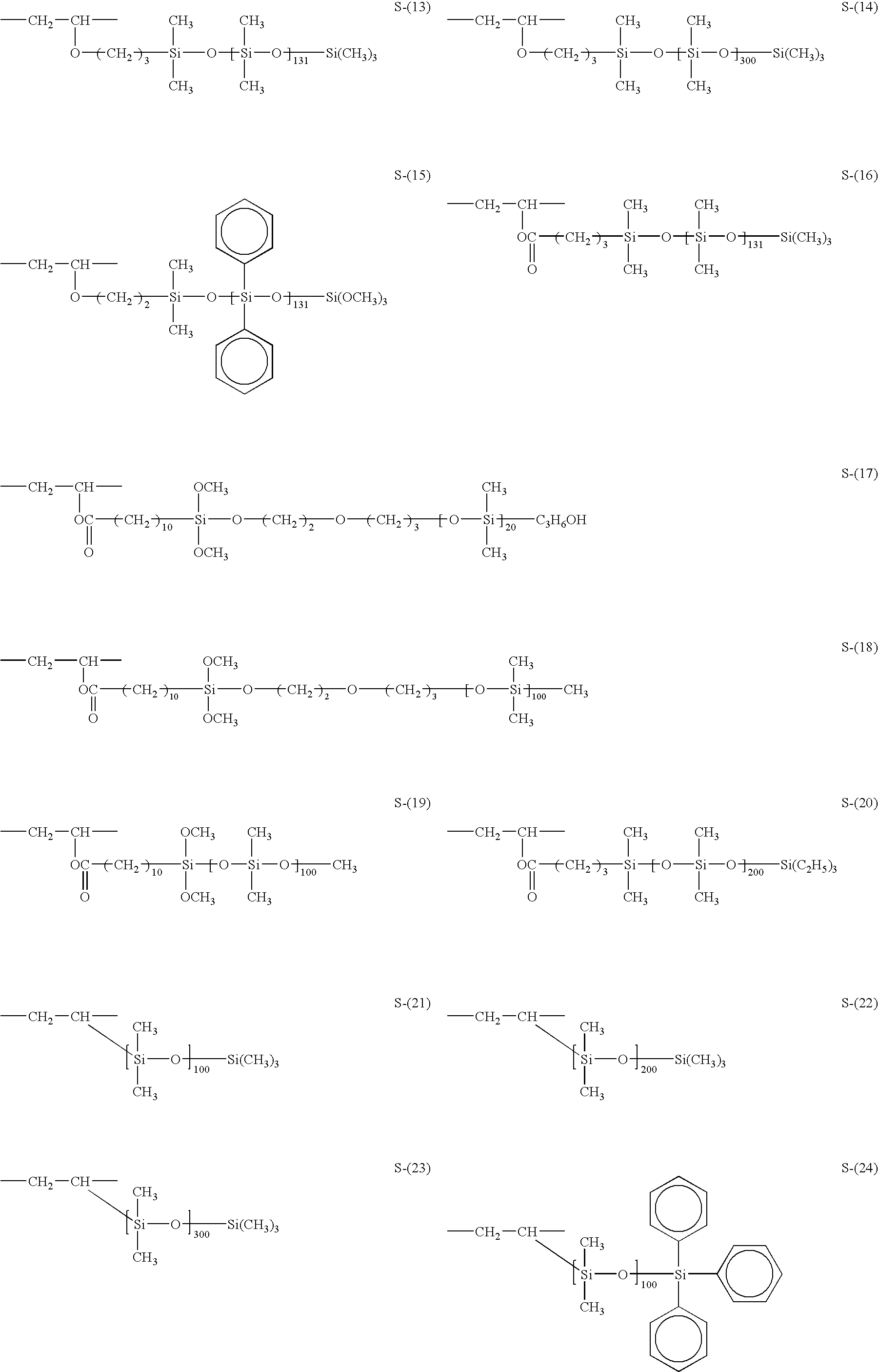

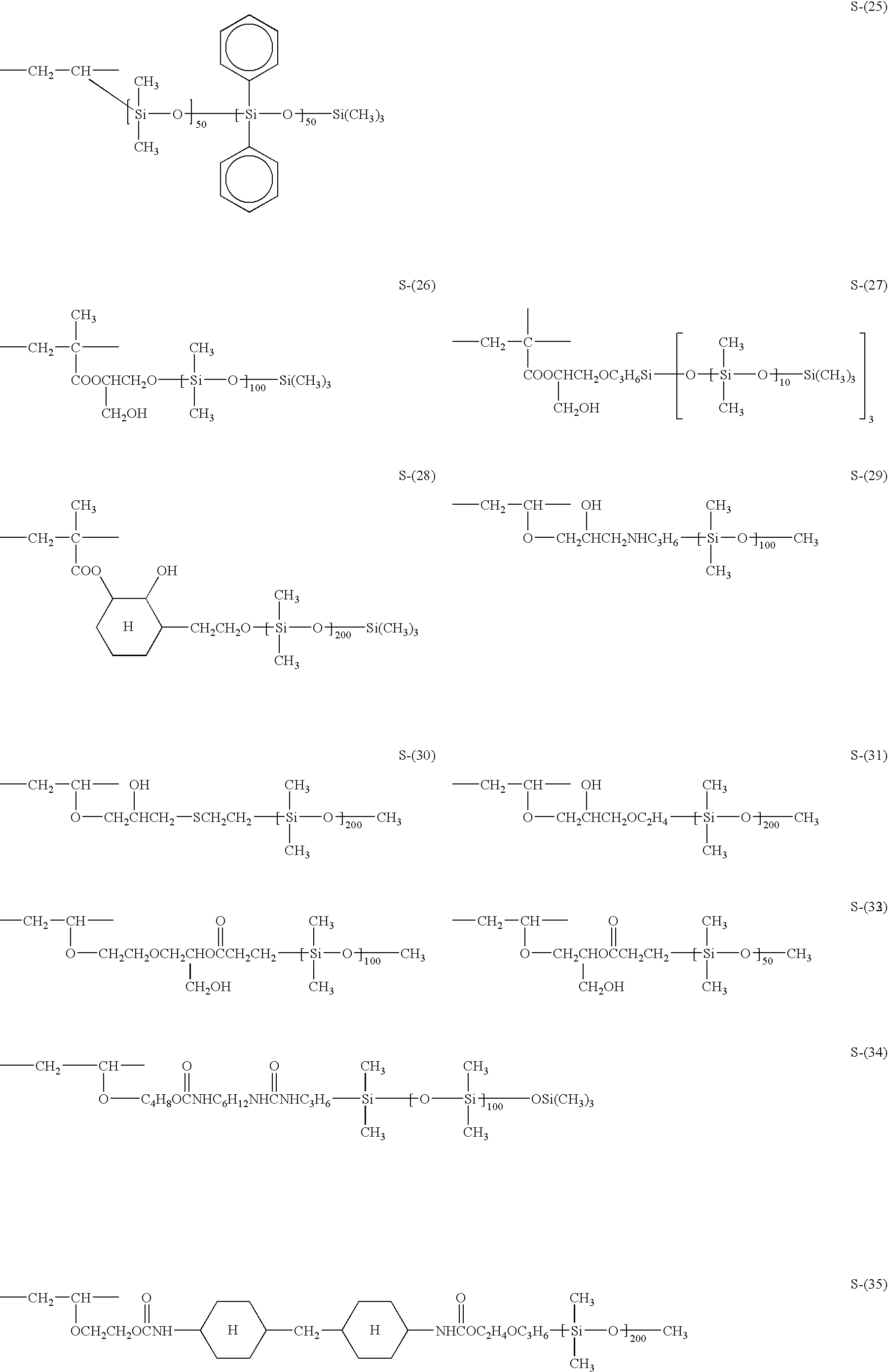

Besides the foregoing, a polymerization unit formed by subjecting a polysiloxane containing a reactive group having reactivity in one end thereof to polymerization reaction with a reactive group which other polymerization unit contains can be used as the polymerization unit containing a repeating siloxane side in a side chain thereof. Examples of such a commercially available polysilane include:

S-(36) SILAPLANE FM-0711 (manufactured by Chisso Corporation),

S-(37) SILAPLANE FM-0721 (manufactured by Chisso Corporation), and

S-(38) SILAPLANE FM-0725 (manufactured by Chisso Corporation)

### (Other Copolymerization Components)

Other copolymerization components than those as described previously can be properly selected from the viewpoints of hardness, adhesiveness to a substrate, solubility in a solvent, transparency, and so on.

Examples of such a copolymerization component include vinyl ethers such as methyl vinyl ether, ethyl vinyl ether, t-butyl vinyl ether, n-butyl vinyl ether, cyclohexyl vinyl ether, and isopropyl vinyl ether; and vinyl esters such as vinyl acetate, vinyl propionate, vinyl butyrate, and vinyl cyclohexanecarboxylate. The amount of introduction of such a copolymerization component is in the range of from 0 to 40% by mole, preferably from 0 to 30% by mole, and especially preferably from 1 to 20% by mole.

Specific examples of the polymer which is useful in the invention will be given in the following Tables 8 and 9, but it should not be construed that the invention is limited thereto. Incidentally, in the Tables 8 and 9, a combination of polymerization units is expressed; and a molar fraction of a component exclusive of a silicon-containing polymerization unit and a weight fraction of the silicon-containing polymerization unit are shown.

TABLE 8
Fluorine-containing polymer

| | Basic constitution (molar fraction (%)) | | | | | | | Constitutional unit | | Weight |
|---|---|---|---|---|---|---|---|---|---|---|
| | | | | Constitutional unit | | Other | | having a polysiloxane | | average |
| | | Fluorine-containing | | containing crosslinking | | copolymerization | | partial structure | | molecular |
| | Hexafluoro- | vinyl ether | | reactive group | | component | | (weight fraction (%)) | | weight |
| No. | propylene | Kind | Amount | Kind | Amount | Kind* | Amount | Kind | Amount | (×10⁴) |
| PP-1 | 50 | — | — | A-(4)/A-(9) | 5/45 | — | — | S-(36) | 2 | 1.9 |
| PP-2 | 50 | — | — | A-(4)/A-(9) | 10/40 | — | — | S-(37) | 2 | 3.1 |
| PP-3 | 50 | — | — | A-(4)/A-(9) | 15/35 | — | — | S-(38) | 1 | 3.3 |
| PP-4 | 50 | — | — | A-(4)/A-(10) | 5/45 | — | — | S-(38) | 1 | 4.5 |
| PP-5 | 50 | — | — | A-(4)/A-(10) | 10/40 | — | — | S-(36) | 2 | 2.5 |
| PP-6 | 50 | — | — | A-(4)/A-(10) | 15/35 | — | — | S-(37) | 2 | 5.1 |
| PP-7 | 50 | — | — | A-(5)/A-(12) | 5/45 | — | — | S-(11) | 1 | 3.5 |
| PP-8 | 50 | — | — | A-(5)/A-(12) | 10/40 | — | — | S-(16) | 2 | 2.8 |
| PP-9 | 50 | — | — | A-(5)/A-(12) | 5/45 | — | — | S-(17) | 1 | 4.5 |
| PP-10 | 50 | — | — | A-(5)/A-(12) | 10/40 | — | — | S-(37) | 2 | 4.2 |
| PP-11 | 50 | — | — | A-(9) | 50 | — | — | S-(37) | 2 | 3.2 |
| PP-12 | 50 | — | — | A-(10) | 50 | — | — | S-(36) | 2 | 3.7 |
| PP-13 | 50 | — | — | A-(12) | 50 | — | — | S-(38) | 1 | 2.8 |
| PP-14 | 50 | — | — | A-(13) | 50 | — | — | S-(37) | 1 | 3.1 |
| PP-15 | 50 | M1-(1) | 10 | A-(9) | 40 | — | — | S-(36) | 2 | 7.1 |
| PP-16 | 50 | M1-(1) | 10 | A-(4)/A-(9) | 5/35 | — | — | S-(37) | 1 | 6.3 |
| PP-17 | 50 | M1-(5) | 10 | A-(4)/A-(10) | 5/35 | — | — | S-(37) | 2 | 4.1 |
| PP-18 | 50 | M1-(5) | 10 | A-(5)/A-(12) | 5/35 | — | — | S-(38) | 1 | 3.5 |
| PP-19 | 50 | — | — | A-(4)/A-(9) | 5/35 | EVE | 10 | S-(11) | 1 | 4.8 |
| PP-20 | 50 | — | — | A-(9) | 35 | EVE | 15 | S-(17) | 1 | 1.6 |

Kind* EVE: Ethyl vinyl ether

TABLE 9
Fluorine-containing polymer

| | Basic constitution (molar fraction (%)) | | | | | | | Constitutional unit | | Weight |
|---|---|---|---|---|---|---|---|---|---|---|
| | | | | Constitutional unit | | Other | | having a polysiloxane | | average |
| | | Fluorine-containing | | containing crosslinking | | copolymerization | | partial structure | | molecular |
| | Hexafluoro- | vinyl ether | | reactive group | | component | | (weight fraction (%)) | | weight |
| No. | propylene | Kind | Amount | Kind | Amount | Kind* | Amount | Kind | Amount | (×10⁴) |
| PP-21 | 50 | — | — | A-(4)/(A)-(8) | 5/45 | — | — | S-(36) | 3 | 1.6 |
| PP-22 | 50 | — | — | A-(8) | 40 | EVE | 10 | S-(5) | 2 | 3.5 |
| PP-23 | 50 | M1-(1) | 10 | A-(8) | 40 | — | — | S-(37) | 3 | 3.0 |
| PP-24 | 50 | M1-(5) | 10 | A-(8) | 40 | — | — | S-(38) | 2 | 4.6 |
| PP-25 | 50 | — | — | A-(8)/A-(9) | 10/40 | — | — | S-(36) | 2 | 2.6 |
| PP-26 | 50 | — | — | A-(8)/A-(12) | 10/40 | — | — | S-(36) | 1 | 6.8 |
| PP-27 | 50 | — | — | A-(2)/A-(9) | 10/40 | — | — | S-(37) | 2 | 2.7 |
| PP-28 | 50 | — | — | A-(2)/A-(10) | 10/40 | — | — | S-(38) | 1 | 9.1 |
| PP-29 | 50 | — | — | A-(6)/A-(8) | 5/45 | — | — | S-(11) | 1 | 2.6 |
| PP-30 | 50 | — | — | A-(6)/A-(8) | 10/40 | — | — | S-(17) | 1 | 3.6 |
| PP-31 | 50 | — | — | A-(4)/A-(9) | 5/35 | tBVE | 10 | S-(16) | 1 | 1.9 |
| PP-32 | 50 | — | — | A-(5)/A-(12) | 5/40 | tBVE | 5 | S-(5) | 1 | 2.4 |
| PP-33 | 50 | — | — | A-(9)/A-(10) | 25/25 | — | — | S-(36) | 2 | 3.3 |
| PP-34 | 50 | — | — | A-(7) | 50 | — | — | S-(37) | 2 | 4.1 |
| PP-35 | 50 | M1-(1) | 10 | A-(7) | 40 | — | — | S-(38) | 1 | 2.2 |
| PP-36 | 50 | M1-(5) | 5 | A-(6)/A-(7) | 5/40 | — | — | S-(11) | 2 | 3.5 |
| PP-37 | 50 | — | — | A-(2)/A-(7) | 10/40 | — | — | S-(37) | 2 | 4.3 |
| PP-38 | 50 | — | — | A-(2)/A-(6) | 30/10 | EVE | 10 | S-(17) | 2 | 4.6 |
| PP-39 | 50 | — | — | A-(2)/A-(5) | 40/10 | — | — | S-(16) | 2 | 2.2 |
| PP-40 | 50 | M1-(5) | 10 | A-(2) | 40 | — | — | S-(38) | 1 | 1.9 |

Kind* EVE: Ethyl vinyl ether, tBVE: t-Butyl vinyl ether

The polymer having a polysiloxane structure in a principal chain or side chain thereof which is a compound having a polysiloxane partial structure to be used in the invention preferably has a number average molecular weight, as reduced into polystyrene by gel permeation chromatography, in the range of from 5,000 to 500,000, and more preferably in the range of from 5,000 to 300,000.

The synthesis of the foregoing polymer having a polysiloxane structure in a principal chain or side chain thereof can be carried out by various polymerization methods, for example, solution polymerization, precipitation polymerization, suspension polymerization, precipitation polymerization, block polymerization, and emulsion polymerization to synthesize a precursor of a hydroxyl group-containing polymer or the like, followed by introducing a (meth)acryloyl group by the foregoing polymerization reaction. The polymerization reaction can be carried out by an arbitrary operation such as a batchwise operation, a semi-continuous operation, and a continuous operation.

Examples of a method for initiating the polymerization include a method of using a radical initiator and a method of irradiating light or radiations. These polymerization methods and method for initiating the polymerization are described in, for example, Teiji Tsuruta, Kobunshi Gosei Hoho (Polymer Synthesis Methods, Revised Edition (published by Nikkan Kogyo Shimbun Ltd., 1971); and Takayuki Otsu and Masayoshi Kinoshita, Kobunshi Gosei no Jikkenho (Experimental Methods of Polymer Synthesis), published by Kagaku-dojin Publishing Company, Inc., pages 124 to 125 (1972).

Among the foregoing polymerization methods, a solution polymerization method using a radical initiator is especially preferable. Examples of a solvent which is used in the solution polymerization method include various solvents such as ethyl acetate, butyl acetate, acetone, methyl ethyl ketone, methyl isobutyl ketone, cyclohexanone, tetrahydrofuran, dioxane, N,N-dimethylformamide, N,N-dimethylacetamide, benzene, toluene, acetonitrile, methylene chloride, chloroform, dichloroethane, methanol, ethanol, 1-propanol, 2-propanol, and 1-butanol. Such an organic solvent may be used singly or in admixture of two or more kinds thereof, or may be used as a mixed solvent with water.

The polymerization temperature must be set up in relation to the molecular weight of a formed polymer, the kind of an initiator, and so on. Though the polymerization can be carried out at not higher than 0° C. or 100° C. or higher, it is preferred to carry out the polymerization at a temperature in the range of from 50 to 100° C.

Though the reaction pressure can be properly selected, it is desired that the reaction pressure is usually from about 1 to 100 kg/cm², and especially from about 1 to 30 kg/cm². The reaction time is from about 5 to 30 hours.

As a reprecipitation solvent of the resulting polymer, isopropanol, hexane, methanol, and so on are preferable.

(Joint Use with Polyfunctional Monomer)

From the viewpoints of increasing film strength, improving coating surface properties and stabilizing surface properties at the time of adding a fine particle, it is preferred to use the ionizing radiation hardenable compound of the invention together with a compound containing two or more ethylenically unsaturated groups. Furthermore, the ionizing radiation hardenable compound of the invention itself may be a compound containing two or more ethylenically unsaturated groups. Examples of the monomer containing two or more ethylenically unsaturated groups include esters of a polyhydic alcohol and (meth)acrylic acid [for example, ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, and polyester polyarylates], vinylbenzene and derivatives thereof (for example, 1,4-divinylbenzene, 2-acryloylethyl 4-vinylbenzoate, and 1,4-divinylcyclohexanone), vinylsulfones (for example, divinylsulfone), acrylamides (for example, methylenebisacrylamide), and methacrylamides. Two or more kinds of such a monomer may be used together.

### [Compound Having a Polysiloxane Partial Structure] (Constitutional Component (C) of Low Refractive Index Layer of the Invention)

For the purpose of imparting antifouling properties or the like, a compound having a polysiloxane partial structure represented by the following formula (I) can be added in the low refractive index layer in the invention.

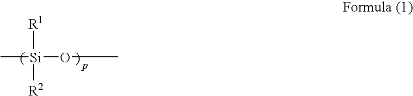

In the formula (I), R¹ and R² may be the same or different and each represents an alkyl group or an aryl group; and p represents an integer of from 10 to 500.

It is preferable that the compound having a polysiloxane partial structure contains at least one reactive group. Examples thereof include KF-100T, X-22-169AS, I(F-102, X-22-37011E, X-22-164B, X-22-5002, X-22-173B, X-22-174D, X-22-167B and X-22-161AS (trade names, as manufactured by Shin-Etsu Chemical Co., Ltd.); and AK-5, AK-30 and AK-32 (trade names, as manufactured by Toagosei Co., Ltd.). Above all, examples of a preferred silicone based compound containing a photopolymerizable functional group in a molecule thereof include X-22-174DX, X-22-2426, X-22-164B, X22-164C and X-22-1821, all of which are a trade name as manufactured by Shin-Etsu Chemical Co, Ltd.); FM-0725, FM-7725, FM-6621, FM-1121, SILAPLANE FM0275 and SILAPLANE FM0721, all of which are manufactured by Chisso Corporation; and DMS-U22, RMS-033, RMS-083, UMS-182, DMS-H21, DMS-H31, HMS-301, FMS121, FMS123, FMS131, FMS141 and FMS221, all of which are a trade name, as manufactured by Gelest. However, it should not be construed that the invention is limited thereto. Furthermore, silicone based compounds as described in Tables 2 and 3 of JP-A-2003-112383 can be preferably used.

On this occasion, the polysiloxane is preferably added in an amount in the range of from 0.5 to 10% by weight, and especially preferably in the range of from 1 to 5% by weight based on the whole of solids of the low refractive index layer.

### [Ionizing Radiation Hardenable Fluorine-Containing Antifouling Agent] (Constitutional Component (D) of Low Refractive Index Layer of the Invention)

In the low refractive index layer of the invention, for the purpose of imparting characteristics such as antifouling properties, water-proof properties, chemical resistance, and slipperiness, it is preferred to properly add a fluorine based antifouling agent or slipping agent or the like. From the viewpoints of inhibiting the transfer of a fluorine compound onto the back surface at the time of preservation of a coated material in a rolled state and improving the scar resistance of the coating film, it is preferred to use a fluorine-containing antifouling agent containing an ionizing radiation hardenable functional group. The fluorine-containing antifouling agent containing an ionizing radiation hardenable functional group is an antifouling agent containing a fluorine based compound. Though the ionizing radiation hardenable functional group is not particularly limited, it is preferably a functional group containing an unsaturated double bond, and most preferably a methacryloyloxy group or an acryloyloxy group.

As the fluorine based compound, a fluoroalkyl group-containing compound is preferable. The fluoroalkyl group preferably has from 1 to 20 carbon atoms, and more preferably from 1 to 10 carbon atoms; may be linear [for example, —CF₂CF₃, —CH₂(CF₂)₄H, —CH₂(CF₂)₈CF₃, and —CH₂CH₂(CF₂)₄H]; may have a branched structure [for example, —CH(CF₃)₂, —CH₂CF(CF₃)₂, —CH(CH₃)CF₂CF₃, and —CH(CH₃)—(CF₂)₅CF₂H]; may have an alicyclic structure (preferably a 5-membered ring or a 6-membered ring, for example, a perfluorocyclohexyl group, a perfluorocyclopentyl group, and an alkyl group substituted with such a group); and may contain an ether bond (for example, —CH₂OCH₂CF₂CF₃, —CH₂CH₂OCH₂C₄F₈H, —CH₂CH₂OCH₂CH₂C₈F₁₇, and —CH₂CH₂OCF₂CF₂OCF₂CF₂H). A plural number of the fluoroalkyl group may be contained in the same molecule.

It is preferable that the fluorine based compound further contains a substituent capable of contributing to bond formation or compatibility with the film of the low refractive index layer. The substituent may be the same or different. It is preferable that the fluorine based compound contains plural substituents. Preferred examples of the substituent include an acryloyl group, a methacryloyl group, a vinyl group, an aryl group, a cinnamoyl group, an epoxy group, an oxetanyl group, a hydroxyl group, a polyoxyalkylene group, a carboxyl group, and an amino group. The fluorine based compound may be a polymer or oligomer with a fluorine atom-free compound. Its molecular weight is not particularly limited. Though the content of a fluorine atom of the fluorine based compound is not particularly limited, it is preferably 20% by weight or more, especially preferably from 30 to 70% by weight, and most preferably from 40 to 70% by weight. Examples of the preferred fluorine based compound include R-2020, M-2020, R-3833 and M-3833 (trade names, as manufactured by Daikin Industries, Ltd.); and MEGAFAC F-171, MEGAFAC F-172, MEGAFAC F-179A and DEFENSER MCF-300 (trade names, as manufactured by Dainippon Ink and Chemicals, Incorporated). However, it should not be construed that the invention is limited thereto.

Furthermore, in the invention, preferred embodiments of the compound in which the ionizing radiation hardenable functional group is a (meth)acryloyloxy group (formulae (F-1), (F-2) and (F-3)) will be hereunder described in detail.

As a first preferred embodiment, there can be enumerated a compound represented by the following formula (F-1).

Rf(CF₂CF₂)ₙCH₂CH₂R²OCOCR¹═CH₂ Formula (F-1)

In the formula (F-1), Rf represents a fluoroalkyl group having from 1 to 10 carbon atoms; R¹ represents a hydrogen atom or a methyl group; R² represents a single bond or an alkylene group; and n represents an integer expressing a polymerization degree, and the polymerization degree n is k (k represents an integer of 3 or more) or more.

In the formula (1), examples of a fluorine atom-containing telomere type acrylate include partially or completely fluorinated alkyl ester derivatives of (meth)acrylic acid.

Specific examples of the compound represented by the formula (F-1) will be given below, but it should not be construed that the invention is limited thereto.

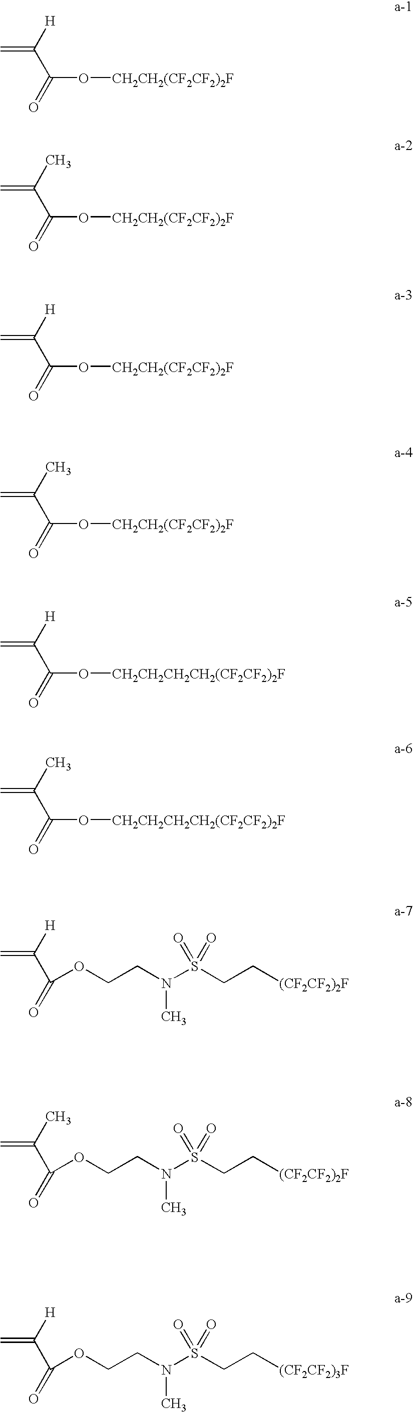

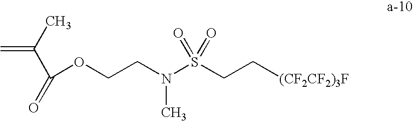

With respect to the compound represented by the foregoing formula (F-1), when telomerization is employed in the synthesis, n of the group Rf(CF₂CF₂)ₙR²CH₂CH₂O— may include plural fluorine-containing (meth)acrylic esters of k, (k+1), (k+2), etc.

As a second preferred embodiment, there can be enumerated a compound represented by the following formula (F-2).

F(CF₂)ₙO(CF₂CF₂O)ₘCF₂CH₂OCOCR═CH₂ Formula (F-2)

In the formula (F-2), R represents a hydrogen atom or a methyl group; m represents an integer of from 1 to 6, and n represents an integer of from 1 to 4.

The fluorine atom-containing monofunctional (meth)acrylate represented by the foregoing formula (F-2) can be obtained by reacting a fluorine-containing alcohol compound represented by the following formula (FG-2) with a (meth)acrylic acid halide.

F(CF₂)ₙO(CF₂CF₂O)ₘCF₂CH₂OH Formula (FG-2)

In the formula (FG-2), m represents an integer of from 1 to 6; and n represents an integer of from 1 to 4.

Specific examples of the fluorine atom-containing alcohol compound represented by the foregoing formula (FG-2) include 1H,1H-perfluoro-3,6-dioxahep-tan-1-ol, 1H,1H-perfluoro-3,6-dioxaoctan-1-ol, 1H,1H-perfluoro-3,6-dioxadecan-1-ol, 1H,1H-perfluoro-3,6,9-trioxadecan-1-ol, 1H,1H-perfluoro-3,6,9-trioxaundecan-1-ol, 1H,1H-perfluoro-3,6,9-trioxamidecan-1-ol, 1H,1H-perfluoro-3,6,9,12-tetraoxamidecan-1ol, 1H, 1H-perfluoro-3,6,9,12-tetraoxatetradecan-1-ol, 1H,1H-perfluoro-3,6,9,12-tetraoxahexadecan-1-ol, 1H,1H-perfluoro-3,6,9,12,15-pentaoxahexadecan-1-ol, 1H,1H-perfluoro-3,6,9,12,15-pentaoxaheptadecan-1-ol, 1H,1H-perfluoro-3,6,9,12,15-pentaoxanonadecan-1-ol, 1H, 1H-perfluoro-3,6,9,12,15,18-hexaoxaeicosan-1-ol, 1H,H-perfluoro-3,6,9,12,15,18-hexaoxadocosan-1-ol, 1H, 1H-perfluoro-3,6,9,12,15,18,21-heptaoxatricosan-1-ol, and 1H,1H-per-fluoro-3,6,9,12,15,18,21-heptaoxapentacosan-1-ol. These compounds are commercially available; and specific examples thereof include 1H,1H-perfluoro-3,6-dioxaheptan-1-ol (a trade name: C5GOL, manufactured by Exfluor Research Corporation), 1H,1H-perfluoro-3,6,9-trioxadecan-1-ol (a trade name: C7GOL, manufactured by Exfluor Research Corporation), 1H,1H-per-fluoro-3,6-dioxadecan-1-ol (a trade name: C8GOL, manufactured by Exfluor Research Corporation), 1H, 1H-perfluoro-3,6,9-trioxamidecan-1-ol (a trade name: C10GOL, manufactured by Exfluor Research Corporation), and 1H,1H-perfluoro-3,6,9,12-tetraoxahexadecan-1-ol (a trade name: C12GOL, manufactured by Exfluor Research Corporation). In the invention, it is preferred to use 1H,1H-perfluoro-3,6,9-trioxamidecan-1-ol.

Furthermore, examples of the (meth)acrylic acid halide which is reacted with the fluorine atom-containing alcohol compound represented by the foregoing formula (FG-2) include (met)acrylic acid fluoride, (met)acrylic acid chloride, (met)acrylic acid bromide, and (met)acrylic acid iodide. In general, (met)acrylic acid chloride is preferable from the viewpoint of easiness of availability.

Specific examples of the compound represented by the formula (F-2) will be given below, but it should not be construed that the invention is limited thereto.

F₉C₄OC₂F₄OC₂F₄OCF₂CHOCOCH═CH₂ (b-1)

F₉C₄OC₂F₄OC₂F₄OCF₂CHOCOC(CH₃)═CH₂ (b-2)

As a third preferred embodiment, there can be enumerated a compound represented by the following formula (F-3).

(Rf)—[(W)—(R_{A})ₙ]ₘ Formula (F-3)

In the formula (F-3), Rf represents a (per)fluoropolyether group; W represents a connecting group; R_{A} represents a (meth)acryl group; n represents an integer of from 1 to 3; and m represents an integer of from 1 to 3, provided that n and m do not represent 1 at the same time.

In the compound represented by the formula (F-3), W represents a connecting group, for example, an alkylene, an arylene, a heteroalkylene, or a combination thereof. Such a connecting group may further contain a functional group, for example, carbonyl, carbonyloxy, carbonylimino, sulfonamide or a combination thereof.

As a preferred structure of Rf, there can be enumerated the following structure.

F(CF(CF₃)CF₂O)ₚCF(CF₃)—

Here, an average value of p is from 4 to 15.

A number average molecular weight of the compound represented by the formula (F-3) is preferably from 400 to 5,000, more preferably from 800 to 4,000, and most preferably from 1,000 to 3,000.

Preferred specific examples and synthesis methods of the compound represented by the formula (F-3) are described in WO 2005/008570.

Specific examples of the compound represented by the formula (F-3) will be given below, while referring to the structure “F(CF(CF₃)CF₂O)ₚCF(CF₃)—” in which an average value of p is from 6 to 7 as “HFPO—”. However, it should not be construed that the invention is limited thereto.

HFPO—CONH—C—(CH₂OCOCH═CH₂)₂CH₂CH₃ (C-1)

HFPO—CONH—C—(CH₂OCOCH═CH₂)₂H (C-2)

(C-3): Michael addition polymer of HFPO—CONH—C₃H₆NHCH₃ and trimethylolpropane triacrylate (1/1)

### [Fine Particle Having a Conductive Metal Oxide-Coated Layer] (Constitutional Component (B) of Low Refractive Index Layer of the Invention)

The fine particle which can be used as the constitutional component (B) of a low refractive index layer in the invention will be hereunder described. The low refractive index layer of the invention contains a fine particle having a conductive metal oxide-coated layer. In the invention, there are enumerated a core/shell type composite fine particle in which a fine particle is used as a nucleus and a shell layer made of a conductive substance is provided on the outside thereof; and an internal void type hollow fine particle as prepared in a manner that by using a fine particle which is soluble in acids, alkalis or organic solvents as a nucleus, a shell layer made of a conductive substance is provided on the outside thereof to form a composite fine particle, followed by removing the nucleus particle by a treatment with an acid, an alkali or an organic solvent to form voids in the inside thereof.

In the fine particles of all of these forms, the conductive metal oxide is not particularly limited. Examples thereof include tin oxide (SnO₂), antimony tin oxide (ATO), indium tin oxide (ITO), antimony oxide (Sb₂O₅), aluminum zinc oxide (AZO), gallium zinc oxide, and mixtures thereof.

Examples of a core particle of the core/shell type composite particle include inorganic fine particles such as a silica fine particle (for example, a colloidal silica fine particle and a silicon oxide fine particle); polymer fine particles such as a fluorine resin fine particle, an acrylic resin particle, and a silicone resin particle; and fine particles such as an organic/inorganic composition particle. So far as the foregoing fine particle is a porous or hollow fine particle, it is able to lower the refractive index.

A nucleus particle which is used in the internal void type hollow fine particle is not limited with respect to the kind thereof so far as it can be dissolved or washed away through the shell layer by a treatment with an acid, an alkali or an organic solvent. Fine particles of a metal oxide of a metal selected from elements belonging to the groups 2A, 2B, 3A, 3B, 4A, 4B, 5B and 6A of the periodic table are preferable, and examples thereof include Al₂O₃, B₂O₃, TiO₂, SnO₂, Ce₂O₃, P₂O₅, Sb₂O₃, MoO₃, ZnO₂, and WO₃. Above all, Al₂O₃, ZnO₂, Y₂O₃ and Sb₂O₅ fine particles are preferable. Furthermore, in the case of using for an internal void type hollow fine particle, as a combination of the nucleus particle and the shell substance, a combination of a fine particle of Al₂O₃, ZnO₂, Y₂O₃, Sb₂O₅, etc. with ATO, ITO, SnO₂, etc. is preferable.

As a manufacturing method of an internal void type hollow fine particle, a method in which a surface of a fine particle of Al₂O₃, ZnO, Y₂O₃, Sb₂O₅, etc. is coated by a superfine particle of ATO, ITO, SnO₂, etc. or a thin film thereof and the internal fine particle is then eluted by an acid or alkali aqueous solution, thereby forming a hollow conductive inorganic fine particle can be employed.

The coating amount of the fine particle (B) having a conductive metal oxide-coated layer which is used in the invention is preferably from 1 to 100 mg/m², more preferably from 5 to 80 mg/m², and further preferably from 10 to 60 mg/m². When the coating amount of the fine particle is the lower limit value or more, the scar resistance is remarkably improved; and when it is not more than the upper limit value, fine irregularities are formed on the surface of the low refractive index layer so that inconveniences such as deterioration in appearance including firmness of black color and integrated reflectance are not caused, and therefore, such is preferable. Since the fine particle is contained in the low refractive index layer, it desirably has a low refractive index.

In the invention, from the viewpoint of manufacturing stability of the fine particle, a composite oxide fine particle containing a silica particle as a nucleus and having a conductive inorganic metal oxide-coated layer on the outside thereof is preferable. The fine particle is especially preferably a composite oxide fine particle in which a conductive inorganic metal oxide thereof is antimony oxide. The silica based fine particle having an antimony oxide-coated layer will be hereunder described in detail.

### [Silica Based Fine Particle Having an Antimony Oxide-Coated Layer]

The “silica based fine particle having an antimony oxide-coated layer” (also referred to as “antimony oxide-coated silica based fine particle”) which is an especially preferred embodiment of the invention represents a silica based fine particle having an antimony oxide-coated layer, and preferably a porous silica based fine particle or a silica based fine particle having voids in the inside thereof. The foregoing “silica based fine particle” refers to a particle containing silica.

The foregoing porous silica based fine particle includes a porous silica based fine particle and a composite oxide fine particle containing silica as the major component. For example, as described in JP-A-7-133105, a low refractive index composite oxide fine particle with a nanometer size, in which a surface of a porous inorganic oxide fine particle is coated by silica, can be used.

Furthermore, as the silica based fine particle having voids in the inside thereof, for example, as described in JP-A-2001-233611, a low refractive index composite oxide fine particle with a nanometer size having voids in the inside thereof, which is made of silica and an inorganic oxide other than silica, can be used.

An average particle size of such a porous silica based fine particle or silica based fine particle having voids in the inside thereof is preferably in the range of from 4 to 270 nm, and more preferably from 8 to 170 nm.

A refractive index of the foregoing porous silica based fine particle or silica based fine particle having voids in the inside thereof is preferably not more than 1.45, and more preferably not more than 1.40 in terms of a refractive index of silica.

The foregoing silica based fine particle is coated by antimony oxide in an average thickness of the coated layer preferably in the range of from 0.5 to 30 nm, and more preferably from 1 to 10 mm. In view of the matters that the silica based fine particle can be thoroughly coated and that conductivity of the resulting antimony oxide-coated silica based fine particle is sufficient, the average thickness of the coated layer is preferably 0.5 nm or more. In view of the matters that an effect for improving the conductivity is sufficient and that even when the average particle size of the antimony oxide-coated silica based fine particle is small, the refractive index is sufficient, the average thickness of the coated layer is preferably not more than 30 nm.

With respect to the average thickness of the coated layer, an average particle size of the particle before and after coating was determined by electron microscopic observation, and a difference therebetween was calculated and defined as an average thickness of the coated layer. As the average particle size, an average value of 100 particles was employed.

The antimony oxide may be any of Sb₂O₃, Sb₂O₅ or SbO₂, and tin oxide may be contained in the antimony oxide-coated layer. The content of the total sum of these antimony oxides in the antimony oxide-coated layer is preferably 10% or more.

Furthermore, the antimony oxide-coated silica based fine particle may be further coated by silica or the like.

The antimony oxide-coated silica based fine particle according to the invention preferably has an average particle size in the range of from 5 to 300 nm, and more preferably from 10 to 200 nm. By making the average particle size of the antimony oxide-coated silica based fine particle fall within this range, not only both the conductivity and the refractive index can be made compatible with each other, but also a white tint of the coating film can be suppressed.

A refractive index of the antimony oxide-coated silica based fine particle is preferably in the range of from 1.35 to 1.60, and more preferably from 1.35 to 1.50.

A volume resistivity value of the antimony oxide-coated silica based fine particle is preferably in the range of from 10 to 5,000 Ω/cm, and more preferably from 10, 2,000 Ω/cm. If desired, the antimony oxide-coated silica based fine particle of the invention can be used after a surface treatment with a silane coupling agent in a usual method.

By making the volume resistivity value fall within the foregoing range, it becomes possible to lower a surface resistivity of the low refractive index coating film while keeping the refractive index of the particle low. The volume resistivity value can be controlled by adjusting the particle size of a nucleus particle and the thickness and composition of the surface coating metal oxide layer.

Furthermore, the volume resistivity value was measured in the following method.

### [Measurement of Volume Resistivity Value]

By suing a ceramic-made cell having a cylindrical bore (cross-sectional area: 0.5 cm²) in the inside thereof, the cell was first placed on a stand electrode; 0.6 g of a sample powder was filled in the inside; a protrusion of an upper electrode having a cylindrical protrusion was inserted; the upper and lower electrodes were pressurized by a hydraulic machine; a resistivity value (Ω) and a height (cm) of the sample at the time of pressurization of 100 kg/cm² were measured; and the height was multiplied by the resistivity value, thereby determining a volume resistivity value.

The coating amount of the antimony oxide-coated silica based fine particle in the low refractive index layer is preferably from 1 to 100 mg/m², more preferably from 5 to 80 mg/m², and further preferably from 10 to 60 mg/m².

Furthermore, it is preferable that the antimony oxide-coated silica based fine particle is used as a dispersion in an organic solvent, and the following organic solvents which are used for other fine particles can be suitably used.

### [Manufacturing Method of Antimony Oxide-Coated Silica Based Fine Particle]

A manufacturing method of the antimony oxide-coated silica based fine particle according to the invention is characterized by adding an antimony oxide dispersion (aqueous solution) in a dispersion of a porous silica based fine particle or silica based fine particle having voids in the inside thereof and coating antimonic acid on a surface of the silica based fine particle.

The foregoing porous silica based fine particle includes a porous silica fine particle and a composite oxide fine particle containing porous silica as the major component. The “porous fine particle” as referred to herein means a fine particle in which a surface area as measured by a titration method or a BET method or the like is larger than an external surface area of the fine particle as calculated from the average particle size of the fine particle. As such a porous silica based fine particle, as described in JP-A-7-133105, a low refractive index composite oxide fine particle with a nanometer size, in which a surface of a porous inorganic oxide fine particle is coated by silica, etc., can be used.

Furthermore, as the silica based fine particle having voids in the inside thereof, for example, as described in JP-A-2001-233611, a low refractive index composite oxide fine particle with a nanometer size having voids in the inside thereof, which is made of silica and an inorganic oxide other than silica, can be used. Incidentally, the voids can be confirmed by observing a transmission electron microscopic photograph (TEM) of a cross-section of the fine particle.

First of all, a dispersion of a porous silica based fine particle or silica based fine particle having voids in the inside thereof is prepared. A concentration of the dispersion is preferably in the range of from 0.1 to 40% by weight, and more preferably from 0.5 to 20% by weight in terms of solids. In the case where the solids concentration is less than 0.1% by weight, the production efficiency is low. On the other hand, when the solids concentration exceeds 40% by weight, the antimony oxide-coated silica based fine particle may cause agglomeration. For that reason, in applying such an antimony oxide-coated silica based fine particle to a coating film-provided substrate, there may be possibility that the dispersibility in the coating film is lowered; that the transparency of the coating film is lowered; or that the haze is deteriorated.

Separately, a dispersion (aqueous solution) of antimonic acid is prepared. A method of preparing antimonic acid is not particularly limited so far as an antimony oxide-coated layer can be formed on the fine particle surface without plugging pores or voids of the porous silica based fine particle or silica based fine particle having voids in the inside thereof. However, a method as exemplified below is preferable because a uniform and thin antimony oxide-coated layer can be formed.

Concretely, an antimonic acid alkali aqueous solution is treated with a cation exchange resin to prepare an antimonic acid (gel) dispersion, which is then treated with an anion exchange resin. The antimonic acid alkali aqueous solution is suitable an antimonic acid alkali aqueous solution which is used for a manufacturing method of an antimony oxide sol as described in, for example, JP-A-2-180717.

The antimonic acid alkali aqueous solution is preferably an antimonic acid alkali aqueous solution obtainable by reacting antimony trioxide (Sb₂O₃), an alkaline substance and hydrogen peroxide. This antimonic acid alkali aqueous solution is obtained by adding hydrogen peroxide at a rate of not more than 0.2 moles/hr per mole of antimony trioxide in a system containing antimony trioxide and an alkaline substance in a molar ratio of the antimony to the alkaline substance to the hydrogen peroxide of 1/(2.0 to 2.5)/(0.8 to 1.5), and preferably 1/(2.1 to 2.3)/(0.9 to 1.2).

The antimony trioxide which is used herein is preferably a powder, and especially preferably a fine particle having an average particle size of not more than 10 μm. Examples of the alkaline substance include LiOH, KOH, NaOH, Mg(OH)₂, and Ca(OH)₂. Of these, alkali metal oxide hydroxides such as KOH and NaOH are preferable. Such an alkaline substance has an effect for stabilizing the resulting antimonic acid solution.

First of all, prescribed amounts of the alkaline substance and antimony trioxide are added in water to prepare an antimony trioxide suspension. A concentration of antimony trioxide in this antimony trioxide suspension is desirably in the range of from 3 to 15% by weight in terms of Sb₂O₃. Next, this suspension is heated to 50° C. or higher, and preferably 80° C. or higher, to which is then added aqueous hydrogen peroxide having a concentration of from 5 to 35% by weight at a rate of not more than 0.2 moles/hr per mole of antimony trioxide in terms of hydrogen peroxide. In the case where the addition rate of hydrogen peroxide is faster than 0.2 moles/hr, the particle size of the resulting antimony oxide fine particle becomes large so that the particle size distribution becomes broad, and therefore, such is not preferable.

On the other hand, in the case where the addition rate of hydrogen peroxide is very slow, the volume of manufacture does not increase. Accordingly, the addition rate of hydrogen peroxide is preferably in the range of from 0.04 moles/hr to 0.2 moles/hr, and especially preferably in the range of from 0.1 moles/hr to 0.15 moles/hr. Furthermore, when the molar ratio of hydrogen peroxide to antimony trioxide is low, the particle size of the resulting antimony oxide fine particle tends to become small. However, in the case where the molar ratio of hydrogen peroxide to antimony trioxide is lower than 0.8, the amount of undissolved antimony trioxide increases, and therefore, such is not desired. On the other hand, in the case where the molar ratio of hydrogen peroxide to antimony trioxide is higher than 1.5, the particle size of the resulting antimony oxide fine particle becomes large, and therefore, such is not preferable.

After separating the undissolved residue as the need arises, the antimonic acid alkali aqueous solution (MHSbO₃ wherein M represents an alkali metal) as obtained by the foregoing reaction is further diluted, if desired and then treated with a cation exchange resin to remove the alkali ion. There is thus prepared an antimonic acid gel ((HSbO₃—)ₙ) dispersion.

Furthermore, the antimonic acid alkali aqueous solution may contain a doping agent-containing aqueous solution such as a stannic acid alkali aqueous solution and a sodium phosphate aqueous solution. When such a doping agent is contained, an antimony oxide-coated silica based fine particle having higher conductivity is obtained.

Here, the antimonic acid can be presented by (HSbO₃—)ₙ (a polymer of n=2 or more) and is made of a polymer of antimonic acid (HSbO₃—) having a particle size of from about 1 to 5 nm, and its fine particle is agglomerated to exhibit a gel state.

In the treatment with a cation exchange resin, a concentration of the antimonic acid alkali aqueous solution is preferably in the range of from 0.01 to 5% by weight, and more preferably from 0.1 to 3% by weight in terms of solids (Sb₂O₅). When the concentration of the antimonic acid alkali aqueous solution is less than 0.01% by weight in terms of solids, the production efficiency is low. On the other hand, when it exceeds 5% by weight, a large agglomerate of antimonic acid may possibly be formed so that a coating of the silica based fine particle with antimonic acid is hardly formed. Even when the coating is formed, it may possibly become non-uniform.

The use amount of the cation exchange resin is controlled such that a pH of the resulting antimonic acid dispersion is preferably in the range of from 1 to 4, and more preferably from 1.5 to 3.5. When the pH of the antimonic acid dispersion is less than 1, a chain particle is not formed but an agglomerated particle is liable to be formed, whereas when it exceeds 4, a monodispersed particle is liable to be formed.

Furthermore, in the case where the pH of the antimonic acid dispersion is less than 1, the solubility of antimonic acid is so high that a prescribed amount of a coating of antimony oxide is hardly formed. On the other hand, in the case where the pH of the antimonic acid dispersion exceeds 4, the resulting antimony oxide-coated silica based fine particle may possibly become an agglomerate; the dispersibility in the coating film may possibility be lowered; and an antistatic effect of the coating film-provided substrate may possibility become insufficient,

Next, the antimonic acid dispersion and the dispersion of a porous silica based fine particle or silica based fine particle having voids in the inside thereof are mixed and ripened at from 50 to 250° C., and preferably from 70 to 120° C. usually for from 1 to 24 hours, thereby obtaining a dispersion of an antimony oxide-coated silica based fine particle.

With respect to the mixing proportion of the antimonic acid dispersion and the dispersion of a silica based fine particle, the antimonic acid is added in an amount of from 1 to 200 parts by weight, and preferably from 5 to 100 parts by weight in terms of Sb₂O₅ based on 100 parts of the silica based fine particle in terms of solids. In the case where the mixing proportion of antimonic acid is less than 1 part by weight, the coating film may possibly become non-uniform; the thickness of the coated layer may possibly become insufficient; and an effect for coating with antimony oxide, namely an effect for imparting or improving the conductivity may not possibly be sufficiently obtained. Even when the mixing proportion of antimonic acid exceeds 200 parts by weight, the amount of antimony oxides which does not contribute to coating may possibly increase; the conductivity of the resulting antimony oxide-coated silica based fine particle may not possibly further increase; and the refractive index may possibly become high exceeding 1.60.

A concentration of the mixed dispersion is preferably in the range of from 1 to 40% by weight, and more preferably from 2 to 30% by weight in terms of solids. In the case where the concentration of the mixed dispersion is less than 1% by weight, the coating efficiency of antimony oxide may possibly become insufficient, and the production efficiency may possibly be lowered. On the other hand, when it exceeds 40% by weight, in the case where the use amount of antimonic acid is large, the resulting antimony oxide-coated silica based fine particle may possibly be agglomerated.

In the case where the ripening temperature is lower than 50° C., a sufficient effect for improving the conductivity may not possibly be obtained due to a potential reason that the antimony oxide-coated layer does not become minute. When the ripening temperature exceeds 200° C., in the case where the porous silica based fine particle is used, the porosity is decreased so that the refractive index of the resulting antimony oxide-coated silica based fine particle may not possibly be lowered sufficiently.

Incidentally, with respect to mixing of the antimonic acid dispersion and the dispersion of a silica based fine particle, though as described previously, the both can be added at once, an antimonic acid gel dispersion can also be continuously or inter-mittently added and mixed in a dispersion of a porous silica based fine particle or silica based fine particle having voids in the inside thereof while spending a long period of time.

The thus obtained dispersion of an antimony oxide-coated silica based fine particle has a pH in the range of from approximately 1 to 4.

Furthermore, at this time, it is preferable that the antimony oxide-coated silica based fine particle has a refractive index in the range of from 1.35 to 1.60, a volume resistivity value in the range of from 10 to 5,000 Ω/cm, an average particle size in the range of from 5 to 300 nm, and a thickness of the antimony oxide-coated layer in the range of from 0.5 to 30 nm.

It is preferable that the dispersion of a silica based fine particle having voids in the inside thereof which is used in the invention is obtained by the following step (a) or (b).

(a) A step in which in simultaneously adding a silicate aqueous solution and/or an acidic silicic acid solution and an aqueous solution of an alkali-soluble inorganic compound in an alkaline aqueous solution or if desired, an alkaline aqueous solution having a seed particle dispersed therein, thereby preparing a composite oxide fine particle dispersion having a molar ratio of MOₓ/SiO₂ (wherein silica is expressed by SiO₂; and the inorganic compound other than silica is expressed by MOₓ) in the range of from 0.3 to 1.0, at a point of time when an average particle size of the composite oxide fine particle becomes from approximately 5 to 50 nm, an electrolyte salt is added such that a ratio of a molar number (M_{E}) of the electrolyte salt to a molar number (M_{S}) of SiO₂ [(M_{E})/(M_{S})] is in the range of from 0.1 to 10, thereby preparing a composite oxide fine particle dispersion.

(b) A step in which if desired, an electrolyte salt is further added in the foregoing composite oxide fine particle dispersion, and an acid is then added to remove at least a part of elements other than silicon constituting the composite oxide fine particle, thereby preparing a dispersion of a silica based fine particle.

### Step (a)

As the silicate, one or two or more silicates selected from an alkali metal silicate, ammonium silicate and a silicate of an organic base are preferably used. Examples of the alkali metal silicate include sodium silicate (water glass) and potassium silicate; and examples of the organic base include quaternary ammonium salts (for example, tetraethylammonium slats) and amines (for example, monoethanolamine, diethanolamine, and triethanolamine). The ammonium silicate or the silicate of an organic base includes an alkaline solution resulting from adding ammonia, a quaternary ammonium hydroxide, an amine compound, etc. in a silicic acid solution.

As the acidic silicic acid solution, a silicic acid solution obtained by, for example, treating a silicic acid alkali aqueous solution with a cation exchange resin to remove the alkali can be obtained. An acidic silicic acid solution having a pH of from 2 to 4 and an SiO₂ concentration of not more than about 7% by weight is especially preferable.

As the inorganic oxide, one or two or more kinds of Al₂O₃, B₂O₃, TiO₂, ZrO₂, SnO₂, Ce₂O₃, P₂O₅, Sb₂O₃, MoO₃, ZnO₂, and WO₃ can be enumerated. As two or more kinds of inorganic oxides, TiO₂—Al₂O₃ and TiO₂—ZrO₂ can be enumerated.

As a raw material of such an inorganic oxide, it is preferred to use an alkali-soluble inorganic compound. Examples thereof include alkali metal salts or alkaline earth metal salts, ammonium salts, and quaternary ammonium salts of an oxoacid of a metal or non-metal constituting the foregoing inorganic oxide. More specifically, suitable examples thereof include sodium aluminate, sodium tetraborate, zirconylammonium carbonate, potassium antimonate, potassium stannate, sodium aluminosilicate, sodium molybdenate, ammonium cerium nitrate, and sodium phosphate.

In order to prepare the composite oxide fine particle dispersion, an alkaline aqueous solution of the foregoing inorganic compound is separately prepared or the mixed aqueous solution is prepared in advance, and this aqueous solution is gradually added in an alkaline aqueous solution, and preferably an alkaline aqueous solution having a pH of 10 or more with stirring depending upon a desired composite proportion of silica to the inorganic oxide other than silica.

With respect to the addition proportion of the silica raw material and the inorganic compound to be added in the alkaline aqueous solution, a molar ratio of MOₓ/SiO₂ (wherein the silica component is expressed by SiO₂; and the inorganic compound other than silica is expressed by MOₓ) is preferably in the range of from 0.3 to 1.0, and especially preferably in the range of from 0.35 to 0.85. When the MOₓ/SiO₂ is less than 0.3, a void volume of the ultimately obtained silica based fine particle does not become sufficiently large; and on the other hand, when the MOₓ/SiO₂ exceeds 1.0, it may possibly become difficult to obtain a spherical composite oxide fine particle, and as a result, the proportion of the void volume in the resulting hollow fine particle is lowered.

When the molar ratio of MOₓ/SiO₂ falls within the range of from 0.3 to 1.0, the structure of the composite oxide fine particle is mainly a structure in which silicon and the elements other than silicon are alternately bound to each other via oxygen. That is, a large amount of a structure in which an oxygen atom is bound to four bonds of the silicon atom and the element M other than silicon is bound to this oxygen atom is formed, and in removing the element M other than silicon in a step (b) as described later, the silicon atom can also be removed as a silicic acid monomer or oligomer associated with the element M.

In the manufacturing method of the invention, a dispersion of a seed particle can be used as a starting material in preparing a composite oxide fine particle dispersion. In this case, a fine particle such inorganic oxides (for example, SiO₂, Al₂O₃, TiO₂, ZrO₂, SnO₂, and CeO₂) and composite oxides thereof (for example, SiO₂—Al₂O₃, TiO₂—Al₂O₃, TiO₂—ZrO₂, SiO₂—TiO₂, and SiO₂—TiO₂—Al₂O₃) is used as the seed particle, and a sol of such a fine particle can be usually used. The dispersion of such a seed particle can be prepared by a conventionally known method. For example, the dispersion of such a seed particle can be obtained by hydrolysis by adding an acid or an alkali to a metal oxide, a mixture of metal salts or a metal alkoxide corresponding to the foregoing inorganic oxide and if desired, ripening.

An aqueous solution of the foregoing compound is added in an alkaline aqueous solution having such a seed particle dispersed therein, and preferably an alkaline aqueous solution having a seed particle dispersed therein whose pH is adjusted at 10 or more with stirring in the same manner as the foregoing method of adding an alkaline aqueous solution. In this way, by growing the composite oxide fine particle as a seed of the seed particle, it is easy to control the particle size of the grown particle so that a particle having a uniform particle size can be obtained. The addition amount of the silica raw material and the inorganic oxide to be added in the seed particle dispersion is the same range as in the case of adding the foregoing alkaline aqueous solution.

The foregoing silica raw material and inorganic oxide raw material have a high solubility in an alkaline side. However, when the both are mixed in this high pH region with high solubility, the solubility of each of a silicate ion and an oxoacid ion such as an aluminate ion is lowered, and a composite of these materials is deposited to grow into a colloid particle or deposited on the seed particle to cause the particle growth.

In preparing the foregoing composite oxide fine particle dispersion, an organosilicon compound represented by the following chemical formula (1) and/or a hydrolyzate thereof may be added as the silica raw material in the alkaline aqueous solution.

RₙSiX₍₄₋ₙ₎ (1)

In the chemical formula (1), R represents an unsubstituted or substituted hydrocarbon group having from 1 to 10 carbon atoms; X represents an alkoxy group having from 1 to 4 carbon atoms, a silanol group, a halogen or hydrogen; and n represents an integer of from 0 to 3.

Specific examples of the organosilicon compound include tetramethoxysilane, tetraethoxysilane, tetraisopropoxysilane, methyltrimethoxysilane, dimethyldimethoxysilane, phenyltrimethoxysilane, diphenyldimethoxysilane, methyl-triethoxysilane, dimethyldiethoxysilane, phenyltriethoxysilane, diphenyldiethoxysilane, isobutyltrimethoxysilane, vinyltrimethoxysilane, vinyltriethoxysilane, vinyltris-(β-methoxyethoxy)silane, 3,3,3-trifluoropropyltrimethoxysilane, methyl-3,3,3-trifluoropropyldimethoxysilane, β-(3,4-epoxycyclohexyl)ethyltrimethoxysilane, γ-glycidoxytripropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, N-β-(aminoethyl)-γ-aminopropylmethyldimethoxysilane, N-α-(aminoethyl)-γ-aminopropyltrimethoxysilane, N-β-(aminoethyl)-γ-aminopropyltriethoxysilane, γ-aminopropyltrimethoxysilane, γ-aminopropyltriethoxysilane, N-phenyl-γ-amino-propyltrimethoxysilane, γ-mercaptopropyltrimethoxysilane, trimethylsilanol, methyltrichlorosilane, methyldichlorosilane, dimethyldichlorosilane, trimethylchlorosilane, phenyltrichlorosilane, diphenyldichlorosilane, vinyl-trichlorosilane, trimethylbromosilane, and diethylsilane.

Among the foregoing organosilicon compounds, since compounds wherein n is from 1 to 3 are poor in hydrophilicity, it is preferable that such a compound is hydrolyzed in advance such that it can be uniformly mixed in the reaction system. For the hydrolysis, a method which is well known as the hydrolysis method of such organosilicon compounds can be employed. In the case where a basic material such as alkali metal hydroxides, ammonia water, and amines is used as a hydrolysis catalyst, after the hydrolysis, such a basic catalyst is removed, thereby converting the solution into an acidic solution, which is then provided for use. In the case where a hydrolyzate is prepared by using an acidic catalyst such as organic acids and inorganic acids, after the hydrolysis, it is preferred to remove the acidic catalyst by ion exchange or the like. Incidentally, it is preferable that the resulting hydrolyzate of an organosilicon compound is used in a form of an aqueous solution. The “aqueous solution” as referred to herein means that the hydrolyzate is in a transparent state but not in a cloudy state as a gel.

In the invention, in this step (a), at a point of time when the average particle size of the composite oxide fine particle becomes from approximately 5 to 50 nm (the composite oxide fine particle at this time will be sometimes referred to as “primary particle”), an electrolyte salt is added such that a ratio of a molar number (M_{E}) of the electrolyte salt to a molar number (M_{S}) of SiO₂[(M_{E})/(M_{S})] is in the range of from 0.1 to 10, and preferably from 0.2 to 8.

Examples of the electrolyte salt include water-soluble electrolyte salts, for example, sodium chloride, potassium chloride, sodium nitrate, potassium nitrate, sodium sulfate, potassium sulfate, ammonium nitrate, ammonium sulfate, magnesium chloride, and magnesium nitrate.

Incidentally, the whole of the electrolyte salt may be added at this point of time, or the electrolyte salt may be continuously or intermittently added while adding an alkali metal silicate or an organic compound other than silica to achieve the particle growth of a composite oxide fine particle.

The addition amount of the electrolyte salt varies depending upon the concentration of the composite oxide fine particle dispersion. In the case where the foregoing molar ratio (M_{E})/(M_{S}) is less than 0.1, an effect as brought by the addition of the electrolyte salt becomes insufficient; and in the step (b), when an acid is added to remove at least a part of an element other than silicon constituting the composite oxide fine particle, the composite oxide fine particle cannot keep a spherical shape and is broken so that it may possibly become difficult to obtain a silica based fine particle having voids in the inside thereof. A reason of the effect as brought by the addition of such an electrolyte salt is not always elucidated yet. However, it is thought that the amount of silica on the surface of the grown composite oxide fine particle becomes high so that the silica which is insoluble in an acid does not act as a protective film of the composite oxide fine particle.

Even when the foregoing molar ratio (M_{E})/(M_{S})exceeds 10, the effect as brought by the addition of the foregoing electrolyte salt does not improve any more. Rather, a new fine particle is formed, or the economy is lowered.

Furthermore, in adding an electrolyte salt, in the case where the average particle size of the primary particle is less than 5 nm, a new fine particle is formed so that the selective particle growth of the primary particle does not occur and that the particle size distribution of the composite oxide fine particle may possibly become non-uniform.

In adding an electrolyte salt, in the case where the average particle size of the primary particle exceeds 50 nm, it may possibly take a long period of time for the removal of elements other than silicon in the step (b), or the removal of elements other than silicon may possibly become difficult.

The thus obtained composite oxide fine particle has an average particle size in the range of from 4 to 270 nm, the value of which is the same as in the silica based fine particle as obtained later.

### Step (b)

Next, by removing a part or the whole of elements other than silicon constituting the composite oxide fine particle from the composite oxide fine particle, a hollow spherical silica based fine particle having voids in the inside thereof can be manufactured.

In this step, if desired, an electrolyte salt is again added in the composite oxide fine particle dispersion. At this time, with respect to the addition amount of the electrolyte salt, the electrolyte salt is added such that a ratio of a molar number (M_{E}) of the electrolyte salt to a molar number (M_{S}) of SiO₂[(M_{E})/(M_{S})] is in the range of from 0.1 to 10, and preferably from 0.2 to 8.

Next, a part or the whole of elements constituting the composite oxide fine particle is removed. Examples of the removal method include a method of adding a mineral acid or an organic acid, thereby achieving dissolution and removal; a method of bringing into contact with a cation exchange resin, thereby achieving removal by ion exchange; and a method of a combination of these methods, thereby achieving removal.

At this time, though the concentration of the composite oxide fine particle in the composite oxide fine particle dispersion varies depending upon the treatment temperature, it is preferably in the range of from 0.1 to 50% by weight, and especially preferably from 0.5 to 25% by weight as reduced into an oxide. When the concentration is less than 0.1% by weight, the dissolution amount of silica becomes high so that the shape of the composite oxide fine particle may possibly be unable to be kept. Even when the shape of the composite oxide fine particle could be kept, the treatment efficiency is lowered due to the low concentration. On the other hand, when the concentration exceeds 50% by weight, the dispersibility of the particle becomes insufficient so that in a composite oxide fine particle having a high content of elements other than silicon, it may possibly be unable to be removed uniformly or efficiently in a small number.

The foregoing removal of elements is preferably carried out until the MOₓ/SiO₂ of the resulting silica based fine particle is from 0.0001 to 0.2, and especially from 0.0001 to 0.1.

The dispersion from which the elements have been removed can be washed by a known washing method such as ultrafiltration. In this case, by carrying out the ultrafiltration after previously removing a part of an alkali metal ion, an alkaline earth metal ion, an ammonium ion and so on in the dispersion, a sol in which a silica based fine particle with high dispersion stability is dispersed is obtained. Incidentally, by substitution with an organic solvent, if desired, a sol dispersed in an organic solvent can be obtained.

In the manufacturing method of a silica based fine particle of the invention, after washing, drying is carried out, and baking is further carried out, if desired. The thus obtained silica based fine particle has voids in the inside thereof and has a low refractive index. A coating film as formed by using this silica based fine particle has a low refractive index, and a coating film having excellent antireflection performance is obtained.

In the manufacturing method of a silica based fine particle of the invention, an alkaline aqueous solution and an organosilicon compound represented by the following chemical formula (1) and/or a partial hydrolyzate thereof, or an acidic silicic acid solution obtainable by dealkalination of an alkali metal silicate is added to the silica based fine particle dispersion as obtained in the foregoing step (b), whereby a silica-coated layer can be formed on the fine particle.

RₙSiX₍₄₋ₙ₎ (1)

In the chemical formula (1), R represents an unsubstituted or substituted hydrocarbon group having from 1 to 10 carbon atoms; X represents an alkoxy group having from 1 to 4 carbon atoms, a silanol group, a halogen or hydrogen; and n represents an integer of from 0 to 3.

As the organosilicon compound represented by the chemical formula (1), the same organosilicon compound as described previously can be used. In the chemical formula (1), in the case of using an organosilicon compound of n=0, this compound can be used as it is, whereas in the case of using an organosilicon compound of n=1 to 3, it is preferred to use a partial hydrolyzate of an organosilicon compound the same as that as described previously.

Since such a silica-coated layer is minute, the inside thereof is kept as a gaseous phase or a liquid layer having a low refractive index. In the case of using it for the formation of a coating film or the like, it is possible to form a coating film having a high effect of low refractive index without penetration of a substance with a high refractive index, for example, a resin for painting into the inside thereof.

Furthermore, in the foregoing, in the case where an organosilicon compound of n=1 to 3 is used for the formation of a silica-coated layer, it is possible to obtain a silica based fine particle dispersion having good dispersibility in an organic solvent and high compatibility with a resin. In addition, though the silica based fine particle dispersion can be used after surface treatment, since it is excellent in dispersibility in an organic solvent, compatibility with a resin, etc., such a treatment is not specially required.

Furthermore, in the case of using a fluorine-containing organosilicon compound for forming a silica-coated layer, since an F atom-containing coated layer is formed, not only the resulting particle has a lower refractive index, but also a silica based fine particle dispersion with good dispersibility in an organic solvent and high compatibility with a resin can be obtained. Examples of such a fluorine-containing organosilicon compound include 3,3,3-trifluoropropyltrimethoxysilane, methyl-3,3,3-trifluoropropyl-dimethoxysilane, heptadecafluorodecylmethyldimethoxysilane, heptadecafluorodecyltrichlorosilane, heptadecafluorodecyltrimethoxysilane, trifluoropropyltrimethoxysilane, and tridecafluorooctyltrimethoxysilane.

The foregoing silica based fine particle having a silica-coated layer formed thereon can be ripened at from the ordinary temperature to 300° C., and preferably from 50 to 250° C. usually for from approximately 1 to 24 hours as the need arises. When the ripening is carried out, the silica-coated layer becomes uniform and more minute, and a substance with high refractive index cannot penetrate into the inside of the particle as described previously. Thus, a coating film having a high effect of low refractive index can be formed.

The thus obtained silica based fine particle preferably has an average particle size in the range of from 4 to 270 nm, and more preferably from 8 to 170 nm. When the average particle size of the silica based fine particle is less than 4 nm, sufficient voids are not obtained so that an effect of low refractive index may not possibly be obtained. When the average particle size of the silica based fine particle exceeds 270 nm, an average particle size of the resulting antimony oxide-coated silica based fine particle may possibly exceed 300 nm. Thus, in a transparent coating film using such an antimony oxide-coated silica based fine particle, there may be some possibility that unevenness is generated on the surface thereof; that its transparency is lowered; and that the haze increases. Incidentally, the average particle size of the silica based fine particle and the antimony oxide-coated silica based fine particle according to the invention can be determined by a dynamic light scattering method.

The silica based fine particle has voids in the inside thereof. For that reason, in general, a refractive index of silica is 1.45, whereas a refractive index of the silica based fine particle was from 1.20 to 1.38. Incidentally, with respect to the void, it can be confirmed by observing a transmission electron microscopic photograph (TEM) of a cross-section of the particle.

A refractive index of the low refractive index layer which is used in the invention is preferably from 1.25 to 1.46, more preferably from 1.30 to 1.43, and most preferably from 1.30 to 1.40. A surface resistivity (Ω/) of the optical film of the invention is preferably 1.0×10⁵ or more and not more than 1.0×10¹³, more preferably 1.0×10⁷ or more and not more than 1.0×10¹², and most preferably 1.0×10⁸ or more and not more than 1.0×10¹⁰. According to the invention, by making each of the refractive index and the surface resistivity fall within the foregoing range, it is possible to keep satisfactory scar resistance while keeping low reflectance and satisfactory dustproof properties.

The antimony oxide-coated silica based fine particle can used singly or in combination with at least one kind of fine particles as described below.

### [Other Fine Particles]

In addition to the fine particle having a conductive metal oxide-coated layer which is the component (B) of the invention, the following fine particles can be suitably used. The fine particle is preferably an inorganic oxide particle; and from the viewpoint of colorless properties of the resulting low refractive index layer, the fine particle is preferably a particle of an oxide of at least one element selected from the group consisting of silicon, aluminum, zirconium, titanium, zinc, germanium, indium, tin, antimony and cerium.

Examples of such an inorganic fine particle include particles of an oxide, for example, silica, magnesium fluoride, alumina, zirconia, titanium oxide, zinc oxide, germanium oxide, indium oxide, tin oxide, antimony-doped tin oxide (ATO), tin-doped indium oxide (ITO), antimony oxide, and cerium oxide. Of these, particles of silica, alumina, zirconia, and antimony oxide are preferable from the viewpoint of high hardness. These particles may be used singly or in combination of two or more kinds thereof.

In addition, the inorganic fine particle is preferably used as an organic solvent dispersion. In the case of using as an organic solvent dispersion, the dispersion medium is preferably an organic solvent from the viewpoints of compatibility and dispersibility with other components.

Examples of such an organic solvent include alcohols (for example, methanol, ethanol, isopropanol, butanol, and octanol); ketones (for example, acetone, methyl ethyl ketone, methyl isobutyl ketone, and cyclohexanone); esters (for example, ethyl acetate, butyl acetate, ethyl lactate, γ-butyrolactone, propylene glycol monomethyl ether acetate, and propylene glycol monoethyl ether acetate); ethers (for example, ethylene glycol monomethyl ether and diethylene glycol monobutyl ether); aromatic hydrocarbons (for example, benzene, toluene, and xylene); and amides (for example, dimethylformamide, dimethylacetamide, and N-methylpyrrolidone). Of these, methanol, isopropanol, butanol, methyl ethyl ketone, methyl isobutyl ketone, ethyl acetate, butyl acetate, toluene, and xylene are preferable.

A number average particle size of the inorganic fine particle is preferably from 1 to 200 nm, more preferably from 3 to 150 nm, and especially preferably from 5 to 100 nm. When the number average particle size of the inorganic fine particle is not more than 200 nm, in the case where a hardened material is formed, inconveniences such as lowering of transparency and deterioration of the surface state in forming into a coating film are not caused, and therefore, such is preferable. Furthermore, for the purpose of improving the dispersibility of the particle, various surfactants and amines may be added.

As commodities which are commercially available as a silicon oxide particle dispersion (for example, a silica particle), examples of colloidal silica include silica sols as manufactured by Nissan Chemical Industries, Ltd., for example, “MA-ST-MS”, “IPA-ST”, “IPA-ST-MS”, “IPA-ST-L”, “IPA-ST-ZL”, “IPA-ST-UP”, “EG-ST”, “NPC-ST-30”, “MEK-ST”, “MEK-ST-L”, “MIBIK-ST”, “NBA-ST”, “XBA-ST”, “DMA-C-ST”, “ST-UP”, “ST-OUP”, “ST-20”, “ST-40”, “ST-C”, “ST-N”, “ST-O”, “ST-50”, and “ST-OL”; and hollow silica “CS60-IPA” as manufactured by Catalysts and Chemicals Industries Co., Ltd. Furthermore, examples of powdered silica include “AEROSIL 130”, “AEROSIL 300”, “AEROSIL 380”, “AEROSIL TT600”, and “AEROSIL OX50”, all of which are manufactured by Nippon Aerosil Co., Ltd.; “SILDEX H31”, “SILDEX H32”, “SILDEX H51”, “SILDEX H52”, “SILDEX H121”, and “SILDEX H122”, all of which are manufactured by Asahi Glass Co., Ltd.; “E220A”, “E220”, “SS-50”, “SS50A” and “SS-50F”, all of which are manufactured by Nippon Silica Industrial Co., Ltd.); SYLYSIA 470” as manufactured by Fuji Silysia Chemical Ltd.); and “SG FLAKE” as manufactured by Nippon Sheet Glass Co., Ltd.

Furthermore, examples of an aqueous dispersion of alumina include “ALUMINA SOL-100”, “ALUMINA SOL-200”, and “ALUMINA SOL-520”, all of which are manufactured by Nissan Chemical Industries, Ltd.; examples of a toluene dispersion of alumina include “AS-150T” as manufactured by Sumitomo Osaka Cement Co., Ltd.; examples of a toluene dispersion of zirconia include “HXU-110JC” as manufactured by Sumitomo Osaka Cement Co., Ltd.; examples of an aqueous dispersion of an antimony oxide zinc powder include “CELNAX” as manufactured by Nissan Chemical Industries, Ltd.; examples of powders and solvent dispersion of alumina, titanium oxide, tin oxide, indium oxide, zinc oxide, etc. include “NANOTEK” as manufactured by C.I. Kasei Co., Ltd.; examples of an aqueous dispersion sol of ATO include “SN-100D” as manufactured by Ishihara Sangyo Kaisha, Ltd.; examples of an ITO powder include products as manufactured by Mitsubishi Materials Corporation; and examples of a cerium oxide aqueous dispersion include “NEEDLAL” as manufactured by Taki Chemical Co., Ltd.

The shape of the inorganic fine particle is a spherical, hollow, porous, rod-like, plate-like, fibrous, chain-like, pearl necklace-like or amorphous shape, and preferably a spherical or hollow shape. The hollow silica particle will be described later. A specific surface area (measured by a BET specific surface area measurement method using nitrogen) of the inorganic fine particle is preferably from 10 to 1,000 m²/g, more preferably from 20 to 500 m²/g, and most preferably from 50 to 300 m²/g. In such an inorganic fine particle, though its powder in a dry state can be dispersed in an organic solvent, for example, a dispersion of an oxide particle in a fine particle state as known in the art as the foregoing solvent dispersion sol of an oxide can be used directly.

### (Hollow Silica Particle)

In the low refractive index layer of the antireflection film of the invention, it is especially preferred to use a hollow inorganic fine particle with low refractive index in addition to the fine particle of a conductive metal oxide-coated layer which is the component (B) of the invention. The hollow silica particle will be described later.

A refractive index of the hollow silica fine particle is preferably from 1.15 to 1.40, more preferably from 1.15 to 1.35, and most preferably from 1.17 to 1.30. The “refractive index” as referred to herein means a refractive index as the whole particle but does not mean a refractive index of only an outer shell which forms the hollow silica particle. At this time, when a radius of a pore within the particle is defined as r₁ and a radius of the particle outer shell is defined as r₀, a porosity x is expressed by the following numerical formula (2). The porosity x of the hollow silica particle is preferably from 10 to 60%, more preferably from 20 to 60%, and most preferably from 30 to 60%.

x=(r₁/r₀)³×100 Numerical Formula (2)

The average particle size of the hollow silica fine particle can be determined by an electron microscopic photograph.

When it is intended to make the hollow silica particle have a lower refractive index and a larger porosity, the thickness of the outer shell becomes thin so that the strength of the particle becomes weak. Accordingly, the refractive index of the hollow silica particle is usually 1.17 or more from the viewpoint of scar resistance.

A manufacturing method of the hollow silica particle is described in JP-A-2001-233611 and JP-A-2002-79616. As the hollow silica particle which is used in the invention, a particle having voids in the inside thereof, with pores of its outer shell being plugged, is especially preferable. Incidentally, the refractive index of such a hollow silica particle can be calculated by a method as described in JP-A-2002-79616.

With respect to the average particle size of the hollow silica, the thickness of the low refractive index layer is preferably 30% or more and not more than 150%, more preferably 35% or more and not more than 80%, and further preferably 40% or more and not more than 60%. That is, when the thickness of the low refractive index layer is 100 nm, the particle size of the hollow silica is preferably 30 nm or more and not more than 150 nm, more preferably 35 nm or more and not more than 100 nm, and further preferably 40 nm or more and not more than 65 nm. When the particle size of the silica fine particle is the foregoing lower limit value or more, a proportion of the pores is sufficient so that a lowering of the refractive index can be expected, and therefore, such is preferable. When the particle size of the silica fine particle is not more than the upper limit value, fine irregularities are formed on the surface of the low refractive index layer so that inconveniences such as deterioration in appearance including firmness of black color and integrated reflectance are not caused, and therefore, such is preferable. The silica fine particle may be either crystalline or amorphous and may be a monodispersed particle. Though the shape of the silica fine particle is most preferably a spherical shape, it may be an amorphous shape.

Furthermore, two or more kinds of hollow silica having a different average particle size can be used jointly. Here, the average particle size of the hollow silica can be determined from an electron microscopic photograph.

In the invention, a specific surface area of the hollow silica is preferably from 20 to 300 m²/g, more preferably from 30 to 120 m²/g, and most preferably from 40 to 90 m²/g. The surface area can be determined by a BET method using nitrogen, In the invention, it is possible to use a pore-free silica particle jointly with the hollowing silica. A particle size of the pore-free silica is preferably 30 nm or more and not more than 150 nm, more preferably 35 nm or more and not more than 100 nm, and most preferably 40 nm or more and not more than 80 nm.

(Silica Fine Particle with Small Particle Size)

Furthermore, it is possible to use at least one kind of a silica fine particle having an average particle size of less than 25% of the thickness of the low refractive index layer (hereinafter referred to as “silica fine particle with small particle size”) jointly with the silica fine particle having the foregoing particle size (hereinafter referred to as “silica fine particle with large particle size”).

Since the silica fine particle with small particle size can exist in gaps among the silica fine particles with large particle size, it can be contributed as a holding agent of the silica fine particle with large particle size.

An average particle size of the silica fine particle with small particle size is preferably 1 nm or more and not more than 20 nm, more preferably 5 nm or more and not more than 15 nm, and especially preferably 10 nm or more and not more than 15 nm. The use of such a silica fine particle is preferable in view of the raw material costs and holding agent effect.

### (Surface Treatment of Inorganic Fine Particle)

In order to design to achieve dispersion stability in the dispersion or coating solution or to enhance the compatibility and binding properties with the binder component, the inorganic fine particle which can be used in the low refractive index layer of the invention may be subjected to a physical surface treatment such as a plasma discharge treatment and a corona discharge treatment or a chemical surface treatment with a surfactant, a coupling agent, or the like.

Such a surface treatment may also be applied to the foregoing silica based fine particle having an antimony oxide-coated layer.

It is preferable that the inorganic fine particle is subjected to a surface treatment with a hydrolyzate of an organosilane represented by the following formula (3) and/or a partial condensate thereof and that in the treatment, either one or both of an acid catalyst and a metal chelate compound are used.

(R³⁰)ₘ₁Si(X³¹)₄₋ₘ₁ Formula (3)

In the formula (3), R³⁰ represents a substituted or unsubstituted alkyl group or a substituted or unsubstituted aryl group; X³¹ represents a hydroxyl group or a hydrolyzable group; and m1 represents an integer of from 1 to 3.

The foregoing dispersibility improving treatment of the inorganic fine particle is carried out by bringing an organosilane and an inorganic fine particle and optionally, water into contact with each other in the presence of at least one member of a catalyst having a hydrolyzing function and a metal chelate compound having a condensing function. The organosilane may be partially hydrolyzed or partially condensed. The organosilane causes hydrolysis and subsequently causes partial condensation, whereby the surface of the inorganic fine particle is modified and improved in its dispersibility. There is thus obtained a stable inorganic fine particle dispersion.

### (Metal Chelate Compound)

The metal chelate compound can be suitably used without particular limits so far as it is at least one kind of metal chelate compound containing an alcohol represented by the following formula (4-1) and a compound represented by the following formula (4-2) as ligands and containing a metal selected from Zr, Ti and Al as a central metal. Two or more kinds of metal chelate compounds may be used jointly within this scope.

R⁴¹OH Formula (4-1)

R⁴²COCH₂COR⁴³ Formula (4-2)

In the formulae (4-1) and (4-2), R⁴¹ and R⁴² may be the same or different and each represents an alkyl group having from 1 to 10 carbon atoms; and R⁴³ represents an alkyl group having from 1 to 10 carbon atoms or an alkoxy group having from 1 to 10 carbon atoms.

### [Organosilane Compound]

It is preferable that either one of a hydrolyzate of an organosilane represented by the following formula (3) which is manufactured in the presence of at least one member of an acid catalyst and a metal chelate compound, and a partial condensate thereof is used in any one of the low refractive index layer of the antireflection film of the invention and layers beneath of the low refractive index layer. Next, this organosilane compound will be hereunder described in detail.

(R³⁰)ₘ₁—Si(X³¹)₄₋ₘ₁ Formula (3)

In the formula (3), R³⁰ represents a substituted or unsubstituted alkyl group or a substituted or unsubstituted aryl group. Examples of the alkyl group include a methyl group, an ethyl group, a propyl group, an isopropyl group, a hexyl group, a t-butyl group, an s-butyl group, a hexyl group, a decyl group, and a hexadecyl group. The alkyl group is preferably an alkyl having from 1 to 30 carbon atoms, more preferably from 1 to 16 carbon atoms, and especially preferably from 1 to 6 carbon atoms. Examples of the aryl group include a phenyl group and a naphthyl group, with a phenyl group being preferable.

X³¹ represents a hydroxyl group or a hydrolyzable group. Examples of the hydrolyzable group include an alkoxy group (preferably an alkoxy group having from 1 to 5 carbon atoms, for example, a methoxy group and an ethoxy group), a halogen atom (for example, Cl, Br, and I), and an R³²CO group (wherein R³² is preferably a hydrogen atom or an alkyl group having from 1 to 5 carbon atoms, for example, a CH₃COO group and a C₂H₅COO group). Above all, an alkoxy group is preferable; and a methoxy group and an ethoxy group are especially preferable.

m1 represents an integer of from 1 to 3. When plural R³⁰s or X³¹s are present, the plural R³⁰s or X³¹s may be the same or different. m1 is preferably 1 or 2, and especially preferably 1.

A substituent which is contained in R³⁰ is not particularly limited. Examples thereof include a halogen atom (for example, a fluorine atom, a chlorine atom, and a bromine atom), a hydroxyl group, a mercapto group, a carboxyl group, an epoxy group, an alkyl group (for example, a methyl group, an ethyl group, an isopropyl group, a propyl group, and a t-butyl group), an aryl group (for example, a phenyl group and a naphthyl group), an aromatic heterocyclic group (for example, a furyl group, a pyrazolyl group, and a pyridyl group), an alkoxy group (for example, a methoxy group, an ethoxy group, an isopropoxy group, and a hexyloxy group), an aryloxy group (for example, a phenoxy group), an alkylthio group (for example, a methylthio group and an ethylthio group), an arylthio group (for example, a phenylthio group), an alkenyl group (for example, a vinyl group and a 1-propenyl group), an acyloxy group (for example, an acetoxy group, an acryloyloxy group, and a methacryloyloxy group), an alkoxycarbonyl group (for example, a methoxycarbonyl group and an ethoxycarbonyl group), an aryloxycarbonyl group (for example, a phenoxycarbonyl group), a carbamoyl group (for example, a carbamoyl group, an N-methylcarbamoyl group, an N,N-dimethylcarbamoyl group, and an N-methyl-N-octylcarbamoyl group), and an acylamino group (for example, an acetylamino group, a benzoylamino group, an acrylamino group, and a methacrylamino group). Such a substituent may be further substituted. Incidentally, in this specification, even when one for substituting the hydrogen atom is a single atom, it is dealt as the substituent for the sake of convenience.

In the case where plural R³⁰s are present, at least one of them is preferably a substituted alkyl group or a substituted aryl group. Above all, it is preferable that this substituted alkyl group or substituted aryl group further contains a vinyl polymerizable group. In this case, the compound represented by the formula (3) can be represented as an organosilane compound containing a vinyl polymerizable substituent represented by the following formula (3-1).

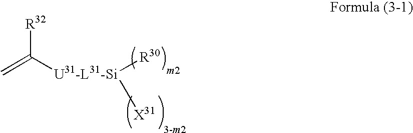

In the formula (3-1), R³² represents a hydrogen atom, a methyl group, a methoxy group, an alkoxycarbonyl group, a cyano group, a fluorine atom, or a chlorine atom. Examples of the alkoxycarbonyl group include a methoxycarbonyl group and an ethoxycarbonyl group. R³² is preferably a hydrogen atom, a methyl group, a methoxy group, a methoxycarbonyl group, a cyano group, a fluorine atom, or a chlorine atom; more preferably a hydrogen atom, a methyl group, a methoxycarbonyl group, a fluorine atom, or a chlorine atom; and especially preferably a hydrogen atom or a methyl group.

U³¹ represents a single bond, an ester group, an amide group, an ether group, or a urea group. U³¹ is preferably a single bond, an ester group, or an amide group; more preferably a sing bond or an ester group; and especially preferably an ester group.

L³¹ represents a divalent connecting chain. Specific examples of the divalent connecting chain include a substituted or unsubstituted alkylene group, a substituted or unsubstituted arylene group, a substituted or unsubstituted alkylene group containing a connecting group (for example, an ether group, an ester group, and an amide group) in the inside thereof, and a substituted or unsubstituted arylene group containing a connecting group in the inside thereof. Of these groups, a substituted or unsubstituted alkylene group having from 2 to 10 carbon atoms, a substituted or unsubstituted arylene group having from 6 to 20 carbon atoms, and an alkylene group containing a connecting group in the inside thereof and having from 3 to 10 carbon atoms are preferable; an un-substituted alkylene group, an unsubstituted arylene group, and an alkylene group containing an ether connecting group or an ester connecting group in the inside thereof are more preferable; and an unsubstituted alkylene group and an alkylene group containing an ether connecting group or an ester connecting group in the inside thereof are especially preferable. Examples of the substituent include a halogen, a hydroxyl group, a mercapto group, a carboxyl group, an epoxy group, an alkyl group, and an aryl group; and such a substituent may be further substituted.

m2 represents 0 or 1. When plural X³¹s are present, the plural X³¹s may be the same or different. m2 is preferably 0.

R³⁰ is synonymous with R³⁰ in the formula (3). R³⁰ is preferably a substituted or unsubstituted alkyl group or an unsubstituted aryl group; and more preferably an un-substituted alkyl group or an unsubstituted aryl group.

X³¹ is synonymous with X³¹ in the formula (3). X³¹ is preferably a halogen, a hydroxyl group, or an unsubstituted alkoxy group; more preferably chlorine, a hydroxyl group, or an unsubstituted alkoxy group having from 1 to 6 carbon atoms; further preferably a hydroxyl group or an alkoxy group having from 1 to 3 carbon atoms; and especially preferably a methoxy group.

As the organosilane compound which is used in the invention, a compound represented by the following formula (3-2) is preferable.

(R_{f}³¹-L³²)ₘ₃—Si(R³³)ₘ₃₋₄ Formula (3-2)

In the foregoing formula (3-2), R_{f}³¹ represents a linear, branched or cyclic fluorine-containing alkyl group having from 1 to 20 carbon atoms or a fluorine-containing aromatic group having from 6 to 14 carbon atoms. R_{f}³¹ is preferably a linear, branched or cyclic fluoroalkyl group having from 3 to 10 carbon atoms, and more preferably a linear fluoroalkyl group having from 4 to 8 carbon atoms. L³² represents a divalent connecting group having not more than 10 carbon atoms; preferably an alkylene group having from 1 to 10 carbon atoms; and more preferably an alkylene group having from 1 to 5 carbon atoms. The alkylene group is a linear or branched substituted or unsubstituted alkylene group optionally containing a connecting group (for example, an ether group, an ester group, and an amide group). The alkylene group may have a substituent. Preferred examples of the substituent include a halogen atom, a hydroxyl group, a mercapto group, a carboxyl group, an epoxy group, an alkyl group, and an aryl group. R³³ represents a hydroxyl group or a hydrolyzable group; preferably an alkoxy group having from 1 to 5 carbon atoms or a halogen atom; and more preferably a methoxy group, an ethoxy group, or a chlorine atom. m3 represents an integer of from 1 to 3.

Next, among the fluorine-containing organosilane compounds represented by the formula (3-2), a fluorine-containing organosilane compound represented by the following formula (3-3) is preferable.

CₙF₂ₙ₊₁—(CH₂)ₜ₆—Si(R³⁴)₃ Formula (3-3)

In the foregoing formula (3-3), n represents an integer of from 1 to 10; t6 represents an integer of from 1 to 5; and R³⁴ represents an alkoxy group having from 1 to 5 carbon atoms or a halogen atom. n is preferably from 4 to 10; t6 is preferably from 1 to 3; and R³⁴ is preferably a methoxy group, an ethoxy group or a chlorine atom.

Two or more kinds of the compound represented by the formula (3) may be used jointly. Specific examples of the compound represented by the formula (3) will be given below, but it should not be construed that the invention is limited thereto.

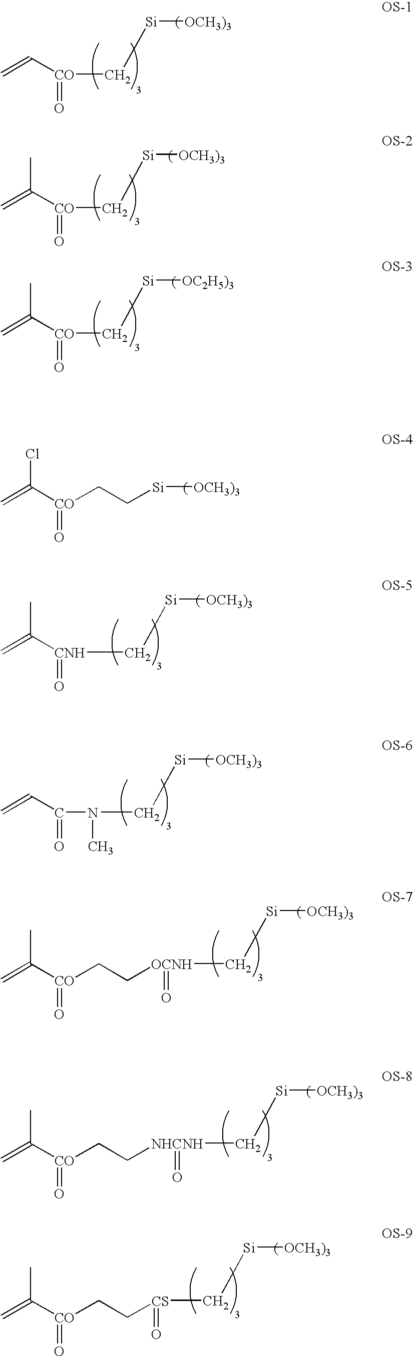

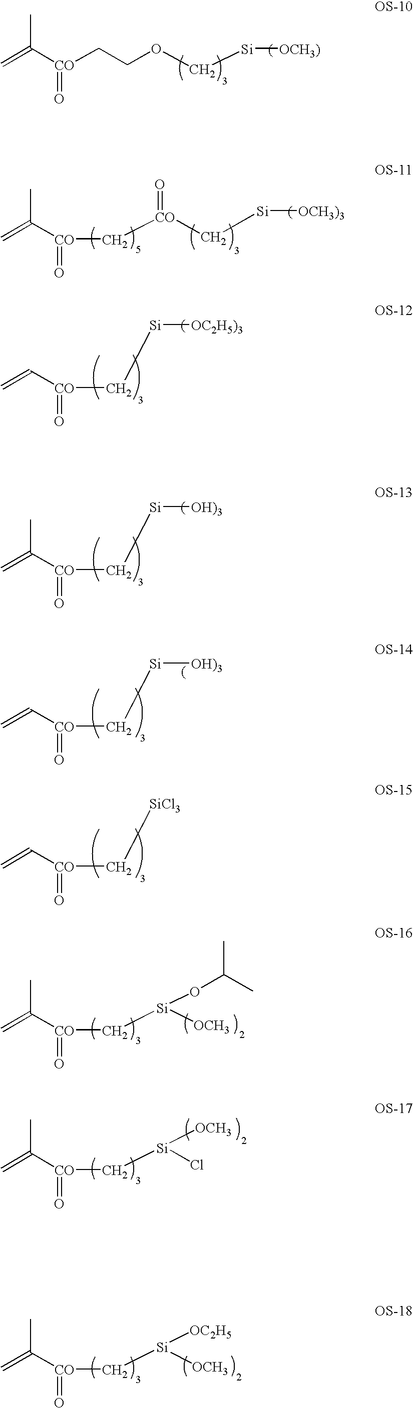

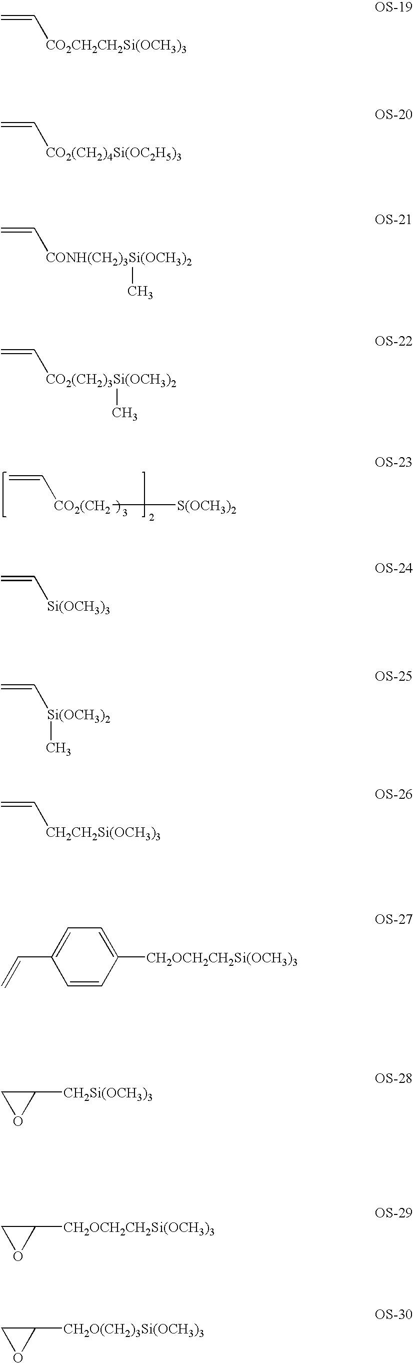

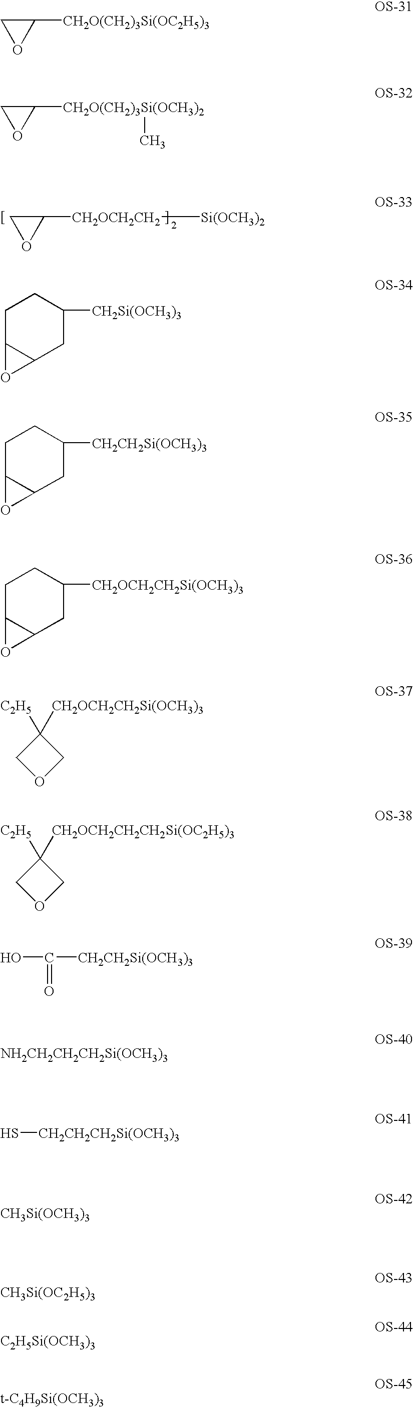

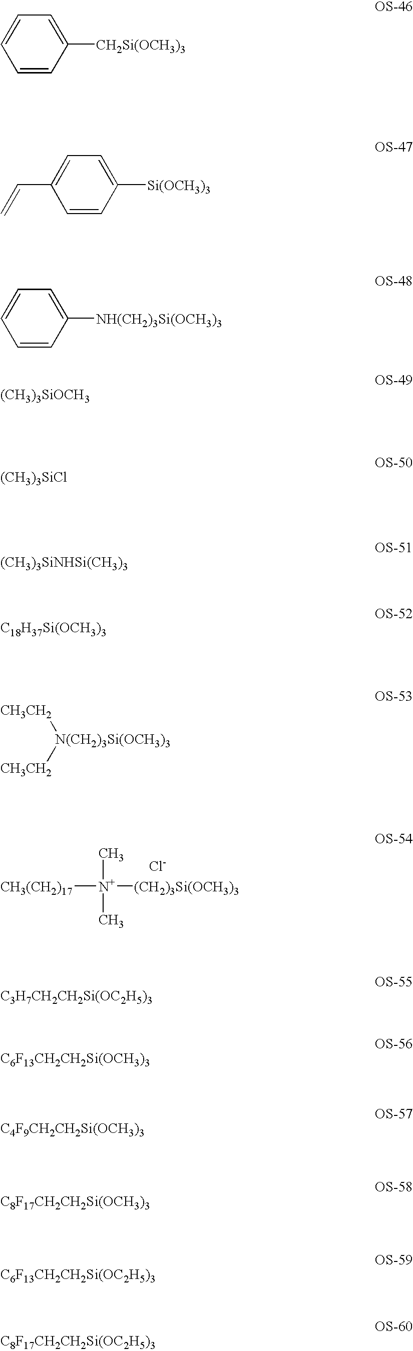

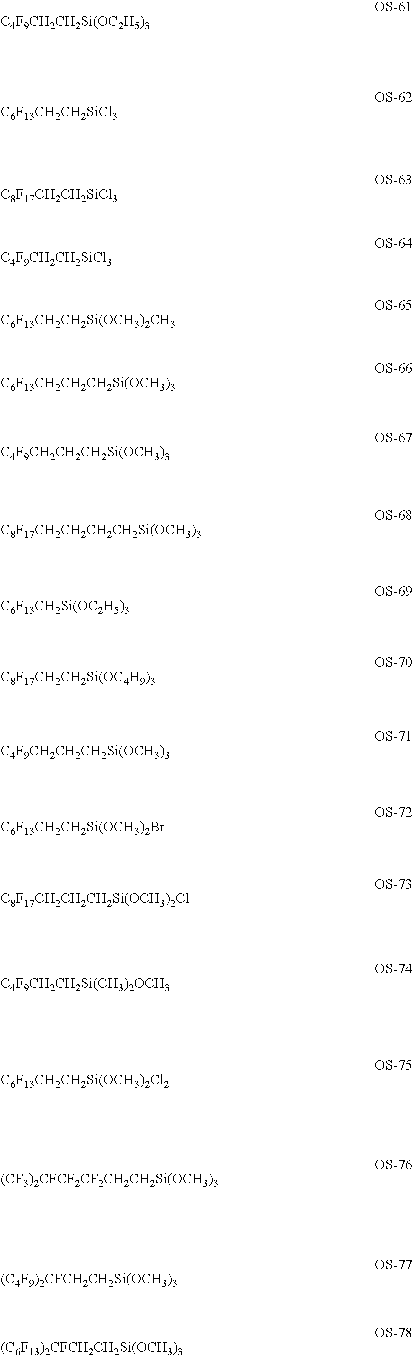

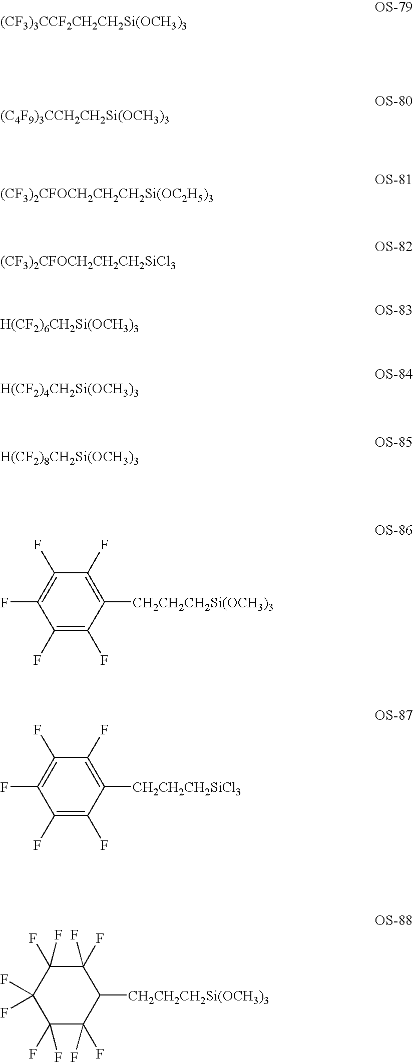

Of these specific examples, (OS-1), (OS-2), (OS-56), (OS-57), and so on are especially preferable. Furthermore, compounds A, B and C as described in the Referential Examples of Japanese Patent No. 3474330 are excellent in dispersion stability and are preferable.

In the invention, though the use amount of the organosilane compound represented by the formula (3) is not particularly limited, it is preferably from 1% by weight to 300% by weight, more preferably from 3% by weight to 100% by weight, and most preferably from 5% by weight to 50% by weight per the inorganic fine particle. The use amount is from 1 to 300% by mole, more preferably from 5 to 300% by mole, and most preferably from 10 to 200% by mole per a normality concentration on the basis of a hydroxyl group of the surface of the inorganic fine particle. When the use amount of the organosilane compound falls within the foregoing range, a sufficient effect for stabilizing the dispersion is obtained, and a film strength at the time of forming a coating film increases.

It is also preferred to use plural kinds of organosilane compounds jointly. The plural kinds of compounds can be added simultaneously or can be reacted by staggering the addition time. Furthermore, when plural kinds of compounds are formed into a partial condensate in advance and then added, the reaction control is easy, and therefore, such is preferable.

### (Use Amount of Organosilane Compound)

In the invention, it is preferable that at least one of the foregoing organosilane compound, its hydrolyzate and its hydrolysis condensate is used in any one of the low refractive index layer and layers beneath of the low refractive index layer. With respect to the hydrolysis of an organosilane compound and condensation thereof, it is preferred to use the acid catalyst and/or metal chelate compound as described previously regarding the inorganic fine particle.

In the case where the organosilane compound is used in the low refractive index layer, its use amount is preferably from 1 to 95% by weight, more preferably from 2 to 70% by weight, and most preferably from 2 to 45% by weight per the solids forming the low refractive index layer. In the case where the organosilane compound is used in a layer adjacent to the low refractive index layer, its use amount is preferably from 0.1 to 70% by weight, more preferably from 0.2 to 50% by weight, and most preferably from 1 to 30% by weight per the solids forming the adjacent layer to the low refractive index layer.

### [Hardening Method of Low Refractive Index Layer]

In the invention, it is preferable that a coating composition for forming a low refractive index layer containing a compound capable of being hardened upon irradiation with ionizing radiations, a fine particle having a conductive metal oxide-coated layer (preferably a silica based fine particle having an antimony oxide-coated layer) and optionally a compound having a polysiloxane partial structure or a fluorine-containing antifouling agent is coated on a support and then hardened by a combination of the irradiation with ionizing radiations with a heat treatment before the irradiation, simultaneously with the irradiation or after the irradiation. Some patterns of the manufacturing process will be given below, but it should not be construed that the invention is limited thereto.

(Before the irradiation)→(Simultaneously with the irradiation)→(After the irradiation) (the term “-” means that the heat treatment is not carried out)

(1) (Before the irradiation)→(Hardening upon irradiation with ionizing radiations)≦(-)
(2) (Heat treatment)→Hardening upon irradiation with ionizing radiations)→(Heat treatment)
(3)(−)→(Hardening upon irradiation with ionizing radiations)→(Heat treatment)

Besides, a process for carrying out the heat treatment simultaneously with the hardening upon irradiation with ionizing radiations is also preferable.

### (Heat Treatment)

In the invention, as described previously, it is preferable that the heat treatment is carried out in combination with the irradiation with ionizing radiations. The heat treatment is not particularly limited so far as it changes the presence state of the component of every kind from an interface between the low refractive index layer and a layer beneath the low refractive index layer to the surface of the low refractive index layer. The heat treatment is preferably carried out at a temperature of from 60 to 200° C., more preferably from 80 to 130° C., and most preferably from 80 to 110° C.

By increasing the temperature, surface free energy is lowered. In the case where a polysiloxane based component or a fluorine-containing component is contained, the alignment into the vicinity of the surface of the low refractive index layer can be promoted. Before hardening upon irradiation with ionizing radiations, the respective components are not fixed, and the foregoing alignment occurs relatively rapidly. However, after hardening upon irradiation with ionizing radiations, the respective components are fixed so that the alignment occurs only partially. Though the time required for the heat treatment varies depending upon the molecular weight of the component to be used, a mutual action with other component, the viscosity, and the like, it is preferably from 30 seconds to 24 hours, more preferably from 60 seconds to 5 hours, and most preferably from 3 minutes to 30 minutes.

A method of controlling the surface temperature of the film at a desired value is not particularly limited. For example, a method of heating a roll and bringing it into contact with the film, a method of blowing heated nitrogen, and irradiation with far infrared rays or infrared rays are preferable. A method of flowing warm water or vapor on a rotary metal roll as described in Japanese Patent No. 2523574 can also be utilized. On the other hand, at the time of irradiation with ionizing radiations as described below, in the case where the surface temperature of the film increases, a method of cooling a roll and bringing it into contact with the film can be utilized.

(Condition for Irradiation with Ionizing Radiations)

Though the surface temperature of the film at the time of irradiation with ionizing radiations is not particularly limited, it is in general from 20 to 200° C., preferably from 30 to 150° C., and most preferably from 40 to 120° C. in view of handling properties and in-plane performance. When the surface temperature of the film is not higher than the foregoing upper limit value, problems that the fluidity of a low molecular weight component in the binder excessively increases, thereby deteriorating the surface properties and that the support is damaged by heat are not caused, and therefore, such is preferable. Furthermore, when the surface temperature of the film is the foregoing lower value or higher, the progress of the hardening reaction is sufficient and the scar resistance of the film is satisfactory, and therefore, such is preferable.

Though the kind of the ionizing radiation is not particularly limited, examples thereof include X-rays. electron beams, ultraviolet rays, visible light, and infrared rays. Of these, ultraviolet rays are widely employed. For example, when the coating film is hardenable with ultraviolet rays, it is preferable that the respective layers are hardened upon irradiation with ultraviolet rays by an ultraviolet lamp at a dose of from 10 mJ/cm² to 1,000 mJ/cm². In the irradiation, though the foregoing energy may be applied at once, it can be irradiated dividedly. In particular, from the standpoint that the scattering of the performance within the plane of the coating film is made small, it is also preferable that the energy is irradiated while dividing it approximately 2 to 8 times.

The time for which the film after the irradiation with ionizing radiations is kept at the foregoing temperature is preferably 0.1 seconds or more and not more than 300 seconds, and more preferably 0.1 seconds or more and not more than 10 seconds after completion of the irradiation with ionizing radiations. When the time for keeping the surface temperature of the film within the foregoing temperature range is too short, the reaction of the coating composition for forming a low refractive index layer which forms a film cannot be promoted, whereas when it is too long, there is generated such a problem that the equipment becomes large or other problem.

### (Oxygen Concentration)

An oxygen concentration at the time of irradiation with ionizing radiations is preferably not more than 3% by volume, more preferably not more than 1% by volume, and further preferably not more than 0.1% by volume. In a process for irradiating ionizing radiations in an oxygen concentration of not more than 3% by volume, by providing a step for keeping it under an atmosphere having an oxygen concentration of not more than 3% by volume just before or just after the irradiation, the hardening of the film is sufficiently promoted so that a film having excellent physical strength and chemical resistance can be formed.

As a measure for lowering the oxygen concentration, it is preferable that the air (nitrogen concentration: about 79% by volume, oxygen concentration: about 21% by volume) is substituted with a separate inert gas, and it is especially preferable that the air is substituted with nitrogen (purged with nitrogen). By carrying out conveyance under an atmosphere with low oxygen concentration prior to the step for irradiating ionizing radiations, the oxygen concentration on the surface and inside of the coating film can be reduced, and the hardening can be promoted. The oxygen concentration in the conveyance step prior to the irradiation with ionizing radiations is preferably not more than 3% by volume, more preferably not more than 1% by volume, and further preferably not more than 0.1% by volume,

### (Polymerization Initiator)

In the invention, the polymerization of the ionizing radiation hardenable compound and other polymerizable compound can be carried out upon irradiation with ionizing radiations or by heating in the presence of a photo radical initiator or a heat radical initiator.

### (Photo Radical Initiator)

Examples of the photo radical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfoniums, lophine dimers, onium salts, borate salts, active esters, active halogens, inorganic complexes, and coumarins.

Examples of the acetophenones include 2,2-dimethoxyacetophenone, 2,2-diethoxyacetophenone, p-dimethylacetophenone, 1-hydroxy-dimethyl phenyl ketone, 1-hydroxy-dimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)butanone, 4-phenoxydichloroacetophenone, and 4-t-butyl-dichloroacetophenone.

Examples of the benzoins include benzoin, benzoin methyl ether, benzoin ethyl ether, benzoin isopropyl ether, benzyl dimethyl ketal, benzoin benzenesulfonic acid ester, benzoin toluenesulfonic acid ester, benzoin methyl ether, benzoin ethyl ether, and benzoin isopropyl ether.

Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone), and 3,3′,4,4′-tetra(t-butyl peroxycarbonyl)benzophenone.

Examples of the phosphine oxides include 2,4,6-trimethylbenzoyl diphenylphosphine oxide. Examples of the active esters include 1,2-octanedione, 1-[4-(phenylthio)-2-(O-benzoyloxime)], sulfonic acid esters, and cyclic active ester compounds. Concretely, Compounds 1 to 21 as described in the working examples of JP-A-2000-80068 are especially preferable.

Examples of the oniums include aromatic diazonium salts, aromatic iodonium salts, and aromatic sulfonium salts. Examples of the borate salts include ion complexes with a cationic dye.

As the active halogens, there are known s-triazine or oxathiazole compounds, for example, 2-(p-methoxyphenyl)-4,6-bis(trichloromethyl)-s-triazine, 2-(p-methoxy-phenyl)-4,6-bis(trichloromethyl)-s-triazine, 2-(p-styryl-phenyl)-4,6-bis(trichloromethyl)-s-triazine, 2-(3-bromo-4-di(ethyl acetate)amino)phenyl)-4,6-bis(trichloromethyl)-s-triazine, and a 2-trihalomethyl-5-(p-methoxyphenyl)-1,3,4-oxadiazole, Concretely, compounds as described in JP-A-58-15503, pages 14 to 30 and JP-A-55-77742, pages 6 to 10; and Compound Nos. 1 to 8 as described in JP-B-60-27673, page 287, Compound Nos. 1 to 17 as described in JP-A-60-239736, pages 443 to 444, and Compound Nos. 1 to 19 of U.S. Pat. No. 4,701,399.

Examples of the inorganic complexes include bis-(η⁵-2,4-cyclopentadien-1-yl)-bis(2,6-difluoro-3-(1H-pyrrol-1-yl)phenyl)titanium. Examples of the coumarins include 3-ketocoumarin.

Such an initiator may be used singly in admixture.

In the invention, as the compound which has a high molecular weight and which is hardly volatilized from the coating film, an oligomer type polymerization initiator is preferable. The oligomer type radiation polymerization initiator is not particularly limited so far as it has a site from which a photo radical is generated upon irradiation with radiations. For the purpose of preventing volatilization by the heat treatment from occurring, a molecular weight of the polymerization initiator is preferably 250 or more and not more than 10,000, and more preferably 300 or more and not more than 10,000. Further preferably, its weight average molecular weight from 400 to 10,000. When the weight average molecular weight is 400 or more, the volatilization properties are low, and therefore, such is preferable. When the weight average molecular weight is not more than 10,000, the hardness of the resulting hardened coating film becomes sufficient, and therefore, such is preferable. As a specific example of the oligomer type radiation polymerization initiator, there can be enumerated an oligo-[2-hydroxy-2-methyl-1-{4-(1-methylvinyl)phenyl}propanone] represented by the following formula (5).

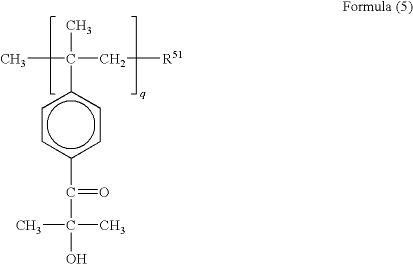

In the foregoing formula (5), R⁵¹ is a monovalent group, and preferably a monovalent organic group; and q represents an integer of from 2 to 45.

Examples of a commercially available product of the oligo-[2-hydroxy-2-methyl-1-{4-(1-methylvinyl)phenyl}propanone] represented by the foregoing formula (5) include “EZACURE KIP150” (CAS-No. 163702-01-0, q=4 to 6), “EZACURE KIP65LT” (a mixture of “EZACURE KIP150” and tripropylene glycol diacrylate), “EZACURE KIP 100F” (a mixture of “EZACURE KIP 150” and 2-hydroxy-2-methyl-1-phenylpropan-1-one), “EZACURE KT37” and “EZACURE KT55 (all of which are a mixture of “EZACURE KIP 150” and a methylbenzophenone derivative), “EZACURE KTO46” (a mixture of “EZACURE KIP150”, a methylbenzophenone derivative and 2,4,6-trimethylbenzoyldiphenylphosphine oxide), and “EZACURE KIP75/B” (a mixture of “EZACURE KIP150” and 2,2-dimethoxy-1,2-diphenylethan-1-one), all of which are a trade name as manufactured by Fratelli Lamberti Co.

A variety of examples are described in Saishin UV Koka Gijutsu (Latest UV Curing Technologies), published by Technical Information Institute Co., Ltd., page 159 (1991) and Kiyoshi Kato, Shigaisen Koka Shisutemu (Ultraviolet Ray Curing Systems), published by Sogo Gijutsu Center, pages 65 to 148 (1988) and are useful in the invention.

As a commercially available photo cleavage type photo radical polymerization initiator, “IRGACURE 651”, “IRGACURE 184”, “IRGACURE 819”, “IRGACURE 907”, “IRGACURE 1870” (a mixed initiator of CGI-403 and Irg 184 (7/3)), “IRGACURE 500”, “IRGACURE 369”, “IRGACURE 1173”, “IRGACURE 2959”, “IRGACURE 4265”, “IRGACURE 4263”, and “OXE 01”, all of which are manufactured by Ciba Speciality Chemicals; “KAYACURE DETX-S”, “KAYACURE BP-100”, “KAYACURE BDMK”, “KAYACURE CTX”, “KAYACURE BMS”, “KAYACURE 2-EAQ”, “KAYACURE ABQ”, “KAYACURE CPTX”, “KAYACURE EPD”, “KAYACURE ITX”, “KAYACURE QTX”, “KAYACURE BTC”, and “KAYACURE MCA”, all of which are manufactured by Nippon Kayaku Co., Ltd.; and ESACURE Series as manufactured by Sartmer Company Inc. (for example, KIP100F, KB1, EB3, BP, X33, KT046, KT37, KIP150, and TZT), and combinations thereof are enumerated as preferred examples.

The photopolymerization initiator is preferably used in an amount in the range of from 0.1 to 15 parts by weight, and more preferably from 1 to 10 parts by weight based on 100 parts by weight of the ionizing radiation hardenable compound.

In addition to the photopolymerization initiator, a photosensitizer may be used. Specific examples of the photosensitizer include n-butylamine, triethylamine, tri-n-butyl phosphine, Michler's ketone, and thioxanthone. In addition, at least one auxiliary agent such as azide compounds, thiourea compounds, and mercapto compounds may be combined and used.

With respect to commercially available photosensitizers, there are enumerated “KAYACURE DMBI” and “KAYACURE EPA” as manufactured by Nippon Kayaku Co., Ltd.

### (Heat Radical Initiator)

Examples of a heat radical initiator which can be used include organic or inorganic peroxides, and organic azo or diazo compounds.

Concretely, examples of the organic peroxides include benzoyl peroxide, halogen benzoyl peroxides, lauroyl peroxide, acetyl peroxide, dibutyl peroxide, cumene hydroperoxide, and butyl hydroperoxide; examples of the inorganic peroxides include hydrogen peroxide, ammonium persulfate, and potassium persulfate; examples of the azo compounds include 2,2′-azobis(isobutyronitrile), 2,2′-azobis(propionitrile), and 1,1′-azobis(cyclohexanecarbonitrile); and examples of the diazo compounds include diazoaminobenzene and p-nitrobenzene diazonium.

### [Layer Configuration of Antireflection Film]

The antireflection film of the invention has a hard coat layer as described later on a transparent substrate (also named as “support”) as the need arises and is stacked thereon so as to reduce the reflectance by optical interference while taking into consideration the refractive index, the thickness, the number of layers, the layer order, and so on. In the antireflection film, the simplest configuration is a configuration in which only a low refractive index layer is coated on a substrate. In order to further lower the reflectance, it is preferable that the antireflection layer is configured by combining a high refractive index layer having a higher refractive index than the substrate and a low refractive index layer having a lower refractive index than the substrate. Examples of the configuration include a stack made of two layers of a high refractive index layer and a low refractive index layer; a stack made of three layers having a different refractive index of a middle refractive index layer (a layer having a higher refractive index than the substrate or hard coat layer and having a lower refractive index than a high refractive index layer), a high refractive index layer and a low refractive index layer in this order. There is also proposed a stack having more antireflection layers. Above all, in view of durability, optical characteristics, costs, productivity, and so on, it is preferable that a middle refractive index layer, a high refractive index layer and a low refractive index layer are coated in this order on a substrate having a hard coat layer.

Examples of the preferred layer configuration of the antireflection film of the invention will be given below. In the following configurations, the substrate film refers to a support which is configured by a film.

Substrate film/low refractive index layer

Substrate film/antistatic layer/low refractive index layer

Substrate film/antiglare layer/low refractive index layer

Substrate film/antiglare layer/antistatic layer/low refractive index layer

Substrate film/hard coat layer/antiglare layer/low refractive index layer

Substrate film/hard coat layer/antiglare layer/antistatic layer/low refractive index layer

Substrate film/hard coat layer/antistatic layer/antiglare layer/low refractive index layer

Substrate film/hard coat layer/high refractive index layer/low refractive index layer

Substrate film/hard coat layer/antistatic layer/high refractive index layer/low refractive index layer

Substrate film/hard coat layer/middle refractive index layer/high refractive index layer/low refractive index layer

Substrate film/antiglare layer/high refractive index layer/low refractive index layer

Substrate film/antiglare layer/middle refractive index layer/high refractive index layer/low refractive index layer

Substrate film/antistatic layer/hard coat layer/middle refractive index layer/high refractive index layer/low refractive index layer

Antistatic layer/substrate film/hard coat layer/middle refractive index layer/high refractive index layer/low refractive index layer

Substrate film/antistatic layer/antiglare layer/middle refractive index layer/high refractive index layer/low refractive index layer

Antistatic layer/substrate film/antiglare layer/middle refractive index layer/high refractive index layer/low refractive index layer

Antistatic layer/substrate film/antiglare layer/high refractive index layer/low refractive index layer/high refractive index layer/low refractive index layer

So far as the reflectance by optical interference can be reduced, it should not be construed that the antireflection film of the invention is limited only to these layer configurations.

The high refractive index layer may be a light diffusible layer having no antiglare properties.

Furthermore, the antistatic layer is preferably a layer containing a conductive polymer particle or a metal oxide fine particle (for example, ATO and ITO) and can be provided by coating, treating with an atmospheric-pressure plasma, or the like. In the case of providing an antifouling layer, it can be provided in the uppermost layer of the foregoing configuration.

### [High Refractive Index Layer]

In the invention, it is preferred to provide a high refractive index layer. The high refractive index layer can be formed of, for example, a binder, a mat particle for imparting antiglare properties, and an inorganic filler for the purposes of realizing a high refractive index, preventing crosslinking shrinkage and realizing a high strength.

### [Mat Particle]

In the high refractive index layer, for the purpose of imparting antiglare properties, it is possible to contain a mat particle having a larger particle size than an inorganic filler particle and preferably having an average particle size of from 0.1 to 5.0 μm, and more preferably from 1.5 to 3.5 μm, for example, a particle of an inorganic compound and a resin particle. From the viewpoints of prevention of cloudiness of the film and a good light diffusing effect, a difference in refractive index between the mat particle and the binder is preferably from 0.02 to 0.20, and especially preferably from 0.04 to 0.10. From the same viewpoints as well as the refractive index, the addition amount of the matting agent to the binder is preferably from 3 to 30% by weight, and especially preferably from 5 to 20% by weight.

As a specific example of the foregoing mat particle, there are preferably enumerated particles of an inorganic compound (for example, a silica particle and a TiO₂ particle); and resin particles (for example, an acrylic particle, a crosslinked acrylic particle, a polystyrene particle, a crosslinked styrene particle, a melamine resin particle, and a benzoguanamine resin particle). Above all, a crosslinked styrene particle, a crosslinked acrylic particle, and a silica particle are especially preferable.

With respect to the shape of the mat particle, all of a spherical shape and an amorphous shape can be employed.

Two or more kinds of mat particles may be used jointly.

In the case where two or more kinds of mat particles are used, in order to effectively reveal a control of the refractive index by mixing the both, a difference in the refractive index is preferably 0.02 or more and not more than 0.10, and especially preferably 0.03 or more and not more than 0.07.

Furthermore, it is possible to impart antiglare properties by a mat particle having a larger particle size and to impart a separate optical characteristic by a mat particle having a smaller particle size. For example, in the case of sticking an antireflection film onto a display with high definition of 133 ppi or more, it is required that there is no inconvenience in optical performance called as “glare”. The glare is derived from the matter that pixels are enlarged or contracted due to irregularities (contributing to antiglare properties) present on the film surface, thereby loosing the uniformity of luminance. It is possible to largely improve the glare at a smaller particle size than that of the mat particle for imparting antiglare properties by jointly using a mat particle having a different refractive index from the binder.

In addition, with respect to the particle size distribution of the foregoing mat particle, a monodispersed state is the most preferable, and it is preferable that the particle size of the respective particles is the same or closed to each other as far as possible. For example, in the case where a particle having a particle size of 20% or more higher than the average particle size is defined as a “coarse particle”, a proportion of this coarse particle is preferably not more than 1%, more preferably not more than 0.1%, and further preferably not more than 0.01% of the number of whole particles. The mat particle having such particle size distribution can be obtained by classification after a usual synthesis reaction, and a matting agent with more satisfactory distribution can be obtained by increasing the number of classification or strengthening its degree.

The foregoing mat particle is contained in the formed high refractive index layer such that an amount of the mat particle in the high refractive index layer is preferably from 10 to 1,000 mg/m², and more preferably from 100 to 700 mg/m².

The particle size distribution of the mat particle is measured by a Coulter counter method, and the measured distribution is reduced into particle number distribution.

### [High Refractive Index Particle]

For the purposes of increasing the refractive index of the layer and reducing the hardening shrinkage, it is preferable that in addition to the foregoing mat particle, an inorganic filler made of an oxide of at least one metal selected from titanium, zirconium, aluminum, indium, zinc, tin, and antimony and preferably having an average particle size of not more than 0.2 μm, more preferably not more than 0.1 μm, and further preferably not more than 0.06 μm is contained.

Furthermore, in order to make a difference in the refractive index from the mat particle, it is preferred to use an oxide of silicon in the low refractive index layer using a mat particle with high refractive index for the purpose of making the refractive index of the layer low. A preferred particle size is the same as in the foregoing inorganic fine particle to be used in the low refractive index layer.

### [Inorganic Filler]

Specific examples of the inorganic filler which is used in the high refractive index layer include TiO₂, ZrO₂, Al₂O₃, In₂O₃, ZnO, SnO₂, Sb₂O₃, ITO, and SiO₂. Of these, TiO₂ and ZrO₂ are especially preferable in view of realizing a high refractive index. In the inorganic filler, it is preferable that its surface is subjected to a silane coupling treatment or a titanium coupling treatment, and a surface treating agent containing a functional group capable of reacting with a binder species on the filler surface is preferably used.

The addition amount of such an inorganic filler is preferably from 10 to 90%, more preferably from 20 to 80%, and especially preferably from 30 to 70% of the whole weight of the high refractive index layer.

Incidentally, since such a filler does not cause scattering because its particle size is sufficiently small as compared with the wavelength of light, and a dispersion medium having the filler dispersed in a binder polymer acts as an optically uniform substance.

A refractive index of a bulk of a mixture of the binder and the inorganic filler of the high refractive index layer of the invention is preferably from 1.48 to 2.00, and more preferably from 1.50 to 1.80. In order to make the refractive index fall within the foregoing range, the kinds and amounts of the binder and the inorganic filler may be properly selected. What they are selected can be experimentally known with ease in advance.

### [Hard Coat Layer]

For the purpose of imparting a physical strength to the antireflection film, a hard coat layer is provided on a surface of the support as the need arises. In particular, it is preferable that the hard coat layer is provided between the support and the foregoing high refractive index layer (or the middle refractive index layer). Furthermore, by containing the foregoing high refractive index particle or the like in the layer, the hard coat layer can also work as the high refractive index layer.

The hard coat layer is preferably formed by a crosslinking reaction or polymerization reaction of an ionizing radiation hardenable resin. For example, the hard coat layer can be formed by coating a coating composition containing an ionizing radiation hardenable polyfunctional monomer or polyfunctional oligomer on a support and subjecting the polyfunctional monomer or polyfunctional oligomer to a crosslinking reaction or a polymerization reaction.

Furthermore, likewise the case of the foregoing high refractive index layer, a mat particle and an inorganic filler can be used in the same amount ranges in the hard coat layer.

In the thus formed antireflection film of the invention, a haze value is preferably in the range of from 3 to 70%, and more preferably from 4 to 60%; and an average reflectance at a wavelength of from 450 nm to 650 nm is preferably not more than 3.0%, and more preferably not more than 2.5%. When the haze value and the average reflectance of the antireflection film of the invention fall within the foregoing ranges, satisfactory antiglare properties and antireflection properties are obtained without being accompanied with deterioration of a transmitted image.

### [Surface Property Improving Agent]

In order to improve defective surface properties (for example, coating unevenness, drying unevenness, and point defect), it is preferred to add at least a fluorine based surface property improving agent or a silicone based surface property improving agent in a coating solution which is used for preparing any one of layers on the support.

The surface property improving agent preferably changes a surface tension of the coating solution by 1 mN/m or more. Here, what the surface tension of the coating solution is changed by 1 mN/m or more means that the surface tension of the coating solution after adding the surface property improving agent is changed by 1 mN/m or more at the time of coating/drying inclusive of a concentration step as compared with a surface tension of a coating solution in which the surface property improving agent is not added. The surface property improving agent is preferably a surface property improving agent having an effect for decreasing the surface tension of the coating solution by 1 mN/m or more, a more preferably a surface property improving agent having an effect for decreasing the surface tension of the coating solution by 2 mN/m or more, and especially preferably a surface property improving agent having an effect for decreasing the surface tension of the coating solution by 3 mN/m or more.

As a preferred example of the fluorine based surface property improving agent, there is enumerated a compound containing a fluoro aliphatic group (hereinafter abbreviated as “fluorine based surface property improving agent”). In particular, acrylic resins and methacrylic resins containing a repeating unit corresponding to a monomer represented by the following formula (6) and a repeating unit corresponding to a monomer represented by the following formula (7) and copolymers thereof with a copolymerizable vinyl based monomer are preferable.

Such a monomer, monomers as described in Polymer Handbook, Second Edition, edited by J. Brandrup and published by Wiley Interscience (1975), Chapter 2, pages 1 to 483 are preferably used.

Specific examples thereof include compounds containing one addition polymerizable unsaturated bond, which are selected from acrylic acid, methacrylic acid, acrylic esters, methacrylic esters, acrylamides, methacrylamides, allyl compounds, vinyl ethers, vinyl esters, and so on.

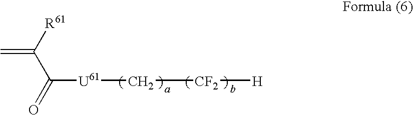

In the formula (6), R⁶¹ represents a hydrogen atom, a halogen atom, or a methyl group; and preferably a hydrogen atom or a methyl group. U⁶¹ represents an oxygen atom, a sulfur atom, or —N(R⁶²)—; preferably an oxygen atom or —N(R⁶²)—; and more preferably an oxygen atom. R⁶² represents a hydrogen atom or an alkyl group having from 1 to 8 carbon atoms; preferably a hydrogen atom or an alkyl group having from 1 to 4 carbon atoms; and more preferably a hydrogen atom or a methyl group. a represents an integer of from 1 to 6, preferably from 1 to 3, and more preferably 1. b represents an integer of from 1 to 18, preferably from 4 to 12, and more preferably from 6 to 8.

Two or more kinds of the fluoro aliphatic group-containing monomer represented by the formula (6) may be contained as a constitutional component in the fluorine based surface property improving agent.

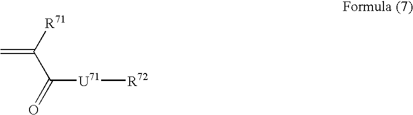

In the formula (7), R⁷¹ represents a hydrogen atom, a halogen atom, or a methyl group; and preferably a hydrogen atom or a methyl group. U⁷¹ represents an oxygen atom, a sulfur atom, or —N(R⁷³)—; preferably an oxygen atom or —N(R⁷³)—; and more preferably an oxygen atom. R⁷³ represents a hydrogen atom or an alkyl group having from 1 to 8 carbon atoms; preferably a hydrogen atom or an alkyl group having from 1 to 4 carbon atoms; and more preferably a hydrogen atom or a methyl group.

R⁷² represents a hydrogen atom, a substituted or unsubstituted linear, branched or cyclic alkyl group having from 1 to 20 carbon atoms, a poly(alkylene oxide) group-containing alkyl group, or a substituted or unsubstituted aromatic group (for example, a phenyl group and a naphthyl group); preferably a linear, branched or cyclic alkyl group having from 1 to 12 carbon atoms or an aromatic group having from 6 to 18 carbon atoms in total; and more preferably a linear, branched or cyclic alkyl group having from 1 to 8 carbon atoms.

The poly(alkylene oxy) group will be hereunder described.

The poly(alkylene oxy) group is also called as a poly(oxyalkylene) group.

The poly(alkylene oxy) group is a group containing —(OR)— as a repeating unit, and examples thereof include an alkylene group having from 2 to 4 carbon atoms, for example, —CH₂CH₂—, —CH₂CH₂CH₂—, —CH(CH₃)CH₂—, and —CH(CH₃)CH(CH₃)—.

The oxyalkylene unit (the foregoing —OR—) in the foregoing poly(oxyalkylene) group may be the same or one in which two or more kinds of oxyalkylenes which are different from each other are irregularly distributed. The oxyalkylene group may be a linear or branched oxypropylene or oxyethylene unit or a group in which a linear or branched oxypropylene unit or oxyethylene unit is present as a block.

This poly(oxyalkylkene) chain can contain one connected by one or more chain bonds (for example, —CONH-Ph-NHCO— and —S—, wherein Ph represents a phenylene group). In the case where the chain bond has a valence of 3 or more, this is a measure for obtaining an oxyalkylene unit of the branched chain. Furthermore, in the case where this copolymer is used in the invention, a molecular weight of the poly(oxyalkylene) group is suitably from 250 to 3,000.

A poly(oxyalkylene) acrylate or methacrylate can be manufactured by reacting a commercially available hydroxy poly(oxyalkylene) material (for example, “PLURONIC” (a trade name, manufactured by Adeka Corporation); “ADEKA POLYETHER” (a trade name, manufactured by Adeka Corporation); “CARBOWAX” (a trade name, manufactured by Glico Products Co., Ltd.); “TORITON” (a trade name, as manufactured by Rohm & Haas); and “P.E.G.” (a trade name, as manufactured by Dai-ichi Kogyo Seiyaku Co., Ltd.)) with acrylic acid, methacrylic acid, acryl chloride, methacryl chloride, acrylic anhydride, etc. by a known method. Separately, a poly(oxyalkylene) diacrylate as manufactured by a known method and so on can also be used.

In the fluorine based surface property improving agent which is used in the invention, an amount of the fluoro aliphatic group-containing monomer represented by the formula (6) is preferably in the range of 50% by mole or more, more preferably from 70 to 100% by mole, and especially preferably from 80 to 100% by mole based on the whole amount of monomers which are used for forming the fluorine based surface property improving agent.

A weight average molecular weight of the fluorine based surface property improving agent which is used in the invention is preferably from 3,000 to 100,000, more preferably from 6,000 to 80,000, and further preferably from 8,000 to 60,000. Here, the weight average molecular weight is a molecular weight as reduced into polystyrene, which is detected in TKF as a solvent by a differential refractometer by using a GPC analyzer with a column of “TSKgel GMHxL”, “TSKgel G4000HxL” or “TSKgel G2000HxL” (all of which are a trade name as manufactured by Tosoh Corporation). In the case where a peak area of components having a molecular weight of 3,000 or more is defined as 100%, the content means an area % of peaks of the foregoing molecular weight range.

In addition, the addition amount of the fluorine based surface property improving agent which is used in the invention is preferably in the range of from 0.001 to 5% by weight, more preferably in the range of from 0.005 to 3% by weight, and further preferably from 0.01 to 1% by weight based on the coating solution of the layer in which the fluorine based surface property improving agent is added.

Examples of a specific structure of the fluorine based surface property improving agent which is useful in the invention will be given below, but it should not be construed that the invention is limited thereto. Incidentally, the numeral means a molar fraction of each monomer component; and Mw represents a weight average molecular weight.

TABLE 10

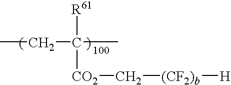

| | R⁶¹ | b | Mw |
|---|---|---|---|
| F-1 | H | 4 | 8000 |
| F-2 | H | 4 | 16000 |
| F-3 | H | 4 | 33000 |
| F-4 | CH₃ | 4 | 12000 |
| F-5 | CH₃ | 4 | 28000 |
| F-6 | H | 6 | 8000 |
| F-7 | H | 6 | 14000 |
| F-8 | H | 6 | 29000 |
| F-9 | CH₃ | 6 | 10000 |
| F-10 | CH₃ | 6 | 21000 |
| F-11 | H | 8 | 4000 |
| F-12 | H | 8 | 16000 |
| F-13 | H | 8 | 31000 |
| F-14 | CH₃ | 8 | 3000 |
| F-15 | CH₃ | 8 | 10000 |
| F-16 | CH₃ | 8 | 27000 |
| F-17 | H | 10 | 5000 |
| F-18 | H | 10 | 11000 |
| F-19 | CH₃ | 10 | 4500 |
| F-20 | CH₃ | 10 | 12000 |
| F-21 | H | 12 | 5000 |
| F-22 | H | 12 | 10000 |
| F-23 | CH₃ | 12 | 5500 |
| F-24 | CH₃ | 12 | 12000 |

TABLE 11

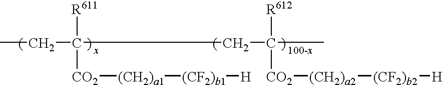

| | x | R⁶¹¹ | a1 | b1 | R⁶¹² | a2 | b2 | Mw |
|---|---|---|---|---|---|---|---|---|
| F-25 | 50 | H | 1 | 4 | CH₃ | 1 | 4 | 10000 |
| F-26 | 40 | H | 1 | 4 | H | 1 | 6 | 14000 |
| F-27 | 60 | H | 1 | 4 | CH₃ | 1 | 6 | 21000 |
| F-28 | 10 | H | 1 | 4 | H | 1 | 8 | 11000 |
| F-29 | 40 | H | 1 | 4 | H | 1 | 8 | 16000 |
| F-30 | 20 | H | 1 | 4 | CH₃ | 1 | 8 | 8000 |
| F-31 | 10 | CH₃ | 1 | 4 | CH₃ | 1 | 8 | 7000 |
| F-32 | 50 | H | 1 | 6 | CH₃ | 1 | 6 | 12000 |
| F-33 | 50 | H | 1 | 6 | CH₃ | 1 | 6 | 22000 |
| F-34 | 30 | H | 1 | 6 | CH₃ | 1 | 6 | 5000 |
| F-35 | 40 | CH₃ | 1 | 6 | H | 3 | 6 | 3000 |
| F-36 | 10 | H | 1 | 6 | H | 1 | 8 | 7000 |
| F-37 | 30 | H | 1 | 6 | H | 1 | 8 | 17000 |
| F-38 | 50 | H | 1 | 6 | H | 1 | 8 | 16000 |
| F-39 | 50 | CH₃ | 1 | 6 | H | 3 | 8 | 19000 |
| F-40 | 50 | H | 1 | 8 | CH₃ | 1 | 8 | 5000 |
| F-41 | 80 | H | 1 | 8 | CH₃ | 1 | 8 | 10000 |
| F-42 | 50 | CH₃ | 1 | 8 | H | 3 | 8 | 14000 |
| F-43 | 90 | H | 1 | 8 | CH₃ | 3 | 8 | 9000 |
| F-44 | 70 | H | 1 | 8 | H | 1 | 10 | 7000 |
| F-45 | 90 | H | 1 | 8 | H | 3 | 10 | 12000 |
| F-46 | 50 | H | 1 | 8 | H | 1 | 12 | 10000 |
| F-47 | 70 | H | 1 | 8 | CH₃ | 3 | 12 | 8000 |

TABLE 12

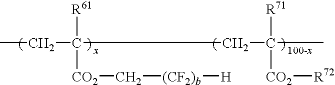

| | x | R⁶¹ | b | R⁷¹ | R⁷² | Mw |
|---|---|---|---|---|---|---|
| F-48 | 80 | H | 4 | CH₃ | CH₃ | 11000 |
| F-49 | 90 | H | 4 | H | C₄H₉(n) | 7000 |
| F-50 | 95 | H | 4 | H | C₆H₁₃(n) | 5000 |
| F-51 | 90 | CH₃ | 4 | H | CH₂CH(C₂H₅)C₄H₉(n) | 15000 |
| F-52 | 70 | H | 6 | CH₃ | C₂H₅ | 18000 |
| F-53 | 90 | H | 6 | CH₃ | 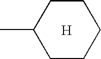 | 12000 |
| F-54 | 80 | H | 6 | H | C₄H₉(s) | 9000 |
| F-55 | 90 | H | 6 | H | C₁₂H₂₅(n) | 21000 |
| F-56 | 60 | CH₃ | 6 | H | CH₃ | 15000 |
| F-57 | 60 | H | 8 | H | CH₃ | 10000 |
| F-58 | 70 | H | 8 | H | C₂H₅ | 24000 |
| F-59 | 70 | H | 8 | H | C₄H₉(n) | 5000 |
| F-60 | 50 | H | 8 | H | C₄H₉(n) | 16000 |
| F-61 | 80 | H | 8 | CH₃ | C₄H₉(i) | 13000 |
| F-62 | 80 | H | 8 | CH₃ | C₄H₉(t) | 9000 |
| F-63 | 60 | H | 8 | H | 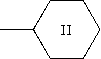 | 7000 |
| F-64 | 80 | H | 8 | H | CH₂CH(C₂H₅)C₄H₉(n) | 8000 |
| F-65 | 90 | H | 8 | H | C₁₂H₂₅(n) | 6000 |

TABLE 13

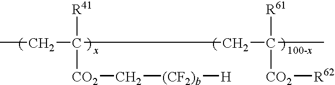

| | x | R⁴¹ | b | R⁶¹ | R⁶² | Mw |
|---|---|---|---|---|---|---|
| F-66 | 80 | CH₃ | 8 | CH₃ | C₄H₉(s) | 18000 |
| F-67 | 70 | CH₃ | 8 | CH₃ | CH₃ | 22000 |
| F-68 | 70 | H | 10 | CH₃ | H | 17000 |
| F-69 | 90 | H | 10 | H | H | 9000 |
| F-70 | 95 | H | 4 | CH₃ | —(CH₃CH₂O)₂—H | 18000 |
| F-71 | 80 | H | 4 | H | —(CH₂CH₂O)₂—CH₃ | 16000 |
| F-72 | 80 | H | 4 | H | —(C₃H₆O)₇—H | 24000 |
| F-73 | 70 | CH₃ | 4 | H | —(C₃H₆O)₁₃—H | 18000 |
| F-74 | 90 | H | 6 | H | —(CH₂CH₂O)₂—H | 21000 |
| F-75 | 90 | H | 6 | CH₃ | —(CH₂CH₂O)₈—H | 9000 |
| F-76 | 80 | H | 6 | H | —(CH₂CH₂O)₂—C₄H₉(n) | 12000 |
| F-77 | 80 | H | 6 | H | —(C₃H₆O)₇—H | 34000 |
| F-78 | 75 | F | 6 | H | —(C₃H₆O)₁₃—H | 11000 |
| F-79 | 85 | CH₃ | 6 | CH₃ | —(C₃H₆O)₂₀ —H | 18000 |
| F-80 | 95 | CH₃ | 6 | CH₃ | —CH₂CH₂OH | 27000 |
| F-81 | 80 | H | 8 | CH₃ | —(CH₂CH₂O)₈—H | 12000 |
| F-82 | 95 | H | 8 | H | —(CH₂CH₂O)₉—CH₃ | 20000 |
| F-83 | 90 | H | 8 | H | —(C₃H₆O)₇—H | 8000 |

It is preferable that the surface property improving agent which is useful in the invention is used in a coating solution containing a ketone based solvent (for example, acetone, methyl ethyl ketone, methyl isobutyl ketone, and cyclohexanone), an ester based solvent (for example, ethyl acetate and butyl acetate), an ether based solvent (for example, tetrahydrofuran and 1,4-dioxane), or an aromatic hydrocarbon based solvent (for example, toluene and xylene). A ketone based solvent is especially preferable. Of ketone based solvents, methyl ethyl ketone, methyl isobutyl ketone, and cyclohexanone are preferable.

The surface property improving agent may possibly deteriorate the adhesiveness at an interface between layers. Accordingly, it is preferable that the surface property improving agent present on the surface of the layer is eluted into a coating solution for forming an adjacent layer thereto, whereby the surface property improving agent does not remain in the vicinity of the interface between the both layers. For that reason, it is preferable that a solvent capable of dissolving the surface property improving agent in the coating solution for forming an adjacent layer is contained. As such a solvent, the foregoing ketone based solvent is preferable.

In the coating solution of a layer which is formed on the support, in particular, it is preferred to add the surface property improving agent in a coating solution for forming a hard coat layer, an antiglare hard coat layer, an antistatic layer, a high refractive index layer, or a low refractive index layer. Above all, it is preferred to add the surface property improving agent in a coating solution for forming a hard coat layer or an antiglare hard coat layer.

### [Support]

As the support of the antireflection film of the invention, it is preferred to use a plastic film. Examples of a polymer capable of forming a plastic film include cellulose esters (for example, triacetyl cellulose and diacetyl cellulose; representatively “TAC-TD80U” and “TD80UL” as manufactured by Fuji Photo Film Co., Ltd.), polyamides, polycarbonates, polyesters (for example, polyethylene terephthalate and polyethylene naphthalate), polystyrene, polyolefins, norbornene based resins (for example, “ARTON” which is a trade name of JSR Corporation), and amorphous polyolefins (for example, “ZEONEX” which is a trade name of Zeon Corporation). Of these, triacetyl cellulose, polyethylene terephthalate, and polyethylene naphthalate are preferable; and triacetyl cellulose is especially preferable. Furthermore, a cellulose acylate film which is substantially free from a halogenated hydrocarbon such as dichloromethane and a manufacturing method thereof are described in a Journal of Technical Disclosure document issued by the Japan Institute of Invention and Innovation (No. 200-1745, issued Mar. 15, 2001, hereinafter referred to as “Journal of Technical Disclosure No. 2001-1745”), and the cellulose acylate as described therein can be suitably used in the invention.

### [Saponification Treatment]

In the case where the antireflection film of the invention is used for a liquid crystal display device, it is usually arranged on the outermost surface of a display by, for example, providing an adhesive layer on one surface thereof. In the case where the support is made of triacetyl cellulose, since triacetyl cellulose can be used as a protective film for protecting a polarizing film of a polarizing plate, it is preferable from the standpoint of costs that the antireflection film of the invention is used as a protective film as it is.

As described previously, in the case where the antireflection film of the invention is arranged on the outermost surface of a display or is used as a protective film for polarizing plate as it is, for the purpose of improving the adhesion, it is preferred to carry out a saponification treatment after forming a low refractive index layer on the support.

The saponification treatment is carried out by a known measure, for example, dipping the antireflection film of the invention in an alkaline solution for a proper period of time. After dipping in the alkaline solution, it is preferable that the antireflection film is thoroughly washed with water or that the antireflection film is dipped in a dilute acid, thereby neutralizing an alkaline component such that the alkaline component does not remain in the film. By this saponification treatment, the surface of the support in the opposite side to the side having the outermost layer is hydrophilized.

The hydrophilized surface is especially effective for improving the adhesion to a polarizing film containing polyvinyl alcohol as a major component. Furthermore, in the hydrophilized surface, since dusts in air hardly attach thereto, the dusts hardly come into a space between the polarizing film and the antireflection film during adhering to the polarizing film. Thus, the hydrophilized surface is effective for preventing a point defect due to the dusts.

The saponification treatment is preferably carried out such that a contact angle of the surface of the support in the opposite side having the outermost surface layer is preferably not more than 30°, and especially not more than 20°.

In general, a concrete measure of the alkaline saponification treatment can be selected among the following two measures (1) and (2). The measure (1) is superior in view of the point that it can be carried out in the same step as in a general-purpose triacetyl cellulose film. However, since even the antireflection layer of the antireflection film is subjected to a saponification treatment, there may be caused problems that the surface is subjected to alkaline hydrolysis, thereby deteriorating the film and that when a saponification treatment solution remains, it becomes a stain. In that case, the measure (2) is superior even when a special step is required.

(1) After forming an antireflection layer on a support, a back surface of the film is subjected to a saponification treatment by dipping in an alkaline solution at least one time.

(2) Before or after forming an antireflection layer on a support, an alkaline solution is coated on a surface in an opposite side to a surface of an antireflection film in a side on which the antireflection layer is formed, heated, washed with water and/or neutralized, thereby subjecting only the back surface of the film to a saponification treatment.

### [Coating Film Forming Method]

The antireflection film of the invention can be formed by the following method, but it should not be construed that the invention is limited thereto.

First of all, a coating solution containing components for forming each layer is prepared.

The resulting coating solution is coated on a support by a dip coating method, an air knife coating method, a curtain coating method, a roller coating method, a wire bar coating method, a gravure coating method, an extrusion coating method (see U.S. Pat. No. 2,681,294), or the like, followed by heating and drying. Among these coating methods, a gravure coating method is preferable because in forming each layer of the antireflection layer, the coating solution can be coated in a small coating amount with high uniformity of the film thickness. In the gravure coating method, a microgravure method is more preferable because the uniformity of the film thickness is high.

Furthermore, when a die coating method is employed, the coating solution can also be coated in a small coating amount with high uniformity of the film thickness. In addition, since the die coating method is of a pre-metering system, the film thickness control is relatively easy, and vaporization of the solvent in a coating area is small. Thus, the die coating method is preferable, too.

Two or more layers may be simultaneously coated. A method of simultaneous coating is described in U.S. Pat. Nos. 2,761,791, 2,941,898, 3,508,947 and 3,526,528 and Yuji Harazaki, Coating Engineering, page 253 (Asakura Publishing Co., Ltd. (1973)).

### <Polarizing Plate>

A polarizing plate is configured mainly of two protective films sandwiching a polarizing film from the both surfaces thereof. It is preferable that the antireflection film of the invention is used for at least one of the two protective films sandwiching a polarizing film from the both surfaces thereof. When the antireflection film of the invention also functions as a protective film, the manufacturing costs of the polarizing plate can be reduced. Furthermore, by using the antireflection film of the invention is used as the outermost surface layer, it is possible to form a polarizing plate which is prevented from reflection of external light or the like and which is excellent in scar resistance, antifouling properties, etc.

### [Polarizing Film]

As a polarizing film, a known polarizing film can be used. Furthermore, a polarizing film which is cut out from a longitudinal polarizing film, an absorption axis of which is neither parallel nor vertical to the longitudinal direction, can also be used. A longitudinal polarizing film, an absorption axis of which is neither parallel nor vertical to the longitudinal direction, can be prepared by the following measure.

That is, such a longitudinal polarizing film can be manufactured by a stretching method in which a polarizing film as prepared by stretching a continuously fed polymer film by imparting a tension while holding both ends thereof by a holding measure is stretched 1.1 to 20.0 times at least in a width direction of the film and bent in a state of holding the both ends of the film in an advancing direction of the film such that a difference in advancing rate in a longitudinal direction of a unit for holding the both ends of the film is within 3% and that an angle formed by the advancing direction of the film in an outlet of the step for holding the both ends of the film and a substantial stretching direction of the time is inclined at from 20 to 70′. In particular, a polarizing film as prepared by inclining at an angle of 45° is preferably used from the viewpoint of productivity.

The stretching method of a polymer film is described in detail in paragraphs [0020] to [0030] of JP-A-2002-86554.

[Combination with Liquid Crystal Display Device]

In the case where the antireflection film of the invention is used as one side of the surface protective film of the polarizing film, it can be suitably used for a transmission type, reflection type or semi-transmission type liquid crystal display device of a mode such as a twisted nematic (TN) mode, a super twisted nematic (STN) mode, a vertical alignment (VA) mode, an in-plane switching (IPS) mode, an optically compensated bend cell (OCB) mode, and an electrically controlled birefringence (ECB) mode.

The liquid crystal cell of a VA mode includes, in addition to (1) a liquid crystal cell of a VA mode in a narrow sense in which a rod-like liquid crystalline molecule is substantially vertically aligned at the time of applying no voltage, whereas it is substantially horizontally aligned at the time of applying a voltage (as described in JP-A-2-176625), (2) a liquid crystal cell of a multi-domained VA mode (MVA mode) for enlarging a viewing angle (as described in SID 97, Digest of Tech. Papers, 28 (1997), page 845), (3) a liquid crystal cell of a mode (n-ASM mode) in which a rod-like liquid crystalline molecule is substantially vertically aligned at the time of applying no voltage and is subjected to twisted multi-domain alignment at the time of applying a voltage (as described in Preprints of Forum on Liquid Crystal, pages 58 to 59 (1998), and (4) a liquid crystal cell of a SURVIVAL mode (as announced in LCD International 98).

For a liquid crystal cell of a VA mode, a polarizing plate as prepared by combining a biaxially stretched triacetyl cellulose film with the antireflection film of the invention is preferably used. With respect to a preparation method of a biaxially stretched triacetyl cellulose film, it is preferred to employ a method as described in, for example, JP-A-2001-249223 and JP-A-2003-170492.

A liquid crystal cell of an OCB mode is a liquid crystal cell of a bend alignment mode in which a rod-like liquid crystalline molecule is aligned in a substantially reverse direction (in a symmetric manner) in the upper and lower parts of a liquid crystal cell and is disclosed in U.S. Pat. Nos. 4,583,825 and 5,410,422. Since the rod-like liquid crystalline molecule is symmetrically aligned in the upper and lower parts of a liquid crystal cell, the liquid crystal cell of a bend alignment mode has a self optical compensating ability. For that reason, this liquid crystal mode is named as an OCB (optically compensatory bend) liquid crystal mode. A liquid crystal display device of a bend alignment mode involves an advantage such that the response speed is fast.

In a liquid crystal cell of an ECB mode, a rod-like liquid crystalline molecule is aligned substantially horizontally at the time of not applying a voltage, and the liquid crystal cell of an ECB mode is most frequently utilized as a color TFT liquid crystal display device and described in a number of documents. The liquid crystal cell of an ECB mode is described in, for example, EL, PDP and LCD Displays (published by Toray Research Center, Inc.) (2001).

In particular, with respect to liquid crystal display devices of a TN mode or an IPS mode, as described in JP-A-2001-100043, by using an optically compensatory film having an effect for enlarging a viewing angle for a surface in the opposite side to the antireflection film of the invention among two protective films on the back and front surfaces of the polarizing film, a polarizing plate having an antireflection effect and an effect for enlarging a viewing angle can be obtained in a thickness of a single polarizing plate, and therefore, such is especially preferable.

### EXAMPLES

The invention will be hereunder described with respect to the following Examples, but it should not be construed that the invention is limited thereto. All “part” and “%” are on a weight basis unless otherwise indicated.

### Antireflection Film

### Example 1

### Preparation of Antimony Oxide-Coated Silica Based Fine Particle (P1)

### 1. Preparation of Silica Based Fine Particle (A-1):

A mixture of 100 g of a silica sol having an average particle size of 5 nm and an SiO₂ concentration of 20% by weight and 1,900 g of pure water was heated at 80° C. This reaction mother liquor had a pH of 10.5, and 9,000 g of a sodium silicate aqueous solution of 1.17% by weight as SiO₂ and 9,000 g of a sodium aluminate aqueous solution of 0.83% by weight as Al₂O₃ were simultaneously added to the reaction mother liquor. Meanwhile, the reaction solution was kept at a temperature of 80° C. The pH of the reaction solution increased to 12.5 immediately after the addition and thereafter, did not substantially change. After completion of the addition, the reaction solution was cooled to room temperature and washed through an ultrafiltration membrane, thereby preparing an SiO₂—Al₂O₃ primary particle dispersion having a solids content of 20% by weight.

1,700 g of pure water was added to 500 g of this primary particle dispersion, and the mixture was heated at 98° C. 53,200 g of ammonium sulfate having a concentration of 0.5% by weight was added while keeping this temperature, to which were then added 3,000 g of a sodium silicate aqueous solution having a concentration of 1.17% by weight as SiO₂ and 9,000 g of a sodium aluminate aqueous solution having a concentration of 0.5% by weight as Al₂O₃, thereby obtaining a dispersion of composite oxide fine particle (1).

Next, 1,125 g of pure water was added to 500 g of the dispersion of composite oxide fine particle (1) whose solids concentration had become 13% by weight by washing through an ultrafiltration membrane, to which was then added dropwise concentrated hydrochloric acid (concentration: 35.5% by weight) to adjust a pH at 1.0, followed by a dealuminum treatment. Next, a dissolved aluminum salt was separated by an ultrafiltration membrane while adding 10 liters of a hydrochloric acid aqueous solution at a pH of 3 and 5 liters of pure water, thereby preparing a dispersion of silica based fine particle (A-1) having a solids concentration of 20% by weight.

This silica based fine particle (A-1) had an average particle size of 58 nm, an MOₓ/SiO₂ molar ratio of 0.0097 and a refractive index of 1.30.

### 2. Preparation of Antimonic Acid:

111 g of antimony trioxide (KN as manufactured by Sumitomo Metal Smelting Co., Ltd., purity: 98.5% by weight) was suspended in a solution having 57 g of potassium hydroxide (manufactured by Asahi Glass Co., Ltd., purity: 85% by weight) dissolved in 1,800 g of pure water. This suspension was heated at 95° C., to which was then added an aqueous solution having 32.8 g of aqueous hydrogen peroxide (manufactured by Hayashi Pure Chemical Ind., Ltd., special grade, purity: 35% by weight) diluted with 110.7 g of pure water at a rate of 0.1 moles/hr over 9 hours, thereby dissolving the antimony trioxide therein, followed by ripening for 11 hours. After cooling, 1,000 g of the resulting solution was taken and diluted with 6,000 g of pure water, and then passed through a cation exchange resin (pk-216, manufactured by Mitsubishi Chemical Corporation) to achieve a deionization treatment. At this time, a pH was 2.1, and a conductivity was 2.4 mS/cm.

### 3. Preparation of Antimony Oxide-Coated Silica Based Fine Particle (P1):

40 g of antimonic acid having a solids concentration of 1% by weight was added in 400 g of a dispersion resulting from diluting the thus prepared dispersion of silica based fine particle (A-1) into a solids concentration of 1% by weight, and the mixture was stirred at 70° C. for 10 hours and concentrated through an ultrafiltration membrane, thereby preparing a dispersion of antimony oxide-coated silica based fine particle (B-1) having a solids concentration of 20% by weight.

300 g of pure water and 400 g of methanol were added in 100 g of this dispersion of antimony oxide-coated silica based fine particle (B-1), with which was then mixed 3.57 g of ethyl orthosilicate (SiO₂ concentration: 28% by weight), and the mixture was stirred under heating at 50° C. for 15 hours, thereby preparing a dispersion of antimony oxide-coated silica fine particle (C-1) having a silica-coated layer formed therein.

By using an ultrafiltration membrane, this dispersion was subjected to solvent displacement with methanol and concentrated to a solids concentration of 20% by weight. Next, the concentrate was subjected to solvent displacement with isopropyl alcohol by a rotary evaporator, thereby preparing an isopropyl alcohol dispersion of silica based fine particle (C-1) having a concentration of 20% by weight.

Next, 0.73 g of a methacrylic silane coupling agent (KBM-503, manufactured by Shin-Etsu Chemical Co., Ltd.) was added in 100 g of this isopropyl alcohol dispersion of antimony oxide-coated silica based fine particle (C-1) having a silica-coated layer formed therein, and the mixture was stirred under heating at 50° C. for 15 hours, thereby preparing a dispersion of antimony oxide-coated silica based fine particle (P1) having a silica-coated layer formed therein whose surface had been treated with the silane coupling agent. This particle had a refractive index of 1.41, a volume resistivity value of 1,500 Ω/cm, an average particle size of 61 nm, and a thickness of an antimony oxide-coated layer of 1 nm.

### [Preparation of Antimony Oxide-Coated Silica Based Fine Particle (P2)]

A dispersion of surface-treated antimony oxide-coated silica based fine particle (P2) was prepared in the same manner as in the preparation of the foregoing antimony oxide-coated silica based fine particle (P1), except for changing the amount of the antimonic acid having a solids concentration of 1% by weight to 100 g. This particle had a refractive index of 1.46, a volume resistivity value of 1,100 Ω/cm, an average particle size of 61.5 nm, and a thickness of an antimony oxide-coated layer of 1.5 nm.

### [Preparation of Coating Solution (HCL-1) for Hard Coat Layer]

To 50.0 parts of “PETA” (manufactured by Nippon Kayaku Co., Ltd.) which is a mixture of pentaerythritol triacrylate and pentaerythritol tetraacrylate, 2.0 parts of a polymerization initiator “IRGACURE 184” (manufactured by Nihon Ciba-Geigy K.K.), 0.06 parts of a surface property improving agent {Illustrative Compound (F-63)}, 10.0 parts of an organosilane compound “KBM5103” (manufactured by Shin-Etsu Chemical Co., Ltd.), and 38.5 parts of toluene were added and stirred. A coating film as obtained by coating and hardening this solution with ultraviolet rays had a refractive index of 1.51.

In addition, to this solution, 1.7 parts of a 30% toluene solution of a crosslinked polystyrene particle “SX-350” (refractive index: 1.60, manufactured by Soken Chemical & Engineering Co., Ltd.) having an average particle size of 3.5 μm, which had been dispersed at 10,000 rpm by a POLYTRON dispersing machine and 13.3 parts of a 30% toluene dispersion of a crosslinked acryl-styrene particle (refractive index: 1.55, manufactured by Soken Chemical & Engineering Co., Ltd.) having an average particle size of 3.5 μm, which had been dispersed at 10,000 rpm by a POLYTRON dispersing machine were added and stirred. Next, the mixture was filtered by a polypropylene-made filter having a pore size of 30 μm, thereby preparing a coating solution (HCL-1) for antiglare hard coat layer. A coating film obtainable from this coating solution had a refractive index of 1.51. The coating solution (HCL-1) for antiglare hard coat layer had a surface tension of 32 mN/m.

### [Preparation of Coating Solution (LL-1) for Low Refractive Index Layer]

124 parts of “DPHA” (manufactured by Nippon Kayaku Co., Ltd.) (solids concentration: 29%) which is a mixture of dipentaerythritol pentaacrylate and dipentaerythritol hexaacrylate, 120 parts of the dispersion of antimony oxide-coated silica based fine particle (P1) (solids concentration: 20%), and 2 parts of a photo radical generator “IRGACURE 970” (manufactured by Ciba Specialty Chemicals) were dissolved in 200 parts of methyl ethyl ketone. The solution was diluted with cyclohexanone and methyl ethyl ketone such that the solids concentration of the whole of coating solution was 6% and that a ratio of cyclohexanone to methyl ethyl ketone was 20/80, thereby preparing a coating solution (LL-1) for low refractive index layer.

### [Preparation of Antireflection Film (1)]

### [Preparation of Hard Coat Layer (HC-1)]

The coating solution (HCL-1) for hard coat layer was coated on a triacetyl cellulose film “TAC-TD80U” (manufactured by Fuji Photo Film Co., Ltd.) having a thickness of 80 μm and a width of 1,340 mm by a microgravure coating system under a condition at a conveyance rate of 30 m/min. After drying at 60° C. for 150 seconds, the coating layer was hardened upon irradiation with ultraviolet rays having a radiation illuminance of 400 mW/cm² and an irradiation dose of 150 mJ/cm² by using an air-cooled metal halide lamp (manufactured by Eyegraphics Co., Ltd.) of 160 W/cm while purging with nitrogen (oxygen concentration: not more than 0.5% by volume), thereby preparing an antiglare hard coat layer having a thickness of 5.5 μm. There was thus obtained a hard coat layer (HC-1).

### [Formation of Low Refractive Index Layer (LL1-1)]

By using the foregoing coating solution (LL-1) for low refractive index layer, a low refractive index layer (LL1-1) was formed on the thus obtained hard coat layer (HC-1) by a microgravure coating system so as to adjust a thickness of the low refractive index layer at 95 nm, thereby preparing an antireflection film sample.

The hardening condition is shown below.

(1) Drying: 80° C. for 120 seconds
(2) Heat treatment before irradiation: 95° C. for 5 minutes
(3) UV hardening: 90° C. for one minute

The hardening was carried out by irradiating ultraviolet rays having a radiation illuminance of 120 mW/cm² and an irradiation dose of 240 mJ/cm² by using an air-cooled metal halide lamp (manufactured by Eyegraphics Co., Ltd.) of 240 W/cm while purging with nitrogen in an atmosphere such that an oxygen concentration was not more than 0.01% by volume.

(4) Heat treatment after irradiation: 30° C. for 5 minutes

### [Saponification Treatment of Antireflection Film]

The thus obtained antireflection film sample was subjected to the following saponification treatment.

A sodium hydroxide aqueous solution of 1.5 moles/L was prepared and kept at a temperature of 55° C. A dilute hydrochloric acid aqueous solution of 0.005 moles/L was prepared and kept at a temperature of 35° C.

The prepared antireflection film was dipped in the foregoing sodium hydroxide aqueous solution for 2 minutes and then dipped in water, thereby thoroughly washing away the sodium hydroxide aqueous solution. Next, after dipping in the foregoing dilute hydrochloric acid aqueous solution for one minute, the sample was dipped in water, thereby thoroughly washing away the dilute hydrochloric acid aqueous solution. Finally, the sample was thoroughly dried at 120° C. There was thus prepared a saponification treated antireflection film (1).

### Examples 2 to 56 and Comparative Examples 1 to 28

### Preparation of Coating Solutions (LL-2) to (LL-84) for Low Refractive Index Layer

Coating solutions (LL-2) to (LL-84) for low refractive index layer were prepared in the same manner as in the preparation of (LL-1), except that in the foregoing coating solution (LL-1) for low refractive index layer, the composition was changed as shown in the following Tables 14-1 to 14-4.

TABLE 14-1

| Components of | | | | | | | | | |
|---|---|---|---|---|---|---|---|---|---|
| coating solution for | | | | | | | | | |
| low refractive index | Solids | | | | | | | | |
| layer | concentration | LL-1 | LL-2 | LL-3 | LL-4 | LL-5 | LL-6 | LL-7 | LL-8 |
| P-3A | 100.0% | | | | | | | | |
| P-3 | 100.0% | | | | | | | | |
| PP-5 | 100.0% | | | | | | | | |
| DPHA | 29.0% | 1.24 | 1.24 | 1.24 | 0.93 | 0.93 | 0.93 | 1.18 | 1.18 |
| Antimony | 20.0% | 1.20 | | | 1.20 | | | 1.20 | |
| oxide-coated silica | | | | | | | | | |
| P1 | | | | | | | | | |
| Antimony | 20.0% | | 1.20 | | | 1.20 | | | 1.20 |
| oxide-coated silica | | | | | | | | | |
| P2 | | | | | | | | | |
| MEK-ST-L | 30.0% | | | 0.80 | | | 0.80 | | |
| RMS-33 | 100.0% | | | | | | | 0.02 | 0.02 |
| MEK | | 5.66 | 5.66 | 6.06 | 5.67 | 5.67 | 6.07 | 5.71 | 5.71 |
| Cyclohexanone | | 1.88 | 1.88 | 1.88 | 1.88 | 1.88 | 1.88 | 1.88 | 1.88 |
| Sol solution a | 29.1% | | | | 0.31 | 0.31 | 0.31 | | |
| IRGACURE 907 | 100.0% | 0.02 | 0.02 | 0.02 | 0.01 | 0.01 | 0.01 | 0.02 | 0.02 |
| Components of | | | | | | | | | |
| coating solution for | | | | | | | | | |
| low refractive index | Solids | | | | | | | | |
| layer | concentration | LL-9 | LL-10 | LL-11 | LL-12 | LL-13 | LL-14 | LL-15 | LL-16 |
| P-3A | 100.0% | | | | | 0.36 | 0.36 | 0.36 | 0.27 |
| P-3 | 100.0% | | | | | | | | |
| PP-5 | 100.0% | | | | | | | | |
| DPHA | 29.0% | 1.18 | 0.87 | 0.87 | 0.87 | | | | |
| Antimony | 20.0% | | 1.20 | | | 1.20 | | | 1.20 |
| oxide-coated silica | | | | | | | | | |
| P1 | | | | | | | | | |
| Antimony | 20.0% | | | 1.20 | | | 1.20 | | |
| oxide-coated silica | | | | | | | | | |
| P2 | | | | | | | | | |
| MEK-ST-L | 30.0% | 0.80 | | | 0.80 | | | 0.80 | |
| RMS-33 | 100.0% | 0.02 | 0.02 | 0.02 | 0.02 | | | | |
| MEK | | 6.11 | 5.71 | 5.71 | 6.11 | 6.54 | 6.54 | 6.94 | 6.33 |
| Cyclohexanone | | 1.88 | 1.88 | 1.88 | 1.88 | 1.88 | 1.88 | 1.88 | 1.88 |
| Sol solution a | 29.1% | | 0.31 | 0.31 | 0.31 | | | | 0.31 |
| IRGACURE 907 | 100.0% | 0.02 | 0.01 | 0.01 | 0.01 | 0.02 | 0.02 | 0.02 | 0.01 |
| Components of | | | | | | | | | |
| coating solution for | | | | | | | | | |
| low refractive index | Solids | | | | | | | | |
| layer | concentration | LL-17 | LL-18 | LL-19 | LL-20 | LL-21 | LL-22 | LL-23 | LL-24 |
| P-3A | 100.0% | 0.27 | 0.27 | 0.29 | 0.29 | 0.29 | 0.22 | 0.22 | 0.22 |
| P-3 | 100.0% | | | | | | | | |
| PP-5 | 100.0% | | | | | | | | |
| DPHA | 29.0% | | | 0.25 | 0.25 | 0.25 | 0.19 | 0.19 | 0.19 |
| Antimony | 20.0% | | | 1.20 | | | 1.20 | | |
| oxide-coated silica | | | | | | | | | |
| P1 | | | | | | | | | |
| Antimony | 20.0% | 1.20 | | | 1.20 | | | 1.20 | |
| oxide-coated silica | | | | | | | | | |
| P2 | | | | | | | | | |
| MEK-ST-L | 30.0% | | 0.80 | | | 0.80 | | | 0.80 |
| RMS-33 | 100.0% | | | | | | | | |
| MEK | | 6.33 | 6.73 | 6.37 | 6.37 | 6.77 | 6.20 | 6.20 | 6.60 |
| Cyclohexanone | | 1.88 | 1.88 | 1.88 | 1.88 | 1.88 | 1.88 | 1.88 | 1.88 |
| Sol solution a | 29.1% | 0.31 | 0.31 | | | | 0.31 | 0.31 | 0.31 |
| IRGACURE 907 | 100.0% | 0/01 | 0.01 | 0.02 | 0.02 | 0.02 | 0.01 | 0.01 | 0.01 |

*: The unit of the numerals in the table is “part”.

TABLE 14-2

| Components of | | | | | | | | | |
|---|---|---|---|---|---|---|---|---|---|
| coating solution for | | | | | | | | | |
| low refractive index | Solids | | | | | | | | |
| layer | concentration | LL-25 | LL-26 | LL-27 | LL-28 | LL-29 | LL-30 | LL-31 | LL-32 |
| P-3A | 100.0% | 0.34 | 0.34 | 0.34 | 0.31 | 0.31 | 0.31 | 0.25 | 0.25 |
| P-3 | 100.0% | | | | | | | | |
| PP-5 | 100.0% | | | | | | | | |
| DPHA | 29.0% | | | | | | | | |
| Antimony | 20.0% | 1.20 | | | 0.90 | | | 1.20 | |
| oxide-coated silica | | | | | | | | | |
| P1 | | | | | | | | | |
| Antimony | 20.0% | | 1.20 | | | 0.90 | | | 1.20 |
| oxide-coated silica | | | | | | | | | |
| P2 | | | | | | | | | |
| MEK-ST-L | 30.0% | | | 0.80 | | | 0.80 | | |
| RMS-33 | 100.0% | 0.02 | 0.02 | 0.02 | 0.02 | 0.02 | 0.02 | 0.02 | 0.02 |
| MEK | | 6.54 | 6.54 | 6.94 | 6.57 | 6.57 | 6.87 | 6.33 | 6.33 |
| Cyclohexanone | | 1.88 | 1.88 | 1.88 | 1.88 | 1.88 | 1.88 | 1.88 | 1.88 |
| Sol solution a | 29.1% | | | | 0.31 | 0.31 | 0.31 | 0.31 | 0.31 |
| IRGACURE 907 | 100.0% | 0.02 | 0.02 | 0.02 | 0.02 | 0.02 | 0.02 | 0.01 | 0.01 |
| Components of | | | | | | | | | |
| coating solution for | | | | | | | | | |
| low refractive index | Solids | | | | | | | | |
| layer | concentration | LL-33 | LL-34 | LL-35 | LL-36 | LL-37 | LL-38 | LL-39 | LL-40 |
| P-3A | 100.0% | 0.25 | 0.19 | 0.19 | 0.19 | 0.27 | 0.27 | 0.27 | 0.25 |
| P-3 | 100.0% | | | | | | | | |
| PP-5 | 100.0% | | | | | | | | |
| DPHA | 29.0% | | | | | 0.24 | 0.24 | 0.24 | 0.22 |
| Antimony | 20.0% | | 1.50 | | | 1.20 | | | 090 |
| oxide-coated silica | | | | | | | | | |
| P1 | | | | | | | | | |
| Antimony | 20.0% | | | 1.50 | | | 1.20 | | |
| oxide-coated silica | | | | | | | | | |
| P2 | | | | | | | | | |
| MEK-ST-L | 30.0% | 0.80 | | | 1.00 | | | 0.80 | |
| RMS-33 | 100.0% | 0.02 | 0.02 | 0.02 | 0.02 | 0.02 | 0.02 | 0.02 | 0.02 |
| MEK | | 6.73 | 6.09 | 6.09 | 6.59 | 6.38 | 6.38 | 6.78 | 6.41 |
| Cyclohexanone | | 1.88 | 1.88 | 1.88 | 1.88 | 1.88 | 1.88 | 1.88 | 1.88 |
| Sol solution a | 29.1% | 0.31 | 0.31 | 0.31 | 0.31 | | | | 0.31 |
| IRGACURE 907 | 100.0% | 0.01 | 0.01 | 0.01 | 0.01 | 0.02 | 0.02 | 0.02 | 0.02 |
| Components of | | | | | | | | | |
| coating solution for | | | | | | | | | |
| low refractive index | Solids | | | | | | | | |
| layer | concentration | LL-41 | LL-42 | LL-43 | LL-44 | LL-45 | LL-46 | LL-47 | LL-48 |
| P-3A | 100.0% | 0.25 | 0.25 | 0.20 | 0.20 | 0.20 | 0.15 | 0.15 | 0.15 |
| P-3 | 100.0% | | | | | | | | |
| PP-5 | 100.0% | | | | | | | | |
| DPHA | 29.0% | 0.22 | 0.22 | 0.17 | 0.17 | 0.17 | 0.13 | 0.13 | 0.13 |
| Antimony | 20.0% | | | 1.20 | | | 1.20 | | |
| oxide-coated silica | | | | | | | | | |
| P1 | | | | | | | | | |
| Antimony | 20.0% | 0.90 | | | 1.20 | | | 1.50 | |
| oxide-coated silica | | | | | | | | | |
| P2 | | | | | | | | | |
| MEK-ST-L | 30.0% | | 0.60 | | | 0.80 | | | 1.00 |
| RMS-33 | 100.0% | 0.02 | 0.02 | 0.02 | 0.02 | 0.02 | 0.02 | 0.02 | 0.02 |
| MEK | | 6.41 | 6.71 | 6.20 | 6.20 | 6.60 | 6.00 | 6.00 | 6.50 |
| Cyclohexanone | | 1.88 | 1.88 | 1.88 | 1.88 | 1.88 | 1.88 | 1.88 | 1.88 |
| Sol solution a | 29.1% | 0.31 | 0.31 | 0.31 | 0.31 | 0.31 | 0.31 | 0.31 | 0.31 |
| IRGACURE 907 | 100.0% | 0.02 | 0.02 | 0.01 | 0.01 | 0.01 | 0.01 | 0.01 | 0.01 |

*: The unit of the numerals in the table is “part”.

TABLE 14-3

| Components of | | | | | | | | | | |
|---|---|---|---|---|---|---|---|---|---|---|
| coating solution for | | | | | | | | | | |
| low refractive index | Solids | | | | | | | | | |
| layer | concentration | LL-49 | LL-50 | LL-51 | LL-52 | L-53 | LL-54 | LL-55 | L-56 | LL-57 |
| P-3A | 100.0% | | | | | | | | | |
| P-3 | 100.0% | 0.36 | 0.36 | 0.36 | 0.27 | 0.27 | 0.27 | 0.29 | 0.29 | 0.29 |
| PP-5 | 100.0% | | | | | | | | | |
| DPHA | 29.0% | | | | | | | 0.25 | 0.25 | 0.25 |
| Antimony | 20.0% | 1.20 | | | 1.20 | | | 1.20 | | |
| oxide-coated silica | | | | | | | | | | |
| P1 | | | | | | | | | | |
| Antimony | 20.0% | | 1.20 | | | 1.20 | | | 1.20 | |
| oxide-coated silica | | | | | | | | | | |
| P2 | | | | | | | | | | |
| MEK-ST-L | 30.0% | | | 0.80 | | | 0.80 | | | 0.80 |
| RMS-33 | 100.0% | | | | | | | | | |
| MEK | | 6.54 | 6.54 | 6.94 | 6.33 | 6.33 | 6.73 | 6.37 | 6.37 | 6.77 |
| Cyclohexanone | | 1.88 | 1.88 | 1.88 | 1.88 | 1.88 | 1.88 | 1.88 | 1.88 | 1.88 |
| Sol solution a | 29.1% | | | | 0.31 | 0.31 | 0.31 | | | |
| IRGACURE 907 | 100.0% | 0.02 | 0.02 | 0.02 | 0.01 | 0.01 | 0.01 | 0.02 | 0.02 | 0.02 |
| Components of | | | | | | | | | | |
| coating solution for | | | | | | | | | | |
| low refractive index | Solids | | | | | | | | | |
| layer | concentration | LL-58 | LL-59 | LL-60 | LL-61 | L-62 | LL-63 | LL-64 | L-65 | LL-66 |
| P-3A | 100.0% | | | | | | | | | |
| P-3 | 100.0% | 0.22 | 0.22 | 0.22 | | | | | | |
| PP-5 | 100.0% | | | | 0.36 | 0.36 | 0.36 | 0.33 | 0.33 | 0.33 |
| DPHA | 29.0% | 0.19 | 0.19 | 0.19 | | | | | | |
| Antimony | 20.0% | 1.20 | | | 1.20 | | | 0.90 | | |
| oxide-coated silica | | | | | | | | | | |
| P1 | | | | | | | | | | |
| Antimony | 20.0% | | 1.20 | | | 1.20 | | | 0.90 | |
| oxide-coated silica | | | | | | | | | | |
| P2 | | | | | | | | | | |
| MEK-ST-L | 30.0% | | | 0.80 | | | 0.80 | | | 0.60 |
| RMS-33 | 100.0% | | | | | | | | | |
| MEK | | 6.20 | 6.20 | 6.60 | 6.54 | 6.54 | 6.94 | 6.58 | 6.56 | 6.86 |
| Cyclohexanone | | 1.88 | 1.88 | 1.88 | 1.88 | 1.88 | 1.88 | 1.88 | 1.88 | 1.88 |
| Sol solution a | 29.1% | 0.31 | 0.31 | 0.31 | | | | 0.31 | 0.31 | 0.31 |
| IRGACURE 907 | 100.0% | 0.01 | 0.01 | 0.01 | 0.02 | 0.02 | 0.02 | 0.02 | 0.02 | 0.02 |

*: The unit of the numerals in the table is “part”.

TABLE 14-4

| Components of | | | | | | | | | | |
|---|---|---|---|---|---|---|---|---|---|---|
| coating solution for | | | | | | | | | | |
| low refractive index | Solids | | | | | | | | | |
| layer | concentration | LL-67 | LL-68 | LL-69 | LL-70 | L-71 | LL-72 | LL-73 | L-74 | LL-75 |
| P-3A | 100.0% | | | | | | | | | |
| P-3 | 100.0% | | | | | | | | | |
| PP-5 | 100.0% | 0.27 | 0.27 | 0.27 | 0.21 | 0.21 | 0.21 | 0.29 | 0.29 | 0.29 |
| DPHA | 29.0% | | | | | | | 0.25 | 0.25 | 0.25 |
| Antimony | 20.0% | 1.20 | | | 1.50 | | | 1.20 | | |
| oxide-coated silica | | | | | | | | | | |
| P1 | | | | | | | | | | |
| Antimony | 20.0% | | 1.20 | | | 1.50 | | | 1.20 | |
| oxide-coated silica | | | | | | | | | | |
| P2 | | | | | | | | | | |
| MEK-ST-L | 30.0% | | | 0.80 | | | 1.00 | | | 0.80 |
| RMS-33 | 100.0% | | | | | | | | | |
| MEK | | 6.33 | 6.33 | 6.73 | 6.09 | 6.09 | 6.59 | 6.37 | 6.37 | 6.77 |
| Cyclohexanone | | 1.88 | 1.88 | 1.88 | 1.88 | 1.88 | 1.88 | 1.88 | 1.88 | 1.88 |
| Sol solution a | 29.1% | 0.31 | 0.31 | 0.31 | 0.31 | 0.31 | 0.31 | | | |
| IRGACURE 907 | 100.0% | 0.01 | 0.01 | 0.01 | 0.01 | 0.01 | 0.01 | 0.02 | 0.02 | 0.02 |
| Components of | | | | | | | | | | |
| coating solution for | | | | | | | | | | |
| low refractive index | Solids | | | | | | | | | |
| layer | concentration | LL-76 | LL-77 | LL-78 | LL-79 | L-80 | LL-81 | LL-82 | L-83 | LL-84 |
| P-3A | 100.0% | | | | | | | | | |
| P-3 | 100.0% | | | | | | | | | |
| PP-5 | 100.0% | 0.26 | 0.26 | 0.26 | 0.22 | 0.22 | 0.22 | 0.17 | 0.17 | 0.17 |
| DPHA | 29.0% | 0.23 | 0.23 | 0.23 | 0.19 | 0.19 | 0.19 | 0.14 | 0.14 | 0.14 |
| Antimony | 20.0% | 0.90 | | | 1.20 | | | 1.50 | | |
| oxide-coated silica | | | | | | | | | | |
| P1 | | | | | | | | | | |
| Antimony | 20.0% | | 0.90 | | | 1.20 | | | 1.50 | |
| oxide-coated silica | | | | | | | | | | |
| P2 | | | | | | | | | | |
| MEK-ST-L | 30.0% | | | 0.60 | | | 0.80 | | | 1.00 |
| RMS-33 | 100.0% | | | | | | | | | |
| MEK | | 6.40 | 6.40 | 9.70 | 6.20 | 6.20 | 6.60 | 5.99 | 5.99 | 6.49 |
| Cyclohexanone | | 1.88 | 1.88 | 1.88 | 1.88 | 1.88 | 1.88 | 1.88 | 1.88 | 1.88 |
| Sol solution a | 29.1% | 0.31 | 0.31 | 0.31 | 0.31 | 0.31 | 0.31 | 0.31 | 0.31 | 0.31 |
| IRGACURE 907 | 100.0% | 0.02 | 0.02 | 0.02 | 0.01 | 0.01 | 0.01 | 0.01 | 0.01 | 0.01 |

*: The unit of the numerals in the table is “part”.

The contents of the compounds as used in Tables 14-1 to 14-4 will be shown below. Furthermore, all parts in the tables represent a part by weight of the solid.

(A) Ionizing Radiation Hardenable Compound:

Fluorine-containing siloxane polymer (which may also be used as (C)):

P-3: Illustrative Compound P-3 of the invention

PP-5: Illustrative Compound PP-5 of the invention

P-3A: Compound having a structure not containing a silicone segment with respect to Illustrative Compound P-3 of the invention

DPHA: Photopolymerizable compound “DPHA” (manufactured by Nippon Kayaku Co., Ltd.) which is a mixture of pentaerythritol triacrylate and pentaerythritol tetraacrylate

(C) Compound Having a Polysiloxane Partial Structure Represented by the Formula (1):

### Photopolymerizable Silicone:

RMS-33: “RMS-33”, manufactured by Gelest

Photopolymerization Initiator:

IRGACURE 907: “IRGACURE 907”, manufactured by Ciba Speciality

Chemicals, molecular weight: 279

(B) Fine particle having a conductive metal oxide-coated layer:

P1 and P2: Silica based fine particle having the foregoing antimony oxide-coated layer

Other Fine Particles:

MEK-ST-L: “MEK-ST-L”, which is a dispersion of silica fine particle as manufactured by Nissan Chemical Industries, Ltd., solvent: MEK, average particle size: 45 nm

[Preparation of Sol Solution a]

In a reactor equipped with a stirrer and a reflux condenser, 120 parts of methyl ethyl ketone, 100 parts of acryloyloxypropyltrimethoxysilane “KBM 5103” (manufactured by Shin-Etsu Chemical Co., Ltd.), and 3 parts of diisopropoxyaluminum ethyl acetoacetate were charged and mixed, to which was then added 30 parts of ion exchanged water, and the mixture was reacted at 60° C. for 4 hours, followed by cooling to room temperature to obtain a sol solution a. A weight average molecular weight was 1,600, and among components of oligomer and polymer components, a proportion of components having a molecular weight of from 1,000 to 20,000 was 100%. Furthermore, a gas chromatographic analysis revealed that the starting acryloyloxypropyltrimethoxysilane did not remain at all. The solids concentration was adjusted at 29% by using methyl ethyl ketone, thereby preparing a sol solution a.

### [Preparation of Antireflection Films (2) to (84)]

On a hard coat layer (HC-1) as obtained in the same manner as in Example 1, each of the foregoing coating solutions (LL-2) to (LL-84) for low refractive index layer was coated and hardened under the same condition as in the antireflection film sample (1) of Example 1, thereby forming low refractive index layers (LL1-2) to (LL1-84). Next, each of the low refractive index layers (LL1-2) to (LL1-84) was subjected to a saponification treatment in the same manner as in Example 1, thereby preparing antireflection film samples (2) to (84).

### [Evaluation of Antireflection Film]

Each of the thus obtained films was evaluated in the following manners.

### (Evaluation 1) Mirror Reflectance:

With respect to the measurement of mirror reflectance, by using a spectrophotometer “V-550” (manufactured by JASCO Corporation) having an adaptor “ARV-474” installed therein, a mirror reflectance at each of an incident angle of 5° and an outgoing angle of −5 is measured in a wavelength region of from 380 to 780 nm, and an average reflectance at from 450 to 650 nm is calculated, thereby evaluating anti-reflection properties.

### (Evaluation 2) Marker Ink Wiping Properties:

A film is fixed on a glass surface by an adhesive; a circle of a diameter of 5 mm is written in three times by a pen tip (fine) of a black marking pen “McKee Ultra-fine (a trade name of Zebra Co., Ltd.)” under a condition at 25° C. and 60 RH %; and after 5 seconds, wiping is carried out 20 reciprocations by a bundle of ten-ply folded BEMCOT (a trade name of Asahi Kasei Corporation) under a load to an extent that the BEMCOT bundle is indented. By repeating the foregoing writing and wiping under the foregoing condition until the marker ink mark does not disappear by wiping, it is possible to evaluate antifouling properties in terms of the number of wiping at which wiping is possible. The number of wiping at which wiping is possible was evaluated with its upper limit being 50 times.

The number of wiping until the marker ink mark does not disappear is preferably 5 or more, more preferably 10 or more, and most preferably 50 or more.

### (Evaluation 3) Evaluation of Scar Resistance:

By using a rubbing tester, a rubbing test was carried out under the following condition.

Evaluation circumstance condition: 25° C., 60% RH

Rubbing material: A steel wool (manufactured by Nippon Steel Wool Co., Ltd., No. 0000) was wound around a tip part (1 cm×1 cm) of the tester coming into contact with a sample and fixed by a band. Then, a reciprocal rubbing movement was given under the following condition.

Movement distance (one way): 13 cm

Rubbing rate: 13 cm/sec

Load: 500 g/cm² and 200 g/cm²

Contact area of tip part: 1 cm×1 cm

Number of rubbing: 10 reciprocations

An oily black ink was applied in the rear side of the rubbed sample, and a scar of the rubbed portion was evaluated by visual observation by reflected light according to the following criteria.

A: Even by very careful observation, a scar is not observed at all.

AB: By every careful observation, a weak scar is slightly observed.

B: A weak scar is observed.

BC: A scar is observed to a medium extent.

C: A scar is observed at the first glance.

### (Evaluation 4) Evaluation of Adhesiveness:

The antireflection film sample was subjected to humidity control under a condition at a temperature of 25° C. and a relative humidity of 60%. In each of the samples, the surface in a side at which the low refractive index layer was present was subjected to cross-cutting with 11 lines in length and 11 lines in width by using a cutter knife, thereby providing 100 squares in total; a polyester pressure sensitive adhesive tape (No. 31B) manufactured by Nitto Denko Corporation was stuck thereonto; after elapsing 30 minutes, the tape was quickly peeled away in a vertical direction; the number of peeled squares was counted; and the evaluation was carried out according to the following criteria of four grades. The same adhesiveness evaluation was repeated thrice, and an average value thereof was taken.

A: Peeling was not observed at all in the 100 squares.

B: Peeling was observed in one or two squares of the 100 squares.

C: Peeling was observed in three to ten squares of the 100 squares (within a tolerable range).

D: Peeling was observed in eleven or more squares of the 100 squares.

### (Evaluation 5) Surface Resistivity Value:

A surface resistivity of the surface of the antireflection film in the side having a low refractive index layer (outermost layer) was measured under a condition at 25° C. and a relative humidity of 60% by using a megger/micro ammeter “TR8601” (manufactured by Advantest Corporation).

The layer configuration of each of the antireflection film samples (1) to (84) and evaluation results are shown in Tables 15-1 to 15-2. (With respect to the numerical values in Tables 15-1 to 15-2, for example, “3.10E+09” expresses “3.1×10⁹”.)

TABLE 15-1

| | | Mirror | Marker ink | | | Surface |
|---|---|---|---|---|---|---|
| | | reflectance | wiping | Evaluation of | Evaluation of | resistivity |
| | | (R) | properties | scar resistance | adhesiveness | (Ω/) |
| Antireflection film sample | Example 1 | 1.91 | 6 | A | B | 3.10E+09 |
| (1) | | | | | | |
| Antireflection film sample | Example 2 | 1.97 | 6 | A | B | 2.20E+09 |
| (2) | | | | | | |
| Antireflection film sample | Com. Example 1 | 1.97 | 4 | AB | C | 2.90E+14 |
| (3) | | | | | | |
| Antireflection film sample | Example 3 | 1.91 | 12 | A | B | 3.10E+09 |
| (4) | | | | | | |
| Antireflection film sample | Example 4 | 1.97 | 11 | A | B | 2.20E+09 |
| (5) | | | | | | |
| Antireflection film sample | Com. Example 2 | 1.97 | 8 | AB | C | 2.90E+14 |
| (6) | | | | | | |
| Antireflection film sample | Example 5 | 1.91 | 10 | A | B | 3.10E+09 |
| (7) | | | | | | |
| Antireflection film sample | Example 6 | 1.97 | 10 | A | B | 2.20E+09 |
| (8) | | | | | | |
| Antireflection film sample | Com. Example 3 | 1.97 | 7 | AB | C | 2.90E+14 |
| (9) | | | | | | |
| Antireflection film sample | Example 7 | 1.91 | 20 | A | B | 3.10E+09 |
| (10) | | | | | | |
| Antireflection film sample | Example 8 | 1.97 | 16 | A | A | 2.20E+09 |
| (11) | | | | | | |
| Antireflection film sample | Com. Example 4 | 1.97 | 9 | AB | C | 2.90E+14 |
| (12) | | | | | | |
| Antireflection film sample | Example 9 | 1.77 | 6 | A | B | 3.10E+09 |
| (13) | | | | | | |
| Antireflection film sample | Example 10 | 1.80 | 5 | A | B | 2.20E+09 |
| (14) | | | | | | |
| Antireflection film sample | Com. Example 5 | 1.83 | 3 | B | C | 2.90E+14 |
| (15) | | | | | | |
| Antireflection film sample | Example 11 | 1.77 | 9 | A | B | 3.10E+09 |
| (16) | | | | | | |
| Antireflection film sample | Example 12 | 1.80 | 7 | A | B | 2.20E+09 |
| (17) | | | | | | |
| Antireflection film sample | Com. Example 6 | 1.83 | 4 | AB | C | 2.90E+14 |
| (18) | | | | | | |
| Antireflection film sample | Example 13 | 1.77 | 6 | A | B | 3.10E+09 |
| (19) | | | | | | |
| Antireflection film sample | Example 14 | 1.80 | 6 | A | B | 2.20E+09 |
| (20) | | | | | | |
| Antireflection film sample | Com. Example 7 | 1.83 | 4 | AB | C | 2.90E+14 |
| (21) | | | | | | |
| Antireflection film sample | Example 15 | 1.77 | 9 | A | B | 3.10E+09 |
| (22) | | | | | | |
| Antireflection film sample | Example 16 | 1.80 | 9 | A | A | 2.20E+09 |
| (23) | | | | | | |
| Antireflection film sample | Com. Example 8 | 1.83 | 7 | AB | C | 2.90E+14 |
| (24) | | | | | | |
| Antireflection film sample | Example 17 | 1.77 | 22 | A | B | 3.10E+09 |
| (25) | | | | | | |
| Antireflection film sample | Example 18 | 1.80 | 13 | A | A | 2.20E+09 |
| (26) | | | | | | |
| Antireflection film sample | Com. Example 9 | 1.83 | 8 | B | C | 2.90E+14 |
| (27) | | | | | | |
| Antireflection film sample | Example 19 | 1.77 | 23 | A | B | 3.10E+09 |
| (28) | | | | | | |
| Antireflection film sample | Example 20 | 1.80 | 18 | A | B | 2.20E+09 |
| (29) | | | | | | |
| Antireflection film sample | Com. Example | 1.83 | 11 | AB | C | 2.90E+14 |
| (30) | 10 | | | | | |
| Antireflection film sample | Example 21 | 1.77 | 23 | A | A | 3.10E+09 |
| (31) | | | | | | |
| Antireflection film sample | Example 22 | 1.80 | 17 | A | A | 2.20E+09 |
| (32) | | | | | | |
| Antireflection film sample | Com. Example | 1.83 | 8 | AB | C | 2.90E+14 |
| (33) | 11 | | | | | |
| Antireflection film sample | Example 23 | 1.77 | 20 | A | B | 3.10E+09 |
| (34) | | | | | | |
| Antireflection film sample | Example 24 | 1.80 | 14 | A | B | 2.20E+09 |
| (35) | | | | | | |
| Antireflection film sample | Com. Example | 1.83 | 9 | AB | C | 2.90E+14 |
| (36) | 12 | | | | | |
| Antireflection film sample | Example 25 | 1.77 | 20 | A | B | 3.10E+09 |
| (37) | | | | | | |
| Antireflection film sample | Example 26 | 1.80 | 12 | A | B | 2.20E+09 |
| (38) | | | | | | |
| Antireflection film sample | Com. Example | 1.83 | 8 | AB | C | 2.90E+14 |
| (39) | 13 | | | | | |
| Antireflection film sample | Example 27 | 1.77 | 22 | A | B | 3.10E+09 |
| (40) | | | | | | |
| Antireflection film sample | Example 28 | 1.80 | 18 | A | B | 2.20E+09 |
| (41) | | | | | | |
| Antireflection film sample | Com. Example | 1.83 | 10 | AB | C | 2.90E+14 |
| (42) | 14 | | | | | |

TABLE 15-2

| | | Mirror | Marker ink | | | Surface |
|---|---|---|---|---|---|---|
| | | reflectance | wiping | Evaluation of | Evaluation of | resistivity |
| | | (R) | properties | scar resistance | adhesiveness | (Ω/) |
| Antireflection film sample | Example 29 | 1.77 | 27 | A | A | 3.10E+09 |
| (43) | | | | | | |
| Antireflection film sample | Example 30 | 1.80 | 20 | A | A | 2.20E+09 |
| (44) | | | | | | |
| Antireflection film sample | Com. Example | 1.83 | 11 | AB | B | 2.90E+14 |
| (45) | 15 | | | | | |
| Antireflection film sample | Example 31 | 1.77 | 24 | A | B | 3.10E+09 |
| (46) | | | | | | |
| Antireflection film sample | Example 32 | 1.80 | 16 | A | B | 2.20E+09 |
| (47) | | | | | | |
| Antireflection film sample | Com. Example | 1.83 | 9 | AB | C | 2.90E+14 |
| (48) | 16 | | | | | |
| Antireflection film sample | Example 33 | 1.77 | 27 | A | B | 3.10E+09 |
| (49) | | | | | | |
| Antireflection film sample | Example 34 | 1.80 | 19 | A | B | 2.20E+09 |
| (50) | | | | | | |
| Antireflection film sample | Com. Example | 1.83 | 9 | B | C | 2.90E+14 |
| (51) | 17 | | | | | |
| Antireflection film sample | Example 35 | 1.77 | 27 | A | B | 3.10E+09 |
| (52) | | | | | | |
| Antireflection film sample | Example 36 | 1.80 | 19 | A | B | 2.20E+09 |
| (53) | | | | | | |
| Antireflection film sample | Com. Example | 1.83 | 9 | AB | C | 2.90E+14 |
| (54) | 18 | | | | | |
| Antireflection film sample | Example 37 | 1.77 | 23 | A | B | 3.10E+09 |
| (55) | | | | | | |
| Antireflection film sample | Example 38 | 1.80 | 17 | A | B | 2.20E+09 |
| (56) | | | | | | |
| Antireflection film sample | Com. Example | 1.83 | 8 | AB | C | 2.90E+14 |
| (57) | 19 | | | | | |
| Antireflection film sample | Example 39 | 1.77 | 22 | A | B | 3.10E+09 |
| (58) | | | | | | |
| Antireflection film sample | Example 40 | 1.80 | 17 | A | A | 2.20E+09 |
| (59) | | | | | | |
| Antireflection film sample | Com. Example | 1.83 | 8 | AB | C | 2.90E+14 |
| (60) | 20 | | | | | |
| Antireflection film sample | Example 41 | 1.77 | 24 | A | B | 3.10E+09 |
| (61) | | | | | | |
| Antireflection film sample | Example 42 | 1.80 | 16 | A | B | 2.20E+09 |
| (62) | | | | | | |
| Antireflection film sample | Com. Example | 1.83 | 9 | B | C | 2.90E+14 |
| (63) | 21 | | | | | |
| Antireflection film sample | Example 43 | 1.77 | 29 | A | B | 3.10E+09 |
| (64) | | | | | | |
| Antireflection film sample | Example 44 | 1.80 | 21 | A | B | 2.20E+09 |
| (65) | | | | | | |
| Antireflection film sample | Com. Example | 1.83 | 10 | AB | C | 2.90E+14 |
| (66) | 22 | | | | | |
| Antireflection film sample | Example 45 | 1.77 | 23 | A | A | 3.10E+09 |
| (67) | | | | | | |
| Antireflection film sample | Example 46 | 1.80 | 14 | A | A | 2.20E+09 |
| (68) | | | | | | |
| Antireflection film sample | Com. Example | 1.83 | 9 | AB | C | 2.90E+14 |
| (69) | 23 | | | | | |
| Antireflection film sample | Example 47 | 1.77 | 25 | A | B | 3.10E+09 |
| (70) | | | | | | |
| Antireflection film sample | Example 48 | 1.80 | 20 | A | B | 2.20E+09 |
| (71) | | | | | | |
| Antireflection film sample | Com. Example | 1.83 | 8 | AB | C | 2.90E+14 |
| (72) | 24 | | | | | |
| Antireflection film sample | Example 49 | 1.77 | 27 | A | B | 3.10E+09 |
| (73) | | | | | | |
| Antireflection film sample | Example 50 | 1.80 | 18 | A | B | 2.20E+09 |
| (74) | | | | | | |
| Antireflection film sample | Com. Example | 1.83 | 9 | AB | C | 2.90E+14 |
| (75) | 25 | | | | | |
| Antireflection film sample | Example 51 | 1.77 | 21 | A | B | 3.10E+09 |
| (76) | | | | | | |
| Antireflection film sample | Example 52 | 1.80 | 19 | A | A | 2.20E+09 |
| (77) | | | | | | |
| Antireflection film sample | Com. Example | 1.83 | 8 | AB | C | 2.90E+14 |
| (78) | 26 | | | | | |
| Antireflection film sample | Example 53 | 1.77 | 26 | A | A | 3.10E+09 |
| (79) | | | | | | |
| Antireflection film sample | Example 54 | 1.80 | 20 | A | A | 2.20E+09 |
| (80) | | | | | | |
| Antireflection film sample | Com. Example | 1.83 | 10 | AB | C | 2.90E+14 |
| (81) | 27 | | | | | |
| Antireflection film sample | Example 55 | 1.77 | 25 | A | B | 3.10E+09 |
| (82) | | | | | | |
| Antireflection film sample | Example 56 | 1.80 | 19 | A | B | 2.20E+09 |
| (83) | | | | | | |
| Antireflection film sample | Com. Example | 1.83 | 9 | AB | C | 2.90E+14 |
| (84) | 28 | | | | | |

As a result of the foregoing evaluations of the obtained antireflection film samples (1) to (84), it is understood that the antireflection film having a low refractive index layer containing an antimony oxide-coated silica based fine particle is low in the surface resistivity value and low in the reflectance as compared with the antireflection film having a low refractive index layer containing an equivalent amount of silica. Also, it is understood that the antireflection film having a low refractive index layer containing an antimony oxide-coated silica based fine particle is excellent in the antifouling properties, adhesiveness and scar resistance.

### Example 57

### Preparation of Coating Solution (HCL-2) for Hard Coat Layer

100 parts by weight of DeSolite Z7404 (zirconia fine particle-containing hard coat composition solution, manufactured by JSR Corporation), 31 parts by weight of DPHA (UV hardenable resin, manufactured by Nippon Kayaku Co., Ltd.), 10 parts by weight of KBM-5103 (silane coupling agent, manufactured by Shin-Etsu Chemical Co., Ltd.), 8.9 parts by weight of KE-P150 (1.5-μm silica particle, manufactured by Nippon Shokubai Co., Ltd.), 3.4 parts by weight of MXS-300 (3-μm crosslinked PMMA particle, manufactured by Soken Chemical & Engineering Co., Ltd.), 29 parts by weight of MEK, and 13 parts by weight of MIBK were charged in a mixing tank and stirred to prepare a coating solution (HCL-2) for hard coat layer.

### [Preparation of Antireflection Film (201)]

As a support, a triacetyl cellulose film (TD80U, manufactured by Fuji Photo Film Co., Ltd.) was wound out in a rolled state; the foregoing coating solution (HCL-2) for hard coat layer was coated thereon by using a microgravure roll with a gravure pattern having 135 lines per inch and a depth of 60 μm and having a diameter of 50 mm and a doctor blade under a condition at a conveyance rate of 10 m/min; after drying at 60° C. for 150 seconds, the coating layer was further hardened upon irradiation with ultraviolet rays having a radiation illuminance of 400 mW/cm² and an irradiation dose of 250 mJ/cm² by using an air-cooled metal halide lamp (manufactured by Eyegraphics Co., Ltd.) of 160 W/cm under purging with nitrogen, thereby forming a hard coat layer (HC-2), followed by winding up. A hard coat layer (HC-2) was prepared by adjusting the revolution number of the gravure roll such that the hard coat layer after hardening had a thickness of 4.0 μm. The thus obtained hard coat layer (HC-2) had a surface roughness of a center line mean roughness (Ra)=0.02 μm, a square mean surface roughness (RMS)=0.03 μm and an n-point mean roughness (Rz)=0.25 μm. Incidentally, Ra, RMS and Rz were measured by a scanning probe microscope system “SPI3800”, manufactured by Seiko Instruments Inc.

By using the foregoing coating solution (LL-67) for low refractive index layer, a low refractive index layer (LL2-67) was formed on the thus obtained hard coat layer (HC-2) under the same condition as in the low refractive index layer (LL1-67), thereby preparing an antireflection sample (267).

### [Saponification Treatment of Antireflection Film]

The thus obtained antireflection film sample (267) was subjected to the following saponification treatment.

A sodium hydroxide aqueous solution of 1.5 moles/L was prepared and kept at a temperature of 55° C. A dilute hydrochloric acid aqueous solution of 0.005 moles/L was prepared and kept at a temperature of 35° C.

The prepared antireflection film sample (267) was dipped in the foregoing sodium hydroxide aqueous solution for 2 minutes and then dipped in water, thereby thoroughly washing away the sodium hydroxide aqueous solution. Next, after dipping in the foregoing dilute hydrochloric acid aqueous solution for one minute, the sample was dipped in water, thereby thoroughly washing away the dilute hydrochloric acid aqueous solution. Finally, the sample was thoroughly dried at 120° C. There was thus prepared a saponification treated antireflection film.

### [Preparation of Antireflection Film-Provided Polarizing Plate]

Iodine was adsorbed on a stretched polyvinyl alcohol film to prepare a polarizing film. The saponification treated antireflection film (267) was stuck to one side of the polarizing film by using a polyvinyl alcohol based adhesive such that the support (triacetyl cellulose) side of the antireflection film was faced at the polarizing film side. Furthermore, a viewing angle enlargement film having an optical anisotropic layer, “WIDE VIEW FILM SA” (manufactured by Fuji Photo Film Co., Ltd.), in which a disc plane of a discotic structural unit is inclined against a support plane and an angle formed by the disc plane of the discotic structural unit and the support plane varies in a depth direction of the optically anisotropic layer, was subjected to a saponification treatment and stuck to the other side of the polarizing film by using a polyvinyl alcohol based adhesive. There was thus prepared an antireflection film-provided polarizing plate (267P).

The obtained antireflection film-provided polarizing plate (267P) was evaluated in the same manner as described previously. As a result, it was understood that an antireflection film-provided polarizing plate of low reflection, which is excellent in the marker ink wiping properties and scar resistance was obtained.

### Example 58

### Preparation of Coating Solution (HCL-3) for Hard Coat Layer

10 parts of cyclohexanone, 85 parts of a partially caprolactone-modified polyfunctional acrylate “DPCA-20” (manufactured by Nippon Kayaku Co., Ltd.), 10 parts of “IBM-5103” (silane coupling agent, manufactured by Shin-Etsu Chemical Co., Ltd.), 5 parts of a photopolymerization initiator “IRGACURE 184” (manufactured by Ciba Specialty Chemicals), and 0.04 parts of a surface property improving agent {Illustrative Compound (F-63) of the invention} were added in 90 parts of MEK and stirred. Next, the mixture was filtered through a polypropylene-made filter having a pore size of 0.4 μm, thereby preparing a coating solution (HCL-3) for hard coat layer.

### [Preparation and Evaluation of Antireflection Film]

The coating solution (HCL-3) for hard coat layer was coated on a triacetyl cellulose film “TAC-TD80U” (manufactured by Fuji Photo Film Co., Ltd.) as a support and hardened in the same manner as in Example 2-67. On that occasion, the revolution number of the gravure roll was adjusted such that the thickness of the hardened hard coat layer (HC-3) was 4.5 μm.

By using the coating solution (LL-67) for low refractive index layer, a low refractive index layer (LL3-67) was coated on the thus obtained hard coat layer (HC-3) under the same condition as in the low refractive index layer (LL1-67), thereby preparing an antireflection sample (367). Next, the antireflection sample (367) was subjected to a saponification treatment.

The obtained antireflection film sample (367) was evaluated in the same manner as described previously. As a result, it was understood that an antireflection film of low reflection, whish is excellent in the marker ink wiping properties and scar resistance was obtained.

### Examples 401 to 406 and Comparative Examples 401 to 404

### Preparation of Coating Solutions (LL-85) to (LL-94) for Low Refractive Index Layer

Coating solutions for low refractive index layer each having a composition as shown in Table 16 were prepared. Each of the coating solutions was prepared by dissolving the components in a mixed solution of MEK and cyclohexanone (weight ratio: 95/5) such that the solids content of the coating solution was 8% by weight.

TABLE 16

| Constitutional | | | | | |
|---|---|---|---|---|---|
| component | LL-85 | LL-86 | LL-87 | LL-88 | LL-89 |
| P-3A | 30 | 30 | 30 | 27 | 27 |
| P-3 | 15 | 15 | 15 | 15 | 15 |
| DPHA | 4 | 4 | 4 | 4 | 4 |
| Antimony | | | 45 | 45 | 45 |
| oxide-coated silica | | | | | |
| P1 | | | | | |
| ATO-coated silica P3 | 45 | | | | |
| ITO-coated silica P4 | | 45 | | | |
| IPA-ST-L | | | | | |
| Fluorine-containing | | | | 3 | |
| antifouling agent | | | | | |
| (a-9) | | | | | |
| Fluorine-containing | | | | | 3 |
| antifouling agent | | | | | |
| (b-1) | | | | | |
| Fluorine-containing | | | | | |
| antifouling agent | | | | | |
| (c-2) | | | | | |
| Sol solution a | 4 | 4 | 4 | 4 | 4 |
| IRGAGURE 469 | 2 | 2 | 2 | 2 | 2 |
| Remark | Invention | Invention | Invention | Invention | Invention |
| Constitutional | | | | | |
| component | LL-90 | LL-91 | LL-92 | LL-93 | LL-94 |
| P-3A | 27 | 30 | 27 | 27 | 27 |
| P-3 | 15 | 15 | 15 | 15 | 15 |
| DPHA | 4 | 4 | 4 | 4 | 4 |
| Antimony | 45 | | | | |
| oxide-coated silica | | | | | |
| P1 | | | | | |
| ATO-coated silica P3 | | | | | |
| ITO-coated silica P4 | | | | | |
| IPA-ST-L | | 45 | 45 | 45 | 45 |
| Fluorine-containing | | | 3 | | |
| antifouling agent | | | | | |
| (a-9) | | | | | |
| Fluorine-containing | | | | 3 | |
| antifouling agent | | | | | |
| (b-1) | | | | | |
| Fluorine-containing | 3 | | | | 3 |
| antifouling agent | | | | | |
| (c-2) | | | | | |
| Sol solution a | 4 | 4 | 4 | 4 | 4 |
| IRGAGURE 469 | 2 | 2 | 2 | 2 | 2 |
| Remark | Invention | Comparison | Comparison | Comparison | Comparison |

Among the compounds as used in Table 16, the content of the compounds which are not used in Tables 14-1 to 14-4 will be shown below. Furthermore, all parts in the table represent a part by weight of the solid (non-volatile material).

(B) Fine Particle Having a Conductive Metal Oxide-Coated Layer:

ATO-coated silica P3: Silica particle the same as the silica particle P1 having an antimony oxide-coated layer, which is, however, coated by ATO in place of the antimony oxide. The particle has a refractive index of 1.41, a volume resistivity value of 1,600Ω/ and an average particle size of 61 nm and has a thickness of the ATO-coated layer of 1 nm.

ITO-coated silica P4: Silica particle the same as the silica particle PI having an antimony oxide-coated layer, which is, however, coated by ITO in place of the antimony oxide. The particle has a refractive index of 1.42, a volume resistivity value of 1,300Ω/ and an average particle size of 61 nm and has a thickness of the ITO-coated layer of 1 nm.

### Other Fine Particle:

IPA-ST-L: “IPA-ST-L”, which is a trade name of a dispersion of silica fine particle as manufactured by Nissan Chemical Industries, Ltd., solvent: IPA, average particle size: 45 nm

Photopolymerization Initiator:

IRGACURE 369: “IRGACURE 369”, manufactured by Ciba Speciality Chemicals

By using each of the foregoing coating solutions (LL-85) to (LL-94) for low refractive index layer, a low refractive index layer was coated on the hard coat layer (HC-3) as prepared in Example 58 by a die coater such that the thickness after hardening was 95 nm, thereby preparing antireflection film samples (401) to (410). With respect to the hardening condition, hardening was carried out by drying at 80° C. for 120 seconds, purging with nitrogen in an oxygen concentration of not more than 0.01%, keeping at a temperature of 60° C., and irradiating at a radiation illuminance of 120 mW/cm² and an irradiation dose of 500 mJ/cm² by using an air-cooled metal halide lamp (manufactured by Eyegraphics Co., Ltd.) of 240 W/cm.

By using each of the resulting samples, the foregoing evaluations (1) to (3) and (5) were carried out. Also, the following evaluation (6) was carried out.

### (Evaluation 6) Dustproof Properties:

A side of the transparent support of each of the antireflection film samples was stuck on a surface of CRT, and the resulting sample was used in a room having 1,000,000 to 2,000,000 dusts and tissue paper wastes of 0.5 μm or more per 1 ft³ (cubic foot) for 24 hours. The number of attached dusts and tissue paper wastes per 100 cm² of the antireflection film was measured. As a result, the case where the average value is less than 20 was evaluated as “A”; the case where the average value is from 20 to 29 was evaluated as “B”; the case where the average value is from 50 to 199 was evaluated as “C”; and the case where the average value is 200 or more was evaluated as “D”, respectively. The results are shown in Table 17.

TABLE 17

| | | Mirror | | | Surface | |
|---|---|---|---|---|---|---|
| | | reflectance | Marker ink | | resistivity | Dustproof |
| No. | | (R) | wiping properties | Scar resistance | (Ω/) | properties |
| Antireflection | Example 59 | 1.55 | 10 | A | 3.50E+09 | A |
| film sample | | | | | | |
| (401) | | | | | | |
| Antireflection | Example 60 | 1.55 | 10 | A | 2.10E+09 | A |
| film sample | | | | | | |
| (402) | | | | | | |
| Antireflection | Example 61 | 1.55 | 10 | A | 3.30E+09 | A |
| film sample | | | | | | |
| (403) | | | | | | |
| Antireflection | Example 62 | 1.55 | 30 | A | 3.30E+09 | A |
| film sample | | | | | | |
| (404) | | | | | | |
| Antireflection | Example 63 | 1.55 | 40 | A | 3.30E+09 | A |
| film sample | | | | | | |
| (405) | | | | | | |
| Antireflection | Example 64 | 1.55 | 50 | A | 3.30E+09 | A |
| film sample | | | | | | |
| (406) | | | | | | |
| Antireflection | Comparative | 2.75 | 4 | AB | 4.00E+14 | C |
| film sample | Example 29 | | | | | |
| (407) | | | | | | |
| Antireflection | Comparative | 2.75 | 20 | A | 4.00E+14 | D |
| film sample | Example 30 | | | | | |
| (408) | | | | | | |
| Antireflection | Comparative | 2.75 | 30 | A | 4.00E+14 | D |
| film sample | Example 31 | | | | | |
| (409) | | | | | | |
| Antireflection | Comparative | 2.75 | 45 | A | 4.00E+14 | D |
| film sample | Example 32 | | | | | |
| (410) | | | | | | |

According to Table 17, it is understood that the sample containing a fine particle having a conductive oxide-coated layer of the invention has low reflection and low surface resistivity and is excellent in the dustproof properties and scar resistance. Also, by jointly using an ionizing radiation hardenable fluorine-containing antifouling agent which is the component (D) of the invention, the maker ink wiping properties could be drastically improved, and deterioration of the dustproof properties was not observed.

This application is based on Japanese Patent application JP 2005-278461, filed Sep. 26, 2005, the entire content of which is hereby incorporated by reference, the same as if set forth at length.

What is claimed is:

1. An antireflection film comprising a transparent support and at least one layer having a refractive index of from 1.28 to 1.48, wherein the layer having a refractive index of from 1.28 to 1.48 positioned farthest from the transparent support in the at least one layer having a refractive index of from 1.28 to 1.48 is formed by coating a coating composition comprising:
an ionizing radiation hardenable compound;
a particle having a conductive metal oxide-coated layer; and
at least one ionizing radiation hardenable fluorine-containing antifouling agent represented by Formula (F-2) or (F-3):
F(CF₂)ₙO(CF₂CF₂O)ₘCF₂CH₂OCOCR═CH₂ Formula (F-2)
wherein in the Formula (F-2), R represents a hydrogen atom or a methyl group; m represents an integer of from 1 to 6; and n represents an integer of from 1 to 4;
(Rf)—[(W)—(R_{A})ₙ]ₘ Formula (F-3)
wherein in the formula (F-3), Rf represents a (per)fluoropolyether group; W represents a connecting group; R_{A} represents a (meth)acryl group; n represents an integer of from 1 to 3; and m represents an integer of from 1 to 3, provided that n and m do not represent 1 at the same time.

2. The antireflection film according to claim 1, wherein the particle is a porous inorganic particle or a particle having a void in an inside of the particle.

3. The antireflection film according to claim 1, wherein the particle is a silica based particle having an antimony oxide-coated layer.

4. The antireflection film according to claim 1, wherein the particle is a porous silica based particle or a silica based particle having a void in an inside of the particle.

5. The antireflection film according to claim 1, wherein the particle comprises a silica-coated layer or a silica-coated layer resulting from a surface treatment with at least one of a hydrolyzate of an organosilane compound represented by the following formula (3) and a partial condensate of the hydrolyzate on the conductive metal oxide-coated layer:
(R³⁰)ₘ₁Si(X³¹)₄₋ₘ₁ Formula (3)
wherein R³⁰ represents a substituted or unsubstituted alkyl group or a substituted or unsubstituted aryl group; X³¹ represents a hydroxyl group or a hydrolyzable group; and m1 represents an integer of from 1 to 3.

6. The antireflection film according to claim 1, wherein the particle has a refractive index of from 1.35 to 1.60 and a volume resistivity value of from 10 to 5,000Ω·cm.

7. The antireflection film according to claim 1, wherein the particle has an average particle size of from 5 to 300 nm, and the conductive metal oxide-coated layer has a thickness of from 0.5 to 30 nm.

8. The antireflection film according to claim 1, wherein the ionizing radiation hardenable compound comprises at least two ethylenically unsaturated groups in one molecule thereof.

9. The antireflection film according to claim 1, wherein the ionizing radiation hardenable compound is a fluorine-containing polymer comprising at least one perfluoroolefin polymerization unit and at least one (meth)acryloyl group-containing polymerization unit.

10. The antireflection film according to claim 1, wherein the coating composition further comprises a compound having a polysiloxane structure represented by the following formula (I): 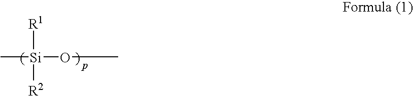
wherein R¹ and R² each independently represents an alkyl group or an aryl group; and p represents an integer of from 10 to 500.

11. The antireflection film according to claim 1, wherein the ionizing radiation hardenable compound is represented by the following formula (2): 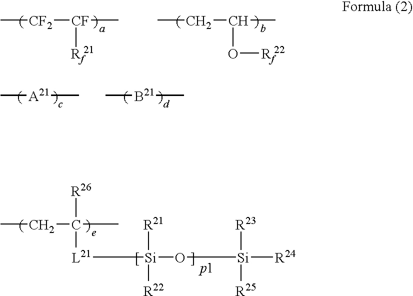
wherein R_{f}²¹ represents a perfluoroalkyl group having from 1 to 5 carbon atoms, R_{f}²² represents a fluorine-containing alkyl group having a linear, branched or alicyclic structure having from 1 to 30 carbon atoms and may contain an ether bond; A²¹ represents a constitutional unit comprising a reactive group capable of participating in a crosslinking reaction; B²¹ represents an arbitrary constitutional component; R²¹ and R²² each independently represents an alkyl group or an aryl group; p1 represents an integer of from 10 to 500; R²³ to R²⁵ each independently represents a substituted or unsubstituted monovalent organic group or a hydrogen atom; R²⁶ represents a hydrogen atom or a methyl group; L²¹ represents an arbitrary connecting group having from 1 to 20 carbon atom or a single bond; a to d each represents a molar fraction (%) of a respective constitutional component exclusive of a polysiloxane-containing polymerization unit and represents a value which is satisfied with the relation s of 10≦(a+b)≦55, 10≦a≦55, 0≦b≦45, 10≦c≦50 and 0≦d≦40; and e represents a weight fraction (%) of a polysiloxane-containing polymerization unit based on a weight of a whole of other components and is satisfied with the relation of 0.01≦e≦20.

12. A polarizing plate comprising the antireflection film according to claim 1 provided in at least one side thereof.

13. An image display device comprising the antireflection film according to claim 1.

14. The antireflection film according to claim 1, wherein the at least one ionizing radiation hardenable fluorine-containing antifouling agent comprises at least one of the following compounds of formulas (b-1) and (b-2):
F₉C₄OC₂F₄OC₂F₄OCF₂CHOCOCH═CH₂, (b-1)
F₉C₄OC₂F₄OC₂F₄OCF₂CHOCOC(CH₃)═CH₂ (b-2).

15. The antireflection film according to claim 1, wherein Rf in Formula (F-3) is represented by the following structure:
F(CF(CF₃)CF₂O)ₚCF(CF₃)—
wherein p is from 4 to 15.

16. The antireflection film according to claim 15, wherein the at least one ionizing radiation hardenable fluorine-containing antifouling agent comprises at least one of the following compounds of formulas (C-1), (C-2) and (C-3):
HFPO—CONH—C—(CH₂OCOCH═CH₂)₂CH₂CH₃, (C-1)
HFPO—CONH—C—(CH₂OCOCH═CH₂)₂H, (C-2)
Michael addition polymer of HFPO—CONH—C₃H₆NHCH₃ and trimethylolpropane triacrylate (1/1), (C-3)
wherein HFPO— is defined as F(CF(CF₃)CF₂O)ₚCF(CF₃)— in which an average value of p is from 6 to 7.

17. The antireflection film according to claim 1, wherein the antifouling agent represented by the Formula (F-3) has a number average molecular weight of from 400 to 5,000.
